(19) United States
(12) Patent Application Publication
(10) Pub. No.: US 2012/0130020 A1
(43) Pub. Date: May 24, 2012

(54) Poly(Ester Amide)s and Poly(Ester Ether Amide)s With Pendant Crosslinkable Functional Groups

(75) Inventors: Chih-Chang Chu, Ithaca, NY (US); Xuan Pang, Changchun (CN)

(73) Assignee: CORNELL UNIVERSITY, Ithaca, NY (US)

(21) Appl. No.: 13/321,998

(22) PCT Filed: May 24, 2010
(86) PCT No.: PCT/US10/35970

§ 371 Date: Feb. 3, 2012

Related U.S. Application Data
(60) Provisional application No. 61/180,747, filed on May 22, 2009.

(51) Int. Cl. C08F 293/00; C08F 222/22; C08F 226/06

(52) U.S. Cl. 525/280; 526/312; 526/260; 525/294

(57) ABSTRACT

Amino-acid based poly(ester amide) (PEA) or poly(ester ether amide) (PEEA) polymers having pendant cross-linkable functional groups. The polymers can be cross-linked to form a hydrogel. These polymers can be used in biomedical applications.

### CROSS-REFERENCE TO RELATED APPLICATIONS

This application claims priority to U.S. provisional patent application No. 61/180,747, filed May 22, 2009, the disclosure of which is incorporated herein by reference.

### FIELD OF THE INVENTION

The present invention generally relates to amino-acid based poly(ester amide) and poly(ester ether amide) polymers. More particularly, the present invention relates to amino-acid based poly(ester amide) and poly(ester ether amide) polymers having a pendant crosslinkable group, methods of making same and uses thereof.

### BACKGROUND OF THE INVENTION

Amino acid-based biodegradable PEAs have been studied for many years due to their biocompatibility, biodegradability and mechanical properties. The presence of amide and ester bonds in PEA furnishes the PEA with a combination of properties typically exhibited by either polyesters or polyamides. Biodegradable PEA is typically synthesized by a solution polycondensation reaction of a-amino acids, aliphatic dicarboxylic acids (or dichloride of dicarboxylic acids) and diols (see Guo et al., Synthesis, Characterization, and Biodegradation of Copolymers of Unsaturated and Saturated Poly(ester amide)s, Journal of Polymer Science, Part A: Polymer Chemistry 2007, 45(9): 1595-1606).

PEA homopolymers generally do not have any functional groups located either along the PEA backbone chain or as pendant groups. The first reported synthesis of functional PEAs was based on a copolymer approach. A free functional group in the form of a carboxylic acid group was introduced in the lysine segment of the PEA copolymer. (see Jokhadze et al., Synthesis and Characterization of Functional Elastomeric Poly(ester Amide Copolymers, Journal of Biomaterials Science—Polymer Edition 2007; 18(4):411-438)

In an alternative approach, carbon-to-carbon double bonds have been positioned along the backbone of PEA to provide a reactive site for the introduction of a functional group into PEA via unsaturated diacids and/or diols. The availability of these carbon-to-carbon double bonds in turn permits the fabrication of hydrogels by photo-gelation of PEA precursors, whereas PEA based upon saturated diacids and/or diols cannot be used to form hydrogels (see Guo et al., Synthesis, Characterization, and Biodegradation of Copolymers of Unsaturated and Saturated Poly(ester amide)s, Journal of Polymer Science, Part A: Polymer Chemistry, 2007; 45(9): 1595-1606).

### BRIEF SUMMARY OF THE INVENTION

In one aspect, the present invention provides an amino acid-based poly(ester amide (PEA) or poly(ester ether amide) (PEEA), where the polymers have at least one pendant cross-linking (PXL) group (R′), having Structure I:

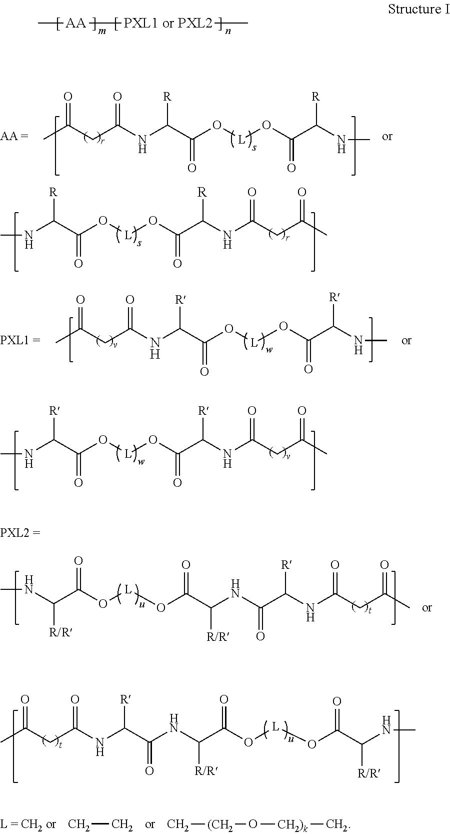

In one embodiment, a polymer having Structure I comprises an [AA]ₘ block and a [PXL1]ₙ or [PXL2]ₙ block. The [AA]ₘ block and [PXL1]ₙ or [PXL2]ₙ blocks are connected by an amide bond. R is a side chain of a naturally-occurring amino acid. R′ is an alkyl group comprising an alkene group. L is a CH₂, CH₂—CH₂ or CH₂—(CH₂—O—CH₂)ₖ—CH₂, where k is from 1 to 6, moiety. The value of r, v or t is from 2 to 8. The value of s, w or u is from 2 to 6. The ratio of m to n is from 1 to 4. In another embodiment, R is a benzyl group or a alkylguanidinium group and R′ is an allyl group. In another embodiment, in the block terminated by an amine the amine is present as an p-nitro phenol adduct and in the block terminated by a carbonyl group is present as a p-nitro phenolate ester.

In one embodiment, the number averaged molecular weight, Mn, is from 10 kg/mol to 100 kg/mol or the weight averaged molecular weight, Mw, is from 10 kg/mol to 100 kg/mol. In one embodiment, R is a benzyl group or a alkylguanidinium group and R′ is an allyl group.

In one embodiment, the PEA or PEEA of the present invention can have the following general structure which includes Structure II (also referred to as x-AA-y-AG, where AA is an amino acid, x is the number of carbons in the diacid and y is the number of carbon atoms in the diol group linking the two amino acids in the diester monomer):

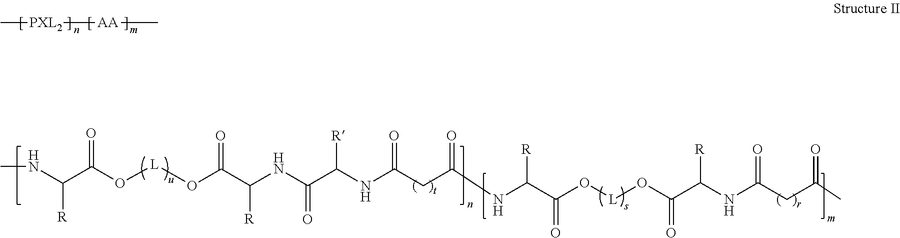

In another embodiment, the PEA or PEEA of the present invention can have the following general structure which includes Structure V (also referred to as x-AA-y-AG-z, where AA is an amino acid, x is the number of carbons in the diacid and y is the number of carbon atoms in the diol group linking the two amino acids in the diester monomer and z is the number of carbons in the diol group linking the two amino acids in the monomer from which the PXL1 block is derived):

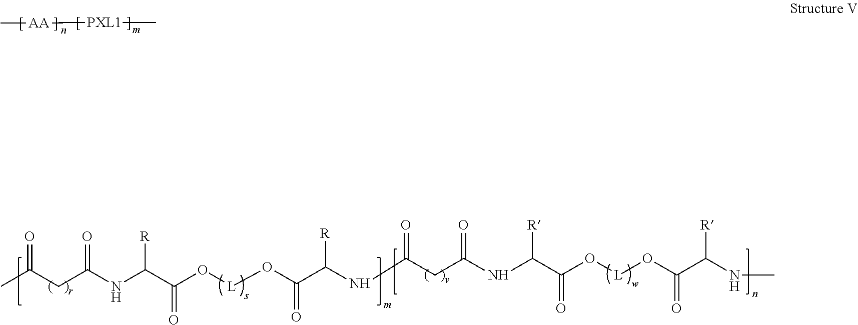

In another aspect, the present invention provides monomers having Structures X (also referred to as AG-NCA monomer) and XI:

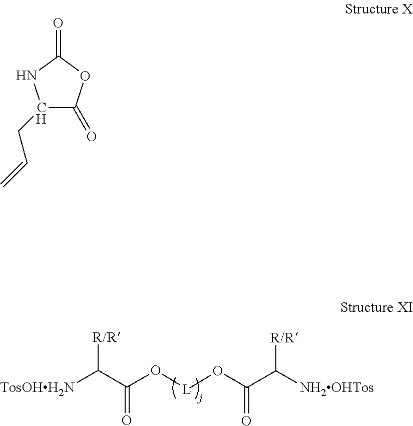

In Structure XI, R and R′ are as defined herein. L is a CH₂, CH₂CH₂, or CH₂ (CH₂OCH₂)ₖCH₂, where k is from 1 to 6, including all integers therebetween, moiety and j is from 2 to 6, including all integers therebetween.

In another aspect, the present invention provides hydrogels prepared by crosslinking (e.g., photocrosslinking) of a PEA or PEEA (Structure I). In one embodiment, the hydrogel is formed from a plurality of polymer molecules having Structure I, where the hydrogel has at least one covalent bond between different blocks of the same molecule or between blocks from different polymer molecules. In this embodiment, the covalent bond is formed by subjecting the plurality of polymer molecules to reaction conditions (e.g. photochemical conditions, where the plurality of polymer molecules and a photoinitiator (e.g., Irgacure 2959®) are combined in the presence of ultraviolet radiation (e.g., wavelengths of from 300 nm to 400 nm), such that a reaction takes place between two alkene groups from blocks of the same polymer molecule or between blocks from different polymer molecules forming a covalent bond. In one embodiment, the PEA or PEEA is crosslinked in the presence of a poly(ethylene/propylene) glycol that is functionalized at hydroxyl groups such that a acryloyl group is formed.

In another aspect, the present invention, the R′ moieties of the PEAs or PEEAs of the present invention have a pendant functional group. In one embodiment, the pendant functional group is a thiol. In various embodiments, the pendant function group is hydroxide (—OH), -sulfonic acid (—SO₃H), imidazole, carboxylate (—COOH) and phenol.

In another aspect, the present invention provides hybrid materials which contain the PEAs and/or PEEAs of the present invention and non-PEA/PEEA polymers such as, for example, polysaccharides and aliphatic polyesters. Besides the linking of these allylglycine-base functional PEA/PEEA copolymers with other PEA/PEEA (without allylglycine unit(s)), additional applications could include the integration of these allylglycine-based functional PEA or PEEA copolymers (e.g., via their pendant double bonds in the AG unit) to other non-PEA/PEEA-based polymers like polysaccharides or aliphatic polyesters (e.g., polylactide, polyglycolide, and poly-ε-caprolactone) to form hybrid biomaterials. Such hybrid biomaterials should be very useful.

In one aspect, the present invention describes at least two alternative methods of fabricating two new families of functional PEA or PEEA copolymers and their derivatives. Due to the presence of a AG-PEA segment in the resulting functional PEA or PEEA copolymers in both families, these copolymers have at least one common structural characteristic: pendant carbon-to-carbon double bond that is reactive, for example, in photo-induced hydrogel formation (e.g., see FIGS. 9-12, 15-25, 36-37 and 44-51) or conversion into other reactive functional groups like amine, carboxylic and sulfonic acid (e.g., see FIGS. 53-60). In a first method of this embodiment, the functional PEA or PEEA copolymers prepared under this 1st method may be labeled as x-AA-y-AG and have the general structure exemplified in (Structure 2 and FIGS. 2 and 3). In a second method of this embodiment, the functional PEA or PEEA copolymers prepared under this second method may be labeled as x-AA-y-AG-z, where z indicates the number of methylene groups in the diols that are used (e.g., see Structure 5 and FIGS. 1 and 4).

### BRIEF DESCRIPTION OF THE FIGURES

FIG. 1. Example of generic chemical structure of functional PEA copolymers having pendant reactive double bonds (x-AA-y-AG). AA: amino acid; AG: allylglycine; x & y: number of methylene groups in diacid and diols, respectively of non-allylglycine PEA, x=2, 4, 8; y=2, 4, 6; z: number of methylene group in diol part of AG toluenesulfonic acid salt, z=4, 6; the ratio of m/n is in the region of 4-1.

FIG. 2. Example of generic chemical structure of functional PEA copolymers having pendant reactive double bonds (x-AA-y-AG). AA: amino acid; AG: allylglycine; x & y: number of methylene groups in diacid and diols, respectively of non-allylglycine PEA, x=2, 4, 8; y=2, 4, 6; the ratio of m/n is in the region of 4-1.

FIG. 3. Example of chemical scheme of synthesis of x-Phe-y-AG.

FIG. 4. Example of chemical scheme of synthesis of x-Phe-y-AG-z.

FIG. 5. NMR Structural Characterization of Phe-based functional coPEA (x-Phe-y-AG).

FIG. 6. FTIR structural characterization of a Phe-based functional PEA (x-Phe-y-AG).

FIG. 7. Thermal characterization of a Phe-based functional coPEA (x-Phe-y-AG).

FIG. 8. Solubility and yields of examples of Phe-based functional coPEAs (x-Phe-y-AG and x-Phe-y-AG-z) at room temperature.

FIG. 9. Gel formation from a Phe-based coPEA (8-Phe-4-AG).

FIG. 10. Example of PEA gel formation without the use of any other agents like PEG-diacrylate or crosslinking agents. 8-Phe-4-AG-G gel before swelling (left) and after swelling (right) 365 nm, 15 W, 12 hours in DMSO.

FIG. 11. Gel formation from a Phe-based coPEA (8-Phe-4-AG-z).

FIG. 12. PEA gel formation without the use of any other agents like PEG-diacrylate or crosslinking agents. 8-Phe-4-AG-4-G gel before swelling (left) and after swelling (right) 365 nm, 15 W, 12 hours in DMSO.

FIG. 13. Example of synthesis of a functionalized crosslinking group precursor. 8.7 g of pluronic F68 were dissolved in 150 mL of benzene and heated to 45° C. with stirring until a complete dissolution. After the solution was cooled to room temperature, trithylamine, at a concentration five times molar excess of each OH group on pluronic, was added to the pluronic solution. Then acryloyl chloride, also five times molar excess of each OH group on pluronic was added. The mixture was stirred at room temperature overnight under nitrogen atmosphere. Pluronic acid-DA was precipitated in cold hexane and collected by filtration. and finally dried in vacuo at room temperature.

FIG. 14. Example of synthesis of a functionalized crosslinking group precursor. 6 g (1.5 mmol) of PEG was dissolved in 150 mL of benzene and heated to 45° C. with stirring until complete dissolution. After the solution was cooled to room temperature, 1.67 mL (12.0 mmol) of triethylamine, at a fourfold molar excess concentration (based on PEG diol end groups), was added to the PEG solution. Then, 0.97 mL (12.0 mmol) of acryloyl chloride, also at a fourfold molar excess concentration (based on PEG diol end groups), was added dropwise to the PEG solution to form acrylate diesters of PEG. The mixture was stirred and heated to 80° C. for 3 hours under a nitrogen atmosphere. The insoluble triethylamine salts that formed during the reaction were removed by filtration, and the PEG-DA product was precipitated by the addition of 700 mL of hexane chilled to 4° C. The PEG-DA precipitate was collected on a fritted funnel, redissolved in 20 mL of benzene, and reprecipitated by 700 mL of chilled hexane twice. The PEG-DA polymer was finally dried for 24 h in a vacuum oven at 35° C. and stored at approximately 48° C. for future use.

FIG. 15. Example of hydrogel fabrication. A weight ratio of 1:3 of 8-Phe-4-AG-4 to pluronic acid-DA (0.08 g of 8-Phe-4-AG-4 and 0.24 g of pluronic acid-DA) was added to a vial and dissolved in 2 mL of DMA to form a clear, homogeneous solution with a light yellow color. The photoinitiator Irgacure 2959® (0.016 g, 5 wt % of the total amount of the precursors) was added to the solution of the precursors and dissolved completely at room temperature. The solution was irradiated by a long-wavelength UV lamp (365 nm, 100 W) for minutes in a teflon mold at room temperature and then gel formation occurred.

FIG. 16. Example of gel formation from pure pluronic acid-DA. Pluronic acid-DA gel before swelling (left) and after swelling (right) 365 nm, 100 W, 10 minutes in DMSO, Pluronic acid Mn=7000.

FIG. 17. Example of gel formation from pure pluronic acid-DA. SEM images of gel prepared by Pluronic acid Mn=7000.

FIG. 18. Example of gel formation from 8-Phe-4-AG-4 and pluronic acid-DA. 8-Phe-4-AG-4 and pluronic acid-DA gel, Phe-4:AG(4)=3:1, PEA:pluronic acid-DA=1:3. Before swelling (left) and after swelling (right) 365 nm, 100 W, 10 minutes in DMSO, Pluronic acid Mn=7000.

FIG. 19. Example of gel formation from 8-Phe-4-AG-4 and pluronic acid-DA. SEM images of gel prepared by 8-Phe-4-AG-4 and pluronic acid-DA Phe-4:AG(4)=3:1 PEA:pluronic acid-DA=1:3 Pluronic acid Mn=7000.

FIG. 20. Example of gel formation from 8-Phe-4-AG-4 and pluronic acid-DA. A weight ratio of 1:3 of 8-Phe-4-AG-4 to PEG-DA (0.08 g of 8-Phe-4-AG-4 and 0.24 g of PEG-DA) was added to a vial and dissolved in 2 mL of DMA to form a clear, homogeneous solution with a light yellow color. The photoinitiator Irgacure 2959® (0.016 g, wt % of the total amount of the precursors) was added to the solution of the precursors and dissolved completely at room temperature. The solution was irradiated by a long-wavelength UV lamp (365 nm, 100 W) for 15 minutes in a teflon mold at room temperature and then gel formation occurred.

FIG. 21. Example of gel formation from pure PEG-DA. PEG-DA gel before swelling (left) and after swelling (right) 365 nm, 100 W, 10 minutes in DMSO, PEG Mn=4000.

FIG. 22. Example of gel formation from pure PEG-DA. SEM images of gel prepared by PEG-DA PEG Mn=4000.

FIG. 23. Example of formation of 8-Phe-4-AG-4 and PEG-DA gel. 8-Phe-4-AG-4 and PEG-DA gel, Phe-4:AG(4)=3:1, PEA:PED-DA=1:3. Before swelling (left) and after swelling (right) 365 nm, 100 W, 10 minutes in DMSO, PEG Mn=7000.

FIG. 24. Example of gel formation from 8-Phe-4-AG-4 and PEG-DA. SEM images of gel prepared by 8-Phe-4-AG-4 and PEG-DA Phe-4:AG(4)=3:1 PEA:PEG-DA=1:3 PEG Mn=4000.

FIG. 25. Example of gel formation from 8-Phe-4-AG-4, PEG-DA and pluronic acid-DA. A. PEG Mn=700. B. PEG Mn=4000. SEM images of gels prepared by 8-Phe-4-AG-4, PEG-DA and pluronic acid Phe-4:AG(4)=3:1 PEA:PEG-DA:pluronic acid=1:1.5:1.5 Pluronic acid Mn=7000.

FIG. 26. Swelling ratio of examples of 8-Phe-4-AG-4 and 2-Phe-4-AG-4 hydrogels.

FIG. 27. Swelling ratio of examples of 8-Phe-4-AG-4 and 2-Phe-4-AG-4 hydrogels.

FIG. 28. In vitro biodegradation of Phe-based PEA. Biodegradation behavior of 8-Phe-4-AG-4 (Phe:AG=3:1) in PBS buffer and a chymotrypsin solutions. ▪0.2 mg/mL α-chymotrypsin; ▴ 0.1 mg/mL α-chymotrypsin; PBS

FIG. 29. Example of chemical scheme of synthesis of x-Arg-y-AG.

FIG. 30. Example of chemical scheme of synthesis of x-Arg-y-AG-z.

FIG. 31. FTIR characterization of an Arg-based functional coPEA (x-Phe-y-AG).

FIG. 32. NMR characterization of an Arg-based functional coPEA (x-Arg-y-AG-z).

FIG. 33. Solubility and yields of examples of Arg-based functional coPEAs at room temperature. + soluble; − insoluble; ± partially soluble but become total soluble at 50° C. and no precipitation after cooling down to room temperature.

FIG. 34. Example of gel formation from an Arg-based coPEA (8-Arg-4-AG).

FIG. 35. An 8-Arg-4-AG-G gel before swelling (left) and after swelling (right) 365 nm, 15 W, 12 hours in DMSO, weight ratio of PEG-DA:PEA=3:1.

FIG. 36. Example of gel formation from an Arg-based coPEA (8-Arg-4-AG-4).

FIG. 37. An 8-Arg-4-AG-4-G gel before swelling (left) and after swelling (right) 365 nm, 15 W, 12 hours in DMSO, weight ratio of PEG-DA:PEA=3:1.

FIG. 38. Examples of weight ratio of Arg/AG and PEG-DA/PEA in a gelation procedure of arginine based coPEAs (x-Arg-y-AG) and (x-Arg-y-AG-z) in H₂O.

FIG. 39. Example of synthesis of water soluble arginine based coPEAs: x-Arg-y-AG-nEG. In this example, oligoethylene glycol (nEG) is used instead of regular diols during AG monomer synthesis to improve water solubility of the resulting coPEAs.

FIG. 40. Example of synthetic pathway of a x-Arg-y-AG-nEG polymer.

FIG. 41. Solubility and yields of examples of Arg-based functional water soluble coPEA at room temperature. + soluble; − insoluble; + partially soluble but become total soluble at 50° C. and no precipitation after cooling down to room temperature.

FIG. 42. Cytotoxicity test data for 8-Arg-4-AG-4EG. BAEC treated by 8-Arg-4-AG-4EG for 48 hours 10 uL per well in 96 well plate. For gelatin coating process, 25 uL 2% gelatin solution was added to each well, and then the gelatin solution was removed after 10 minutes.

FIG. 43. Microscopic images of BAEC treated by 8-Arg-4-AG-4EG for 48 hours. 10 uL per well in 96 well plate. For gelatin coating process, 25 uL 2% gelatin solution was added to each well, and then the gelatin solution was removed after 10 minutes.

FIG. 44. Example of gel formation from an Arg-based coPEA (8-Arg-4-AG-2EG) in H₂O.

FIG. 45. Example of gel formation from an Arg-based coPEA (8-Arg-4-AG-2EG) in H₂O. A. Before swelling. B. After swelling in H₂O. 8-Arg-4-AG-2EG-G hydrogel, 365 nm, 100 W, 10 minutes in H₂O, weight ratio of PEG-DA:PEA=4:1.

FIG. 46. Example of hydrogel formation.

FIG. 47. Example of hydrogel formation. A weight ratio of 1:3 of 8-Arg-4-AG-4EG to pluronic acid-DA (0.08 g of 8-Arg-4-AG-4EG and 0.24 g of pluronic acid-DA) was added to a vial and dissolved in 2 mL of DMA to form a clear, homogeneous solution with a light yellow color. The photoinitiator Irgacure 2959® (0.016 g, 5 wt % of the total amount of the precursors) was added to the solution of the precursors and dissolved completely at room temperature. The solution was irradiated by a long-wavelength UV lamp (365 nm, 100 W) for 15 minutes in a teflon mold at room temperature and then gel formation occurred.

FIG. 48. Example of hydrogel formation. A weight ratio of 1:3 of 8-Arg-4-AG-4EG to PEG-DA (0.08 g of 8-Arg-4-AG-4EG and 0.24 g of PEG-DA) was added to a vial and dissolved in 2 mL of DMA to form a clear, homogeneous solution with a light yellow color. The photoinitiator Irgacure 2959® (0.016 g, 5 wt % of the total amount of the precursors) was added to the solution of the precursors and dissolved completely at room temperature. The solution was irradiated by a long-wavelength UV lamp (365 nm, 100 W) for 15 minutes in a teflon mold at room temperature and then gel formation occurred.

FIG. 49. Example of hydrogel formation. 8-Arg-4-AG-4EG and pluronic acid-DA. SEM image of gel prepared by 8-Arg-4-AG-4EG and pluronic acid-DA Arg-4:AG-4EG=3:1 PEA:pluronic acid-DA=1:3 Pluronic acid Mn=7000.

FIG. 50. Example of hydrogel formation. 8-Arg-4-AG-4EG and PEG-DA. SEM images of gel prepared by 8-Arg-4-AG-4EG and PEG-DA Arg-4:AG-4EG=3:1 PEA:PEG-DA=1:3 PEG Mn=4000.

FIG. 51. Example of hydrogel formation from 8-Arg-4-AG-4EG, PEG-DA and pluronic acid-DA. SEM images of gel prepared by 8-Arg-4-AG-4EG, PEG-DA and pluronic acid-DA Arg-4:AG-4EG=3:1 PEA:PEG-DA:pluronic acid=1:1.5:1.5 PEG Mn=4000 Pluronic acid Mn=7000.

FIG. 52. Example of weight ratio of Arg/AG and PEG-DA/PEA in a gelation procedure of arginine based coPEAs (x-Arg-y-AG-nEG) in H₂O.

FIG. 53. Example of synthetic pathway for functionalization of pendant crosslinkable group. R═CH₂SO₃ Na, COOH or NH₂HCl.

FIG. 54. Example of synthetic pathway for functionalization of pendant crosslinkable group. R═CH₂SO₃ Na, COOH or NH₂HCl.

FIG. 55. NMR and FTIR characterization of 8-Phe-4-AG-COOH. A. 1 NMR spectra of 8-Phe-4-AG. Double bond peaks are indicated by arrows. B. ¹H NMR spectra of 8-Phe-4-AG-COOH. Solvent DMSO. Arrows indicate CH₂ proton peaks from 3-mercaptopropionic acid part.

FIG. 56. FTIR spectrum of 8-Phe-4-AG and 8-Phe-4-AG-COOH. Solvent DMSO. Circles indicate typical peaks of carboxylic acid.

FIG. 57. NMR and FTIR characterization of 8-Phe-4-AG-COOH. A. FTIR spectrum of 8-Phe-4-AG-COOH. Solvent DMA. Circles indicate typical peaks of carboxylic acid. B. ¹H NMR spectra of 8-Phe-4-AG-COOH. Solvent DMA. Arrows indicate CH₂ proton peaks from 3-mercaptopropionic acid part.

FIG. 58. NMR and FTIR characterization of 8-Phe-4-AG-NH₂. A. ¹H NMR spectra of 8-Phe-4-AG-NH₂HCl. Solvent DMA. Arrows indicate CH₂ proton peaks from 2 aminoethanethiol part. B. FTIR spectrum of 8-Phe-4-AG and 8-Phe-4-AG-NH2HCl, solvent DMA. Circles indicate typical peaks from 2-aminoethanethiol part

FIG. 59. NMR and FTIR characterization of 8-Phe-4-AG-NH₂. A. ¹H NMR spectra of 8-Phe-4-AG-NH₂HCl, solvent DMSO. Arrows indicate CH₂ proton peaks from 2-aminoethanethiol part. B. FTIR spectrum of 8-Phe-4-AG-NH₂HCl. Solvent DMSO. Circles indicate typical peaks from 2-aminoethanethiol.

FIG. 60. NMR and FTIR characterization of 8-Phe-4-AG-SO₃Na. A. ¹H NMR spectra of 8-Phe-4-AG-SO₃Na. Arrows indicate CH₂ proton peaks from sodium 3-mercapto-1-propanesulfonate part. B. FTIR spectrum of 8-Phe-4-AG and 8-Phe-4-AG-SO₃ Na. Circles indicate typical peaks of SO₃ group.

FIG. 61. ¹H NMR spectra of a di-p-toluenesulfonic acid salt of bis-DL-2-allylglycine ester AG-2.

FIG. 62. ¹H NMR spectra of pendant double bond functionalized PEA-AG (8-Phe-4-AG-4). a: Phe-4:AG-4=9:1; b: Phe-4:AG-4=3:1; c: Phe-4:AG-4=1:1.

FIG. 63. ¹H NMR spectra of functionalized PEA-AG 8-Phe-4-AG-2-COOH.

FIG. 64. Synthetic pathway for the preparation of di-p-nitrophenol esters of dicarboxylic acids (I). x, number of methylene group in diacid.

FIG. 65. Synthetic pathway for the preparation of di-p-toluenesulfonic acid salt of bis-L-phenylalanine and bis-DL-2-allylglycine esters (II). y and z, number of methylene group in diol part of Phe and AG toluenesulfonic acid salt.

FIG. 66. Examples of monomers and functional PEA-AGs synthesized by different monomer combinations.

FIG. 67. Example of a synthetic pathway for preparation of functional poly(ester amide)s having pendant carbon-carbon double bonds.

FIG. 68. Example of a synthetic pathway for a thiol-based functionalized poly(ester-amide)s.

FIG. 69. FTIR spectra of a pendant double bond functionalized PEA-AG and corresponding thiol-functionalized PEA-AGs. a, 8-Phe-4-AG-2; b, 8-Phe-4-AG-2-COOH; c, 8-Phe-4-AG-2-NH2HCl; d, 8-Phe-4-AG-2-SO3Na.

FIG. 70. Fundamental properties of examples of pendant double bond functionalized PEA-AGs.

FIG. 71. Solubility data of examples of functional PEA-AGs.

FIG. 72. Effect of methylene chain length in the diacid segment (x) of functional PEA-AG on enzymatic catalyzed biodegradation property: 2-Phe-4-AG-4-25 (x ¼ 2) and 8-Phe-4-AG-4-25 (x ¼ 8) in 0.1 mg/mL a-chymotrypsin solution and pure PBS of pH 7.4 and 37° C.

FIG. 73. Effect of methylene chain length in the diol segment (y) of functional PEA-AG on their enzymatic catalyzed biodegradation property: 8-Phe-6-AG-4-25 (y ¼ 6) and 8-Phe-4-AG-4-25 (y ¼ 4) in 0.1 mg/mL a-chymotrypsin solution and pure PBS of pH 7.4 and 37° C.

FIG. 74. Effect of methylene chain length in the diol segment (z) of functional PEA-AG on enzymatic catalyzed biodegradation property: 8-Phe-4-AG-6-25 (z ¼ 6) and 8-Phe-4-AG-4-25 (z ¼ 4) in 0.1 mg/mL a-chymotrypsin solution and pure PBS of pH 7.4 and 37° C.

FIG. 75. Effect of DL-2-allylglycine (AG) content in functional PEA-AGs on their biodegradation property: 8-Phe-4-AG-4-25 and 8-Phe-4-AG-4-50 in 0.2 mg/mL a-chymotrypsin solution and pure PBS of pH 7.4 and 37° C.

FIG. 76. Effect of a-chymotrypsin concentration on biodegradation property of the functional PEA-AG (8-Phe-4-AG-4-25) at pH 7.4 and 37° C.

FIG. 77. SEM images of morphologic changes of examples of functional PEA-AG films (8-Phe-4-AG-4-25 and 2-Phe-4-AG-4-25) after 6-day incubation in the presence of either a-chymotrypsin solution (0.1 mg/mL) or PBS control at pH 7.4 and 37° C. a, Original (0 day) 8-Phe-4-AG-4-25; b, original (0 day) 2-Phe-4-AG-4-25; c, 8-Phe-4-AG-4-25 in a-chymotrypsin solution at day 6; d, 2-Phe-4-AG-4-25 in a-chymotrypsin solution at day 6; e, 8-Phe-4-AG-4-25 in pure PBS buffer at day 6.

FIG. 78. SEM images of morphologic changes of functional PEA-AG films (8-Phe-4-AG-4-25 and 8-Phe-4-AG-4-50) after 6-day incubation in the presence of a-chymotrypsin solution (0.2 mg/mL) at pH 7.4 and 37° C. a, Original (0 day) 8-Phe-4-AG-4-25; b, original (0 day) 8-Phe-4-AG-4-50; c, 8-Phe-4-AG-4-25 in a-chymotrypsin solution at day 6; d, 8-Phe-4-AG-4-50 in a-chymotrypsin solution at day 6.

### DETAILED DESCRIPTION OF THE INVENTION

The present invention provides amino-acid based PEA (poly(ester amide)) or PEEA (poly(ester ether amide)) polymers with pendant crosslinkable groups and methods of making the same. The present invention also provides reactions of and uses of the polymers.

In one aspect, the present invention provides an amino acid-based poly(ester amide (PEA) or poly(ester ether amide) (PEEA), where the polymers have at least one pendant cross-linking (PXL) group (R′), having Structure I:

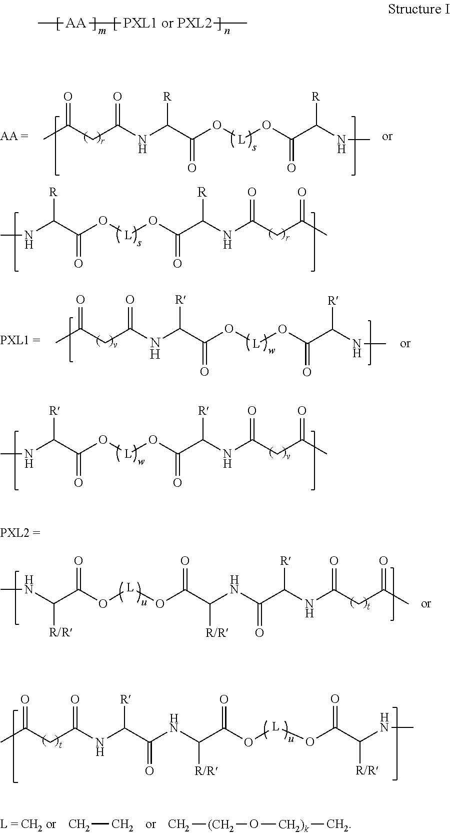

In Structure I, m/n is from 4 to 1. The values of r, v and t are, for example, 2, 4 or 8, and s, w and u are, for example, 2, 4 or 6. R is any side chain from any naturally occurring amino acid (e.g., CH₂-Ph (phenylalanine) or an alkylguanidinium group (arginine). The R group does not have a moiety which can undergo crosslinking reactions or reactions with functionalizing agents that result in formation of a pendant functional group. The R′ group has a pendant cross-linkable group which has a moiety such as, for example, a carbon-carbon double bond (e.g., an allyl group of allylglycine), which can undergo crosslinking reactions or reactions with functionalizing agents that result in formation of a pendant functional group. For example, R′ can be an alkyl group terminated in a carbon-carbon double bond comprising from 3 to 10 carbons, including all integers therebetween. In the L moiety, k is from 1 to 6, including all integers therebetween.

The PEA and PEEA polymers of the present invention have a number averaged molecular weight, Mn, of from 1 kg/mol to 500 kg/mol, including all integers and ranges therebetween. The PEA and PEEA polymers of the present invention have a weight averaged molecular weight, Mw, of from 1 kg/mol to 500 kg/mol, including all integers and ranges therebetween. The Mn and/or Mw can be determined by, for example, gel permeation chromatography. In one embodiment, the PEA and PEEA polymers having Structure I have a number averaged molecular weight, Mn, of from 10 kg/mol to 100 kg/mol, including all integers and ranges therebetween, and/or a weight averaged molecular weight, Mw, of from kg/mol to 100 kg/mol, including all integers and ranges therebetween. In one embodiment, the polymers having Structure I have a Mn of from 20 kg/mol to 50 kg/mol, including all ranges and values to the 0.1 therebetween, and/or a Mw of from 20 kg/mol to 50 kg/mol, including all ranges and values to the 0.1 therebetween.

In one embodiment, the PEA or PEEA of the present invention can have the following general structure which includes Structure II (also referred to as x-AA-y-AG, where AA is an amino acid, x is the number of carbons in the diacid and y is the number of carbon atoms in the diol group linking the two amino acids in the diester monomer):

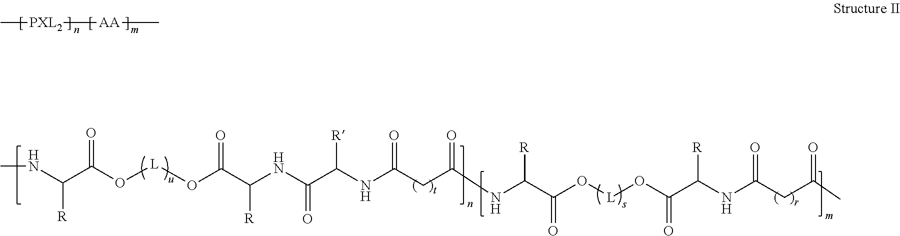

An example of this structure is 8-Phe-4-AG (shown below as Structure III) where in the PXL2 block R is CH₂-Ph, L is CH₂, u is 4, R is CH₂-Ph, R′ is allyl, t is 8 and n is 0.25. In the AA block, R is CH₂-Ph, L is CH₂, s is 4, R is CH₂-Ph and r is 8 and m is 0.75.

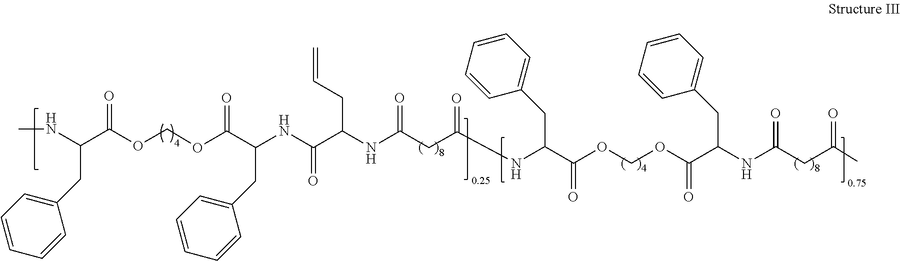

Another example is 8-Arg-4-AG (shown below as Structure IV) where in the PXL2 block, x is R is an alkylguanidinium group (CH₂)₃NH(C(NH₂)═NH⁺), L is CH₂, u is 4, R is an alkylguanidinium group (CH₂)₃NH(C(NH₂)═NH⁺), R′ is allyl, t is 8 and n is 0.25. In the AA block, R is an alkylguanidinium group (CH₂)₃NH(C(NH₂)═NH⁺), L is CH₂, s is 4, R is an alkylguanidinium group (CH₂)₃NH(C(NH₂)═NH⁺) and r is 8, and m is 0.75.

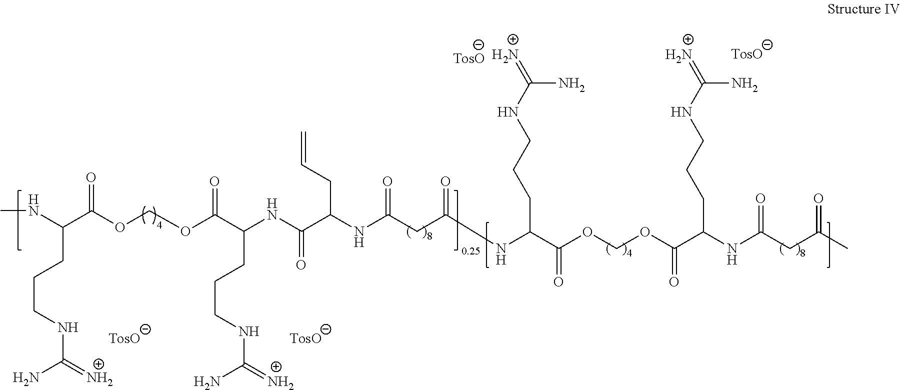

In another embodiment, the PEA or PEEA of the present invention can have the following general structure which includes Structure V (also referred to as x-AA-y-AG-z, where AA is an amino acid, x is the number of carbons in the diacid and y is the number of carbon atoms in the diol group linking the two amino acids in the diester monomer and z is the number of carbons in the diol group linking the two amino acids in the monomer from which the PXL1 block is derived):

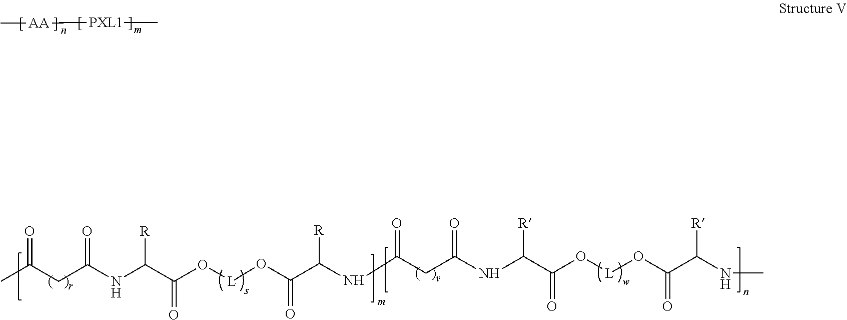

An example of this structure is 8-Phe-4-AG-4 (shown below as Structure VI) where in the AA block, r is 8, R is CH₂-Ph, L is CH₂, s is 4, R is CH₂-Ph and m is 0.75. In the PXL1 block, v is 8, R′ is allyl, L is CH₂, w is 4, R is allyl and n is 0.25.

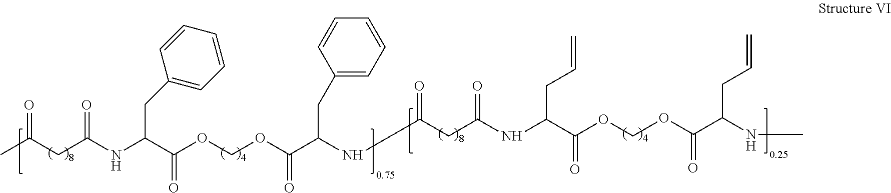

Another example is 8-Arg-4-AG-4 (shown below as Structure VII) where in the AA block, r is 8, R is an alkylguanidinium group (CH₂)₃NH(C(NH₂)═NH⁺), L is CH₂, s is 4, R is an alkylguanidinium group (CH₂)₃NH(C(NH₂)═NH⁺) and m is 0.75. In the FAA1 block, v is 8, R′ is allyl, L is CH₂, w is 4, R is allyl and n is 0.25.

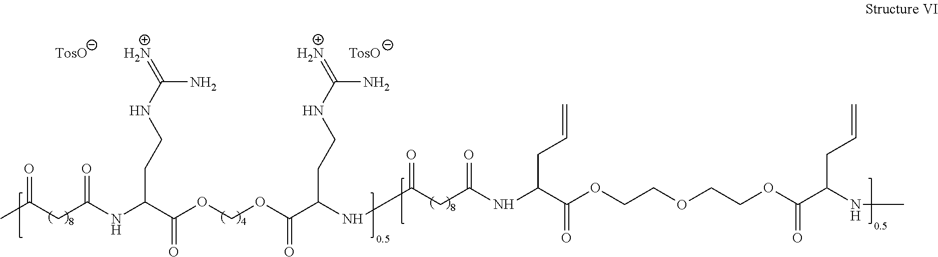

Yet another example is 8-Arg-4-AG-2EG (shown below as Structure VII) where in the AA block, r is 8, R is an alkylguanidinium group (CH₂)₃NH(C(NH₂)═NH⁺), L is CH₂, s is 4, R is an alkylguanidinium group (CH₂)₃NH(C(NH₂)═NH⁺) and m is 0.5. In the PXL1 block, v is 8, R′ is allyl, L is CH₂ (CH₂OCH₂)_{z}CH₂, where z is 1, R′ is allyl and n is 0.5.

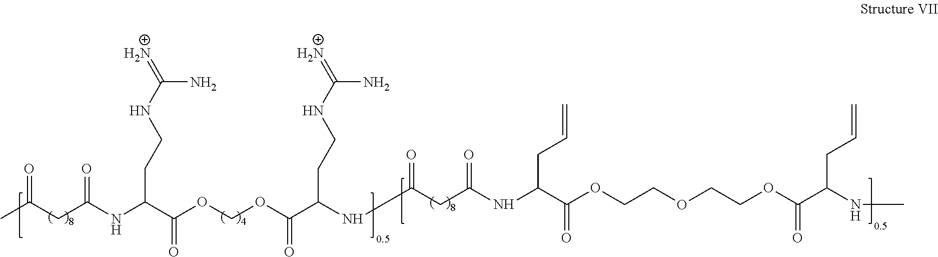

Yet another example is 8-Arg-4-AG-4EG (shown below as Structure VIII) where in the AA block, r is 8, R is an alkylguanidinium group (CH₂)₃NH(C(NH₂)═NH⁺), L is CH₂, s is 4, R is an alkylguanidinium group (CH₂)₃NH(C(NH₂)═NH⁺). In the PXL1 block, v is 8, R′ is allyl, L is CH₂ (CH₂OCH₂)ₖCH₂, where k is 3, R′ is allyl. The values of m and n, respectively, are 0.8, 0.2 or 0.75, 0.25 or 0.67, 0.33 or 0.5, 0.5.

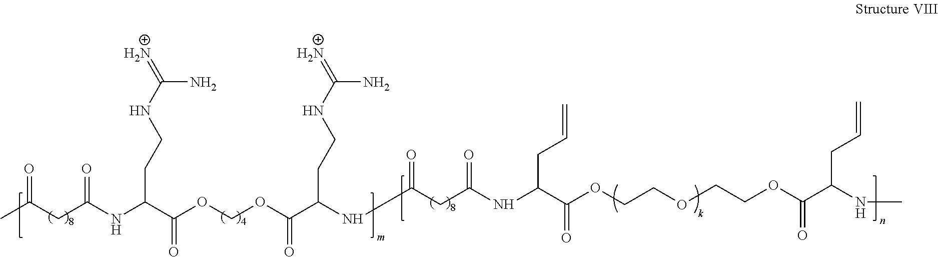

The amino acid-based poly(ester amide (PEA) or poly(ester ether amide) (PEEA) having Structure I can have, for example, an end group of hydrogen (for an amide terminated block) or O(p-nitro)Ph (for a carbonyl terminated block) as shown in Structure IX.

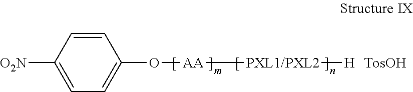

As another example, the end groups of Structure I can both be hydrogen or O(p-nitro)Ph, or end group can be hydrogen and one end group can be O(p-nitro)Ph. The end groups depend on the molar ratio of different monomers. For example, if the amount of Structure XI monomer used is greater than the amount of diester used, both end groups are hydrogens. As another example, if the amount of Structure XI monomer used is equal to the amount of diester used, the end groups are hydrogen on one end of the polymer and O(p-nitro)Ph on the other end. As yet another example, if the amount of Structure XI monomer used is less than the amount of diester used, the end groups are O(p-nitro)Ph.

In another aspect, the present invention provides monomers having Structures X (also referred to as AG-NCA monomer) and XI:

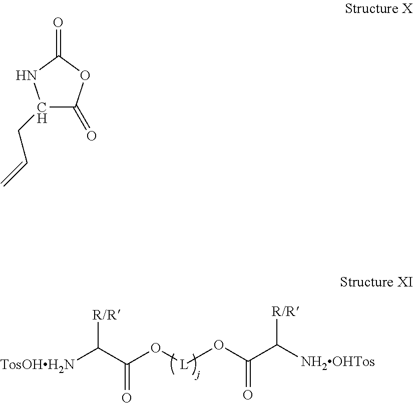

In Structure XI, R and R′ are as defined above. L is a CH₂, CH₂CH₂, or CH₂ (CH₂OCH₂)ₖCH₂, where k is from 1 to 6, moiety and j is from 2 to 6, including all integers therebetween.

In another aspect, the present invention provides hydrogels prepared by crosslinking (e.g., photocrosslinking) of a PEA or PEEA (Structure I). Photocrosslinking can be carried out by UV irradiation. Any photoinitiator can be used. Photoinitiators such as, for example, 2,2-dimethoxy-2-phenylacetophenone (DMPAP) and 4-(2-hydroxyethoxy)phenyl-(2-hydroxy-2-propyl) ketone (Irgacure 2959®). A solvent can optionally be added, depending on the type of photoinitiator used. The UV irradiation can be carried out at from 20 to 30° C., for 5 to 30 minutes. After photocrosslinking, unreacted chemicals can be leached out of the resulting gel. For example, the PEA or PEEA is subjected to UV irradiation (e.g., 10 W of 365 nm radiation for 15 minutes in DMSO) in the presence of a photoinitator (e.g., Irgacure 2959®) such that the PEA or PEEA is crosslinked (e.g., via intramolecular (i.e., intrachain) or intermolecular (i.e., interchain) bonds, or a combination thereof) via covalent bond(s) between blocks in the same polymer chain or different polymer chains.

In one embodiment, the PEA or PEEA is crosslinked in the presence of a poly(ethylene/propylene) glycol that is functionalized at both hydroxyl groups such that a acryloyl group is formed. An example of such a functionalized diol is shown in Structure XII.

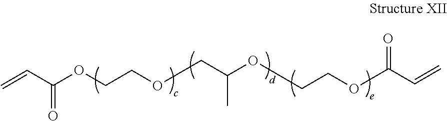

In Structure XII, the value of c can be from 80 to 100, the value of d can be from 25 to 65, and the value of e can be from 80 to 100. The values of c, d and e can be, for example in the case of commercially available F127 Pluronic acid, 95, 62 and 95, respectively. As another example, the values of c, d and e can be, for example in the case of commercially available F68 Pluronic acid, 82, 31 and 82, respectively.

In another aspect, the present invention, the R′ moieties of the PEAs or PEEAs of the present invention have a pendant functional group. For example, the R′ moities can be functionalized such that a pendant functional group is formed. In one embodiment, the pendant functional group is a thiol. For example, the PEAs or PEEAs are reacted with a thiol containing compound (e.g., 3-mercaptopropionic acid, 2-aminoethanethiol hydrochloride and sodium 3-mercapto-1-propanesulfonate). In various embodiments, the pendant function group is hydroxide (—OH), -sulfonic acid (—SO₃H), imidazole, carboxylate (—COOH) and phenol. The pendant groups can be formed by, for example, a Michael addition reaction between the R′ alkene group and an appropriate compound having the desired functionality. For example, R′ can undergo a Michael addition reaction with ethanolamine to form a pendant —OH group, taurine to form a pendant —SO₃H group, 1-(3-aminopropyl)imidazole to form a pendant imidazole group, glycine to form a pendant —COOH group and tyramine to form a pendant phenol group.

In another aspect, the present invention provides hybrid materials which contain the PEAs and/or PEEAs of the present invention and non-PEA/PEEA polymers such as, for example, polysaccharides and aliphatic polyesters. For example, a PEA or PEEA polymer of the present invention can be conjugated, via reaction of a PEA/PEEA R′ moiety (e.g., C═C), to a polylactide, polyglycolide, poly-ε-caprolactone their copolymers, or polysaccharides like maleic dextran, maleic chitosan derivatives to form a hybrid biomaterial.

In one aspect, the present invention provides a method to form PEA or PEEA materials. In one embodiment, monomers having Structure X, Structure XI (e.g., having two R groups or two R′ groups) and a diester are combined under conditions that result in formation of a PEA or PEEA. For example, the PEA or PEEA can have Structure I (e.g., x-AA-y-AG) as follows:

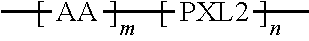

In this embodiment, the amounts of monomers having Structure X and Structure XI incorporated into PEA depend on the desired content of the pendant functional groups on the final PEA polymer, which can be controlled via the molar ratio of Structure X monomer to Structure XI monomer. The molar ratio of Structure X monomer and Structure XI monomer can be from 1 to 1 to 1 to 4. The amount of Structure XI monomer should equal to the amount of diester used.

For example, a mixture of monomers having Structure X and Structure XI and a diester at a predetermined feed ratio in a suitable organic solvent like DMSO, DMF or DMA are combined in a glass reaction vessel equipped with a magnetic stirring bar. The reaction vessel is then heated in an oil bath at a temperature of from 70° C. to 100° C. Trace amounts of triethylamine are added dropwise to the mixture with stirring until the complete dissolution of the three monomers is observed. The reaction vessel is then kept at a temperature of from 70° C. to 100° C. for 48 to 72 hours. The resulting functional PEA or PEEA is precipitated from the reaction solution by adding cold ethyl acetate, followed by filtration, and extraction by ethyl acetate in a Soxhlet apparatus for 48 hours, and finally drying in vacuo at room temperature.

In another embodiment, two monomers having Structure XI and a diester are combined under conditions that result in the formation of a PEA or PEEA. For example, the PEA or PEEA can have Structure I as follows:

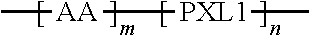

In this embodiment, the amounts of monomers having Structure XI to be incorporated into a PEA or PEEA depend on the desired content of the pendant functional groups on the final PEA or PEEA polymer. The amount of Structure XI used should equal to the amount of diester.

For example, a mixture of monomers having Structure XI and a diester at a predetermined feed ratio in a suitable organic solvent like DMSO, DMF or DMA is placed to a glass reaction vessel equipped with a magnetic stirring bar. The reaction vessel is then heated in an oil bath at a temperature of from 70° C. to 100° C. Trace amounts of triethylamine are added dropwise to the mixture with stirring until the complete dissolution of the three monomers is observed. The reaction vessel is then kept at a temperature of from 70° C. to 100° C. for 48 to 72 hours. The resulting functional PEA or PEEA is precipitated from the reaction solution by adding cold ethyl acetate, followed by filtration, and extraction by ethyl acetate in a Soxhlet apparatus for 48 hours, and finally drying in vacuo at room temperature.

In one aspect, PEA and/or PEEA hydrogels of the present invention can be used to deliver bioactive/active materials in animals. In one embodiment, the hydrogels are used for controlled release of bioactive/active materials. In another embodiment, the hydrogels can be used to deliver cells. In yet another embodiment, the hydrogels can be used to deliver basic fibroblast growth factor (bFGF).

In one embodiment, the bioactive/active materials are covalently bound to the hydrogel. Covalent bonding of bioactive materials to PEA polymers is described in, for example, patent application no. PCT/US2010/000954. In another embodiment, the bioactive/active materials are ionically bound to the hydrogel. In yet another embodiment, the bioactive/active material is encapsulated (or entrapped) by the hydrogel. The bioactive/active material is released as a result of metabolic action on the hydrogel.

In another aspect, PEA and/or PEEA hydrogels of the present invention can be used as a temporary skin cover. For example, the hydrogels can be used as a wound dressing or artificial skin. In one embodiment, the hydrogel contains a antimicrobial agent and/or wound healing growth factor.

In yet another aspect, the PEA and/or PEEA hydrogels can be used as functional components in microdevices such as, for example, biosensors. For example, a hydrogel with a pendant functional group that is sensitive to an environmental stimuli such as, for example, pH, metal ion concentration, or environmental stimuli that can affect hydrogel properties such as, for example, swelling ratio.

In still another aspect, the PEA and/or hydrogels of the present invention can be used in applications where hydrogels are conventionally used. For example, as thickeners, for moisture release in plants, for fluid uptake and retention in applications in the sanitary area, as hydrophilic coatings for textiles, for use in contact lenses and as diffusion gels in chromatography and electrophoresis applications.

In one embodiment, the present invention describes at least two alternative methods of fabricating two new families of functional PEA or PEEA copolymers and their derivatives. Both of these functional PEA or PEEA copolymer families (x-AA-y-AG and x-AA-y-AG-z) have one common amino acid derivative, allyglycine (AG), which provides the pendant functional carbon to carbon double bonds to the resulting functional PEA copolymers. AA stands for amino acids other than allyglycine. In this embodiment, phenylalanine (Phe) and arginine (Arg) are used as the model amino acid to represent AA. These functional PEA or PEEA copolymers with allyglycine segment can be synthesized by two different methods, depending on how allyglycine is used in the synthesis scheme.

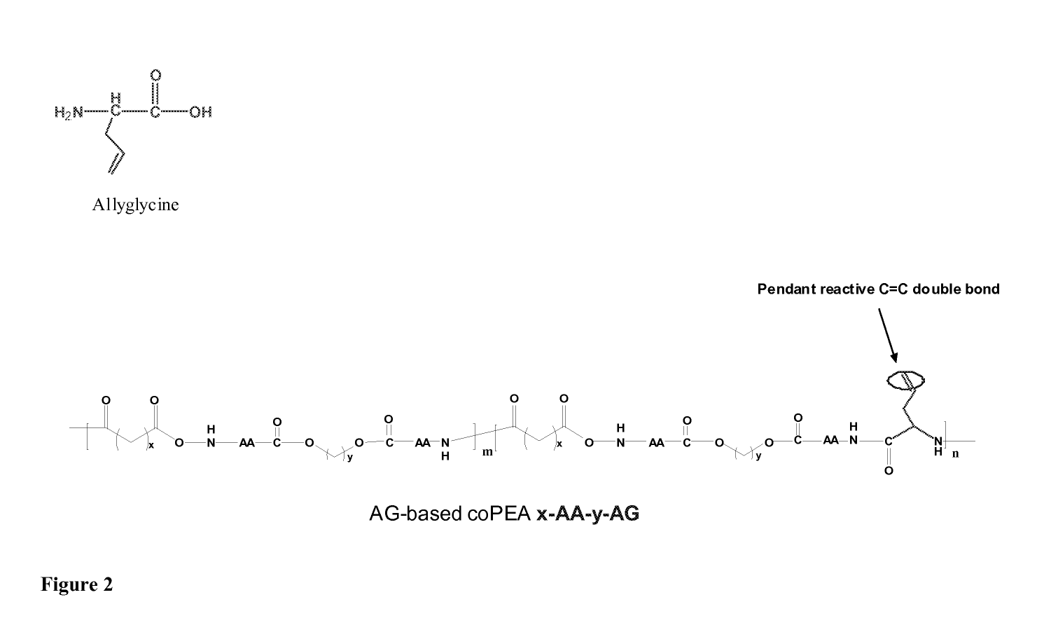

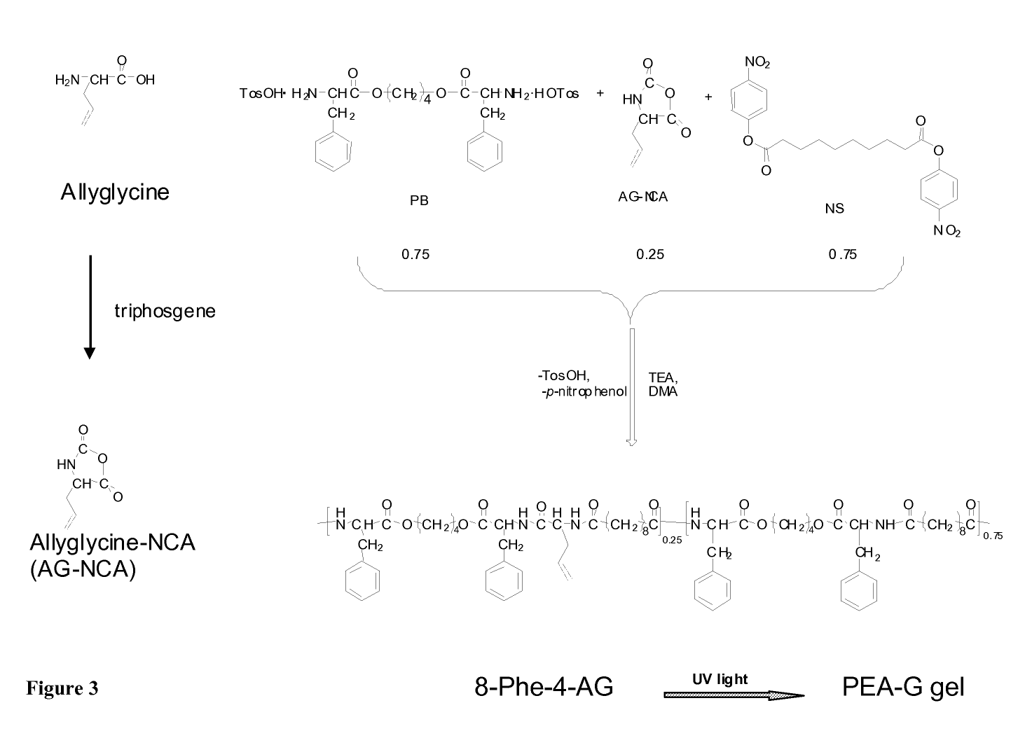

In a first method of this embodiment, AG is converted into AG-NCA monomer (Structure X) via known methods for the synthesis of Lys-NCA (for amine functionality), Ser-NCA (for hydroxyl functionality) and Glu-NCA (for carboxylic acid functionality) monomers described in, for example, patent application no. PCT/US2010/000954. The functional PEA or PEEA copolymers prepared under this 1st method may be labeled as x-AA-y-AG and have the general structure exemplified in (Structure 2 and FIGS. 2 and 3).

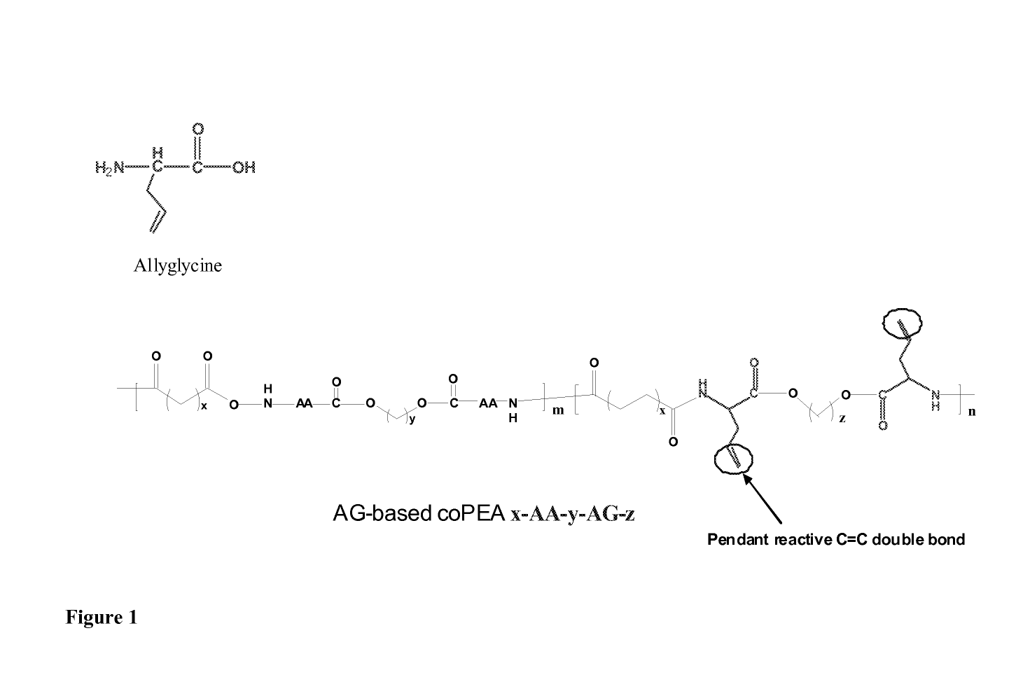

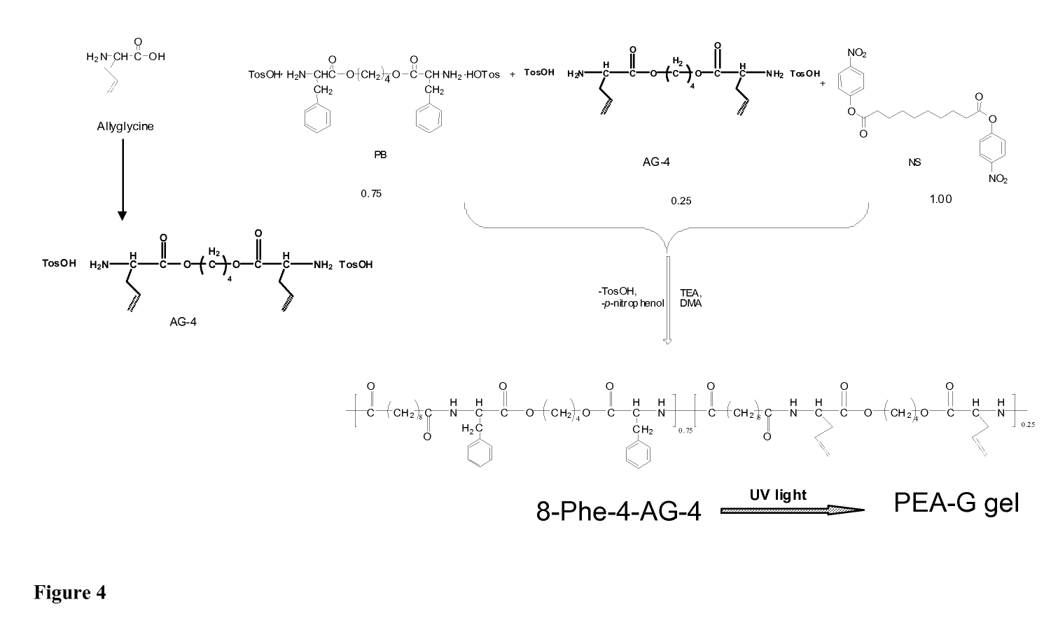

In a second method of this embodiment, the copolymers are prepared by a method using a toluenesulfonic acid salt of an amino acid. Instead of the regular alpha amino acids like phenylalanine, leucine, arginine, an AG amino acid derivative is used to make the toluenesulfonic acid salt of AG monomer. The functional PEA or PEEA copolymers prepared under this second method may be labeled as x-AA-y-AG-z, where z indicates the number of methylene groups in the diols that are used (e.g., see Structure 5 and FIGS. 1 and 4).

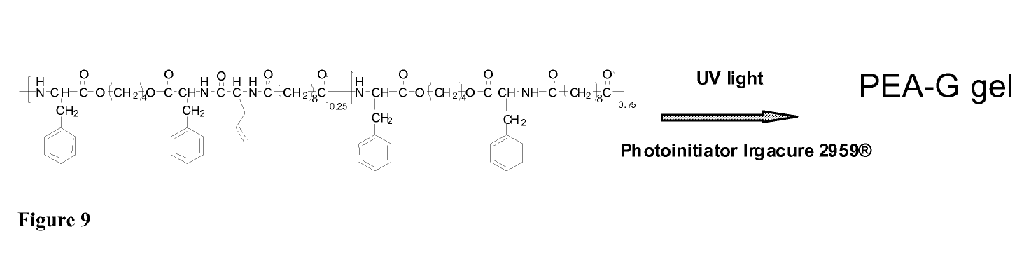

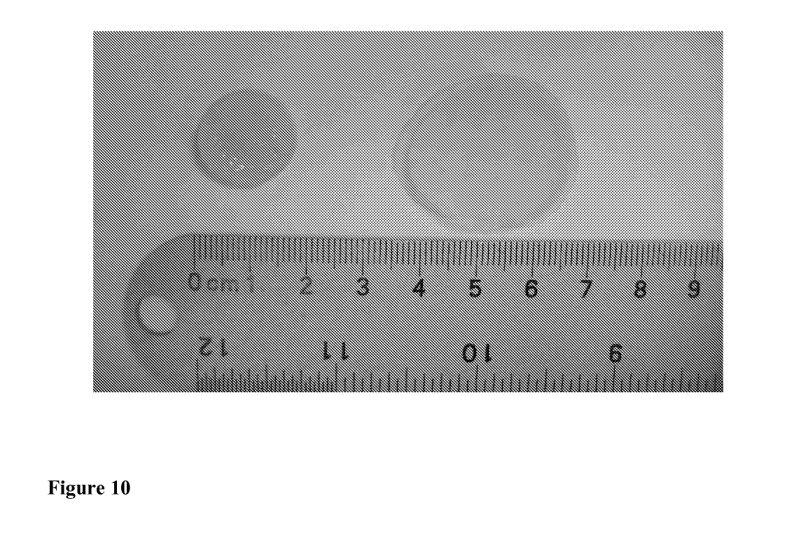

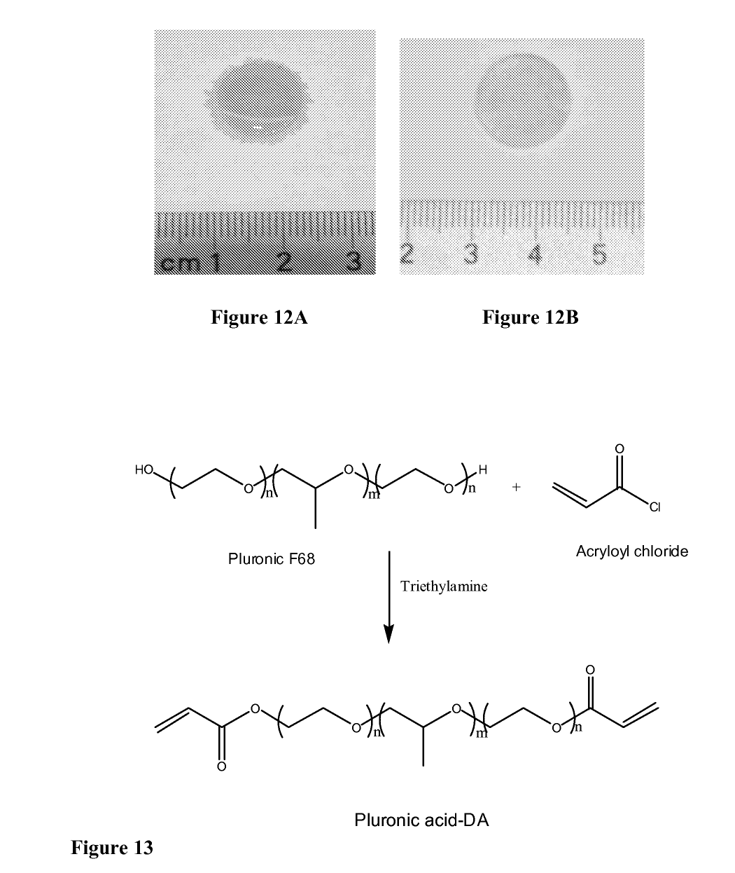

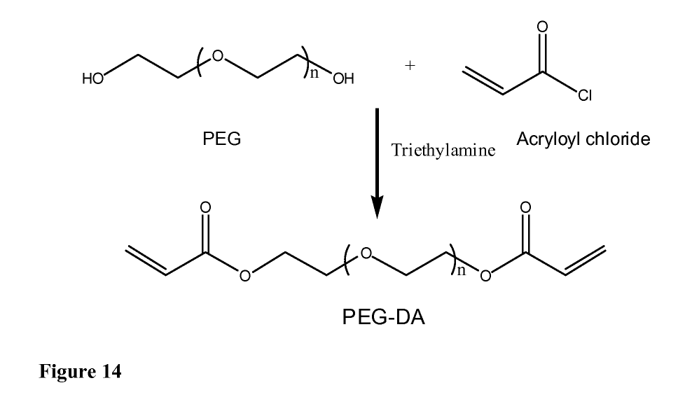

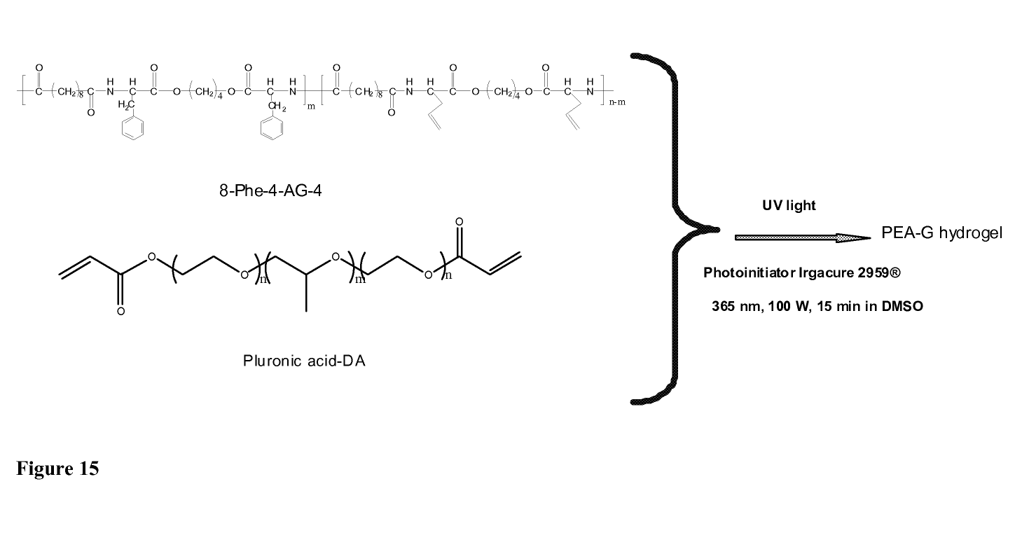

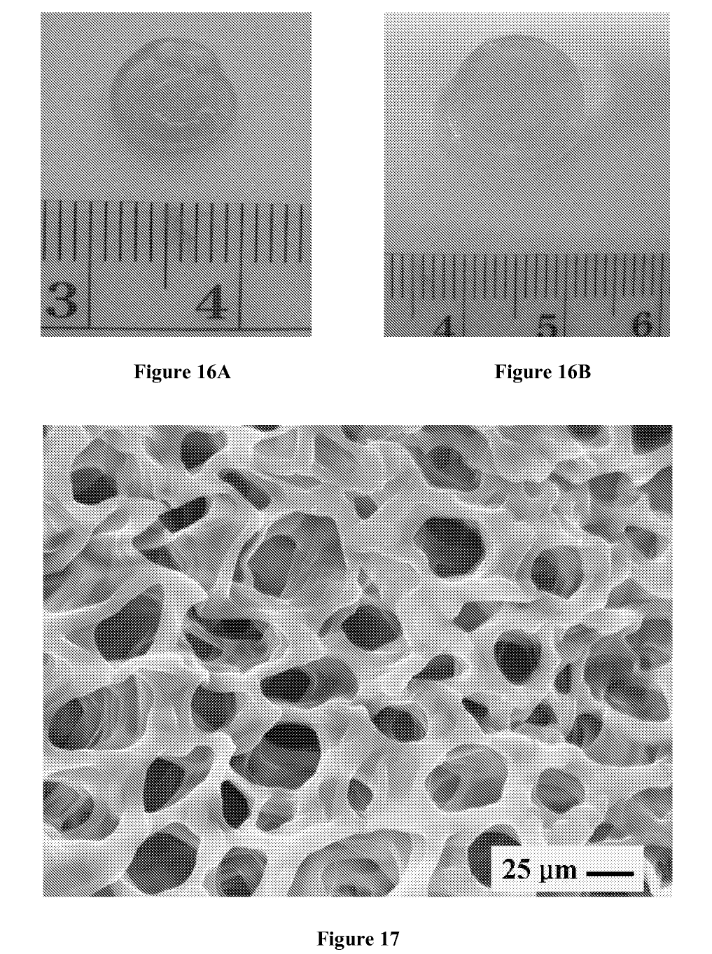

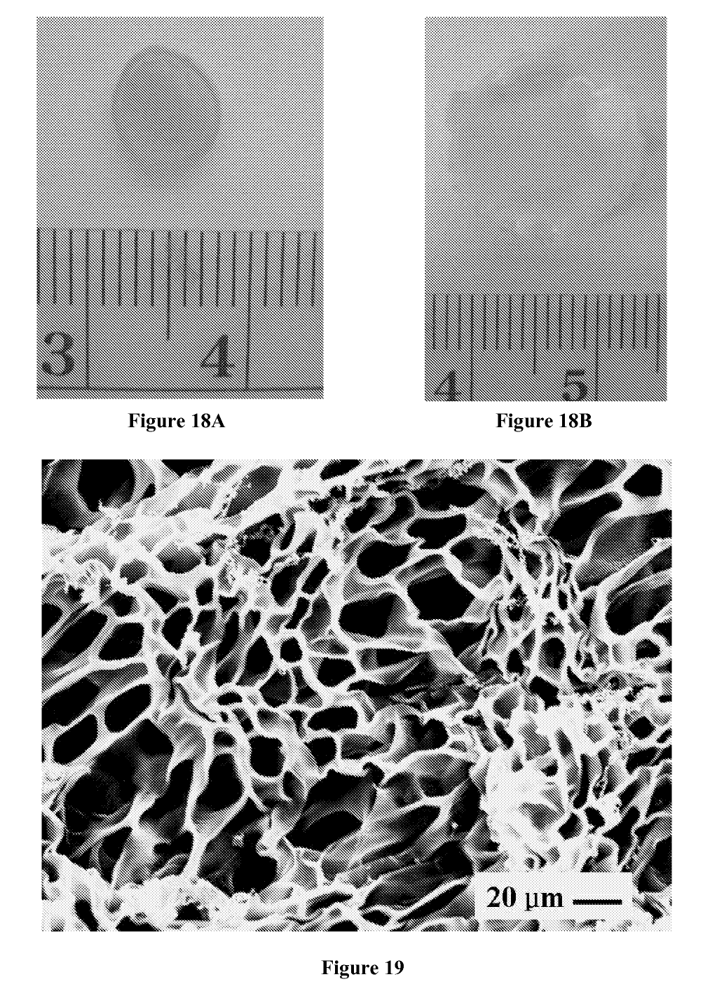

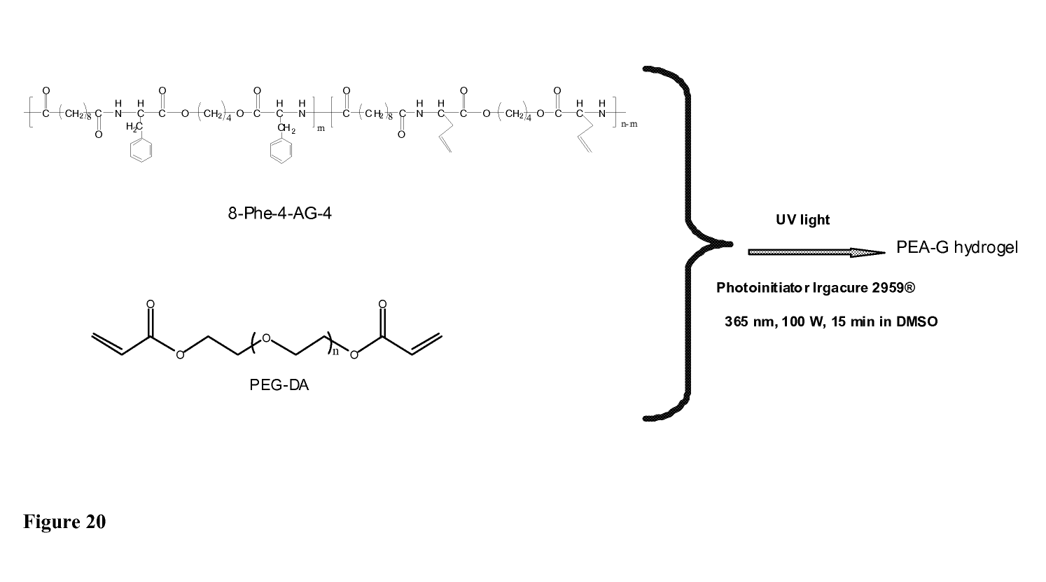

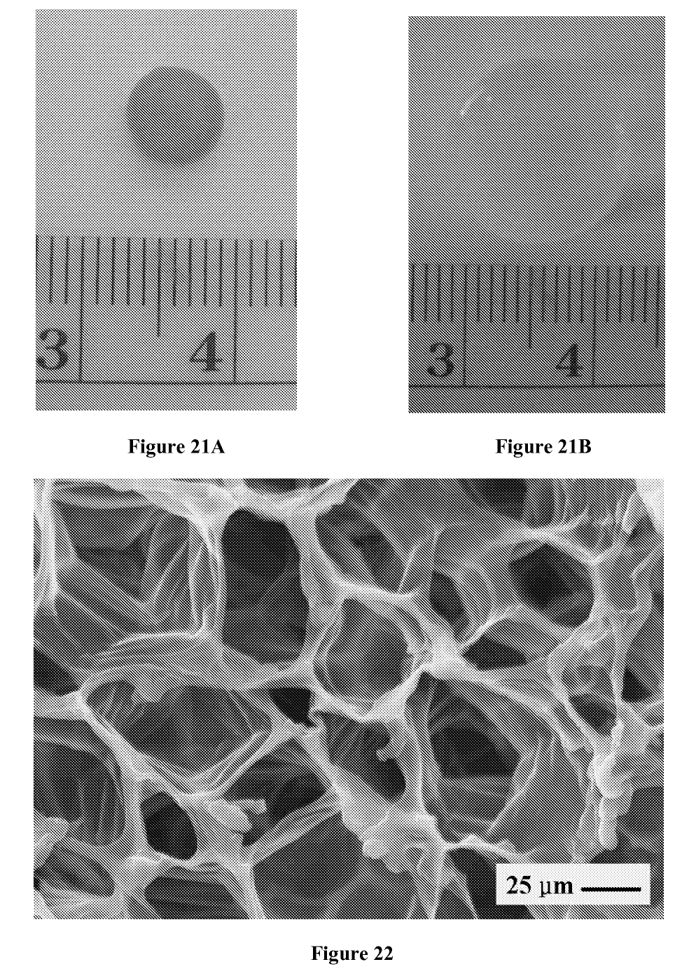

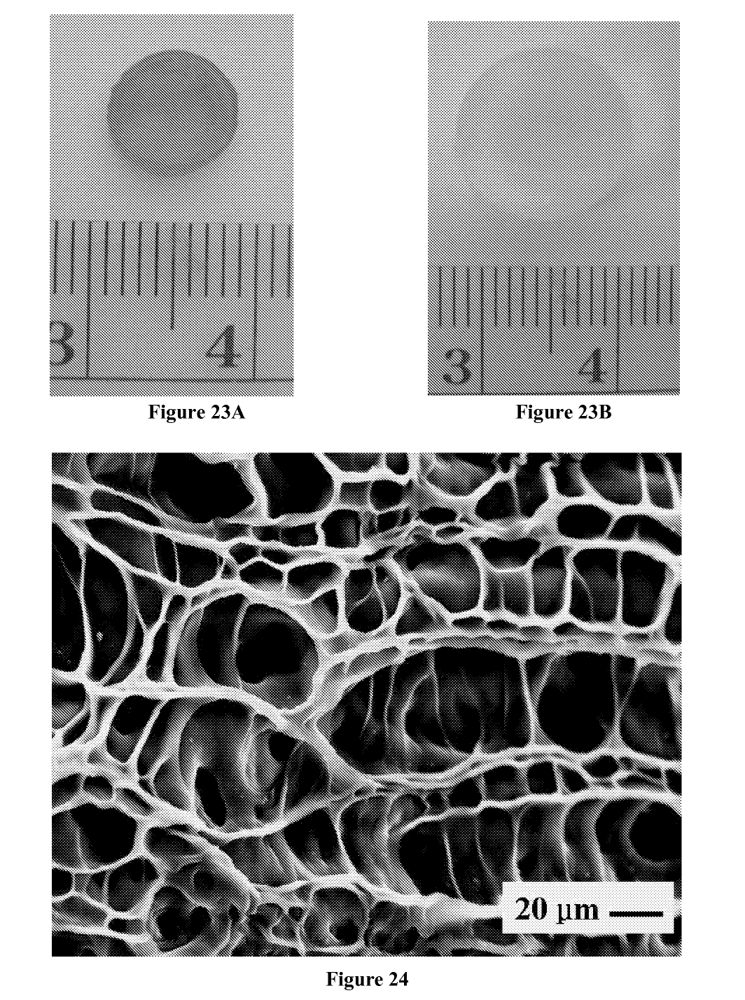

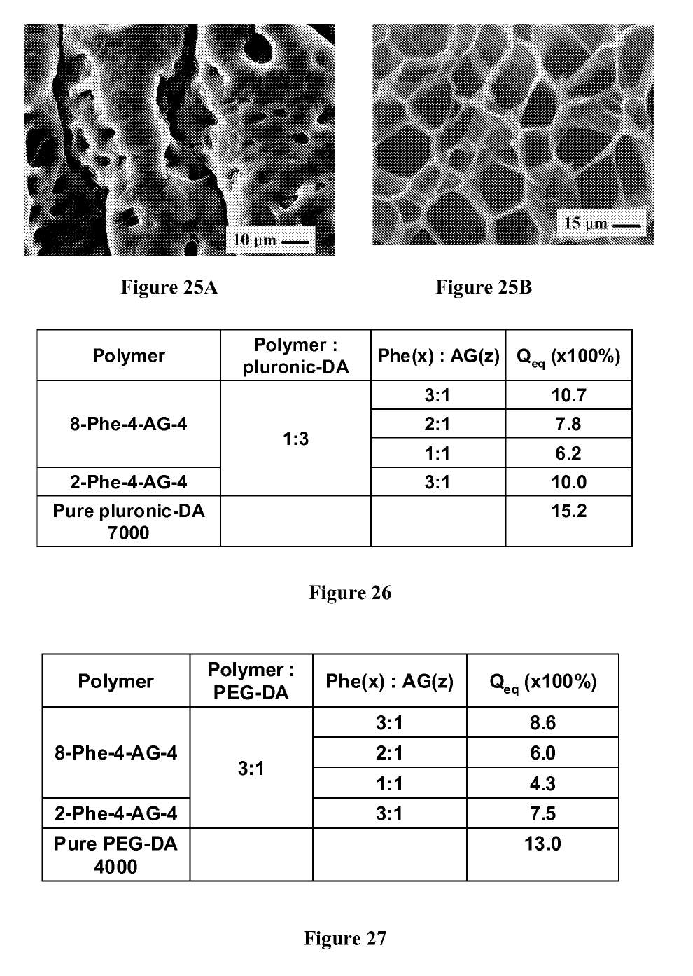

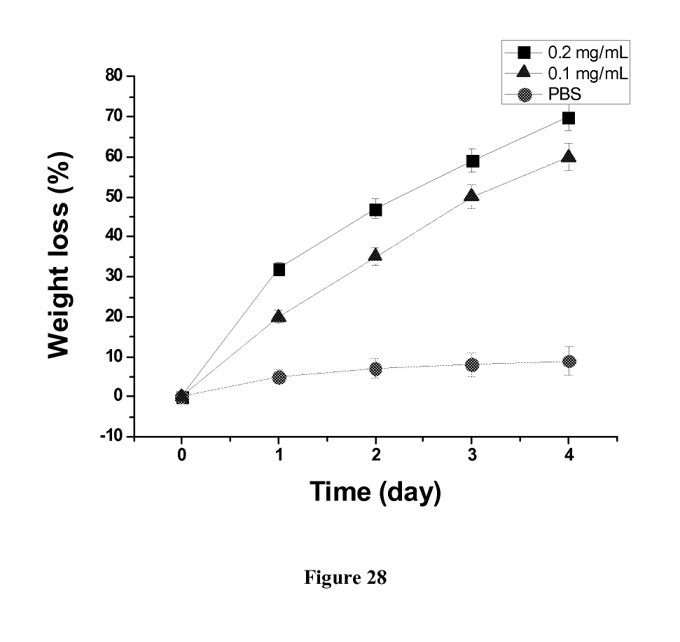

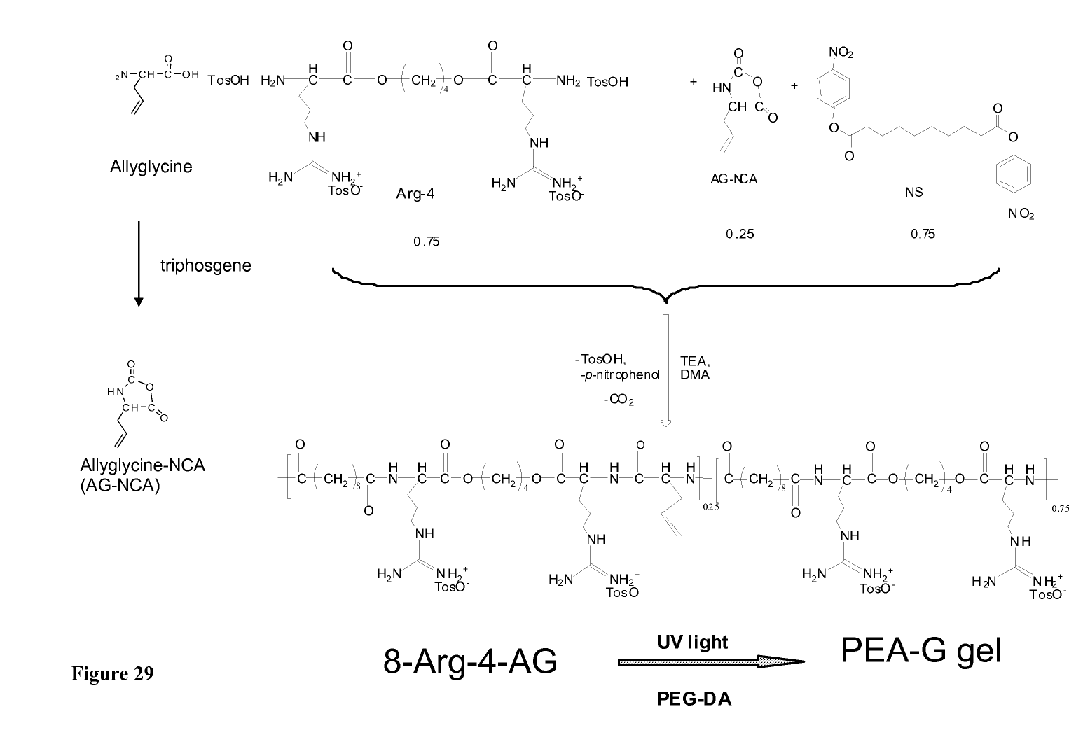

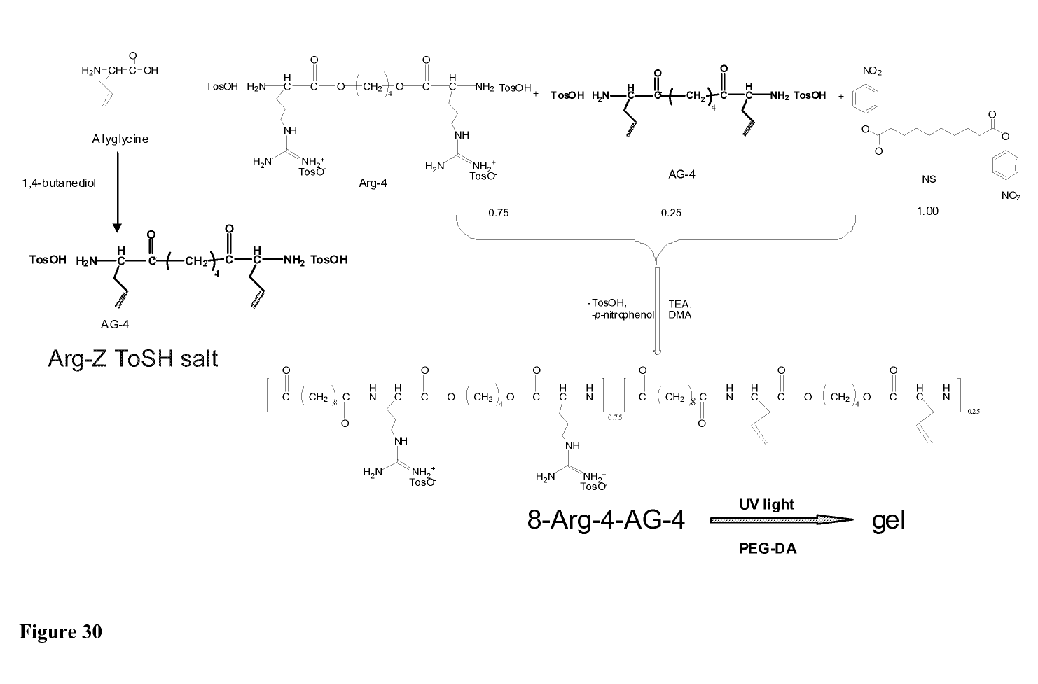

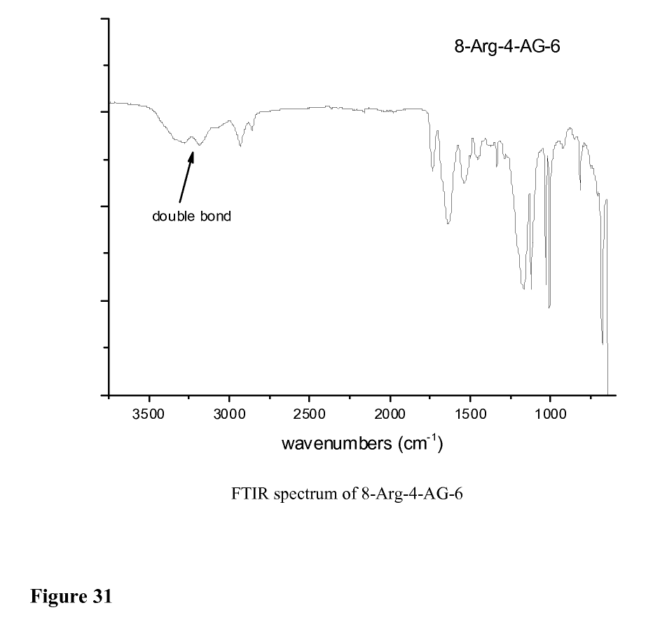

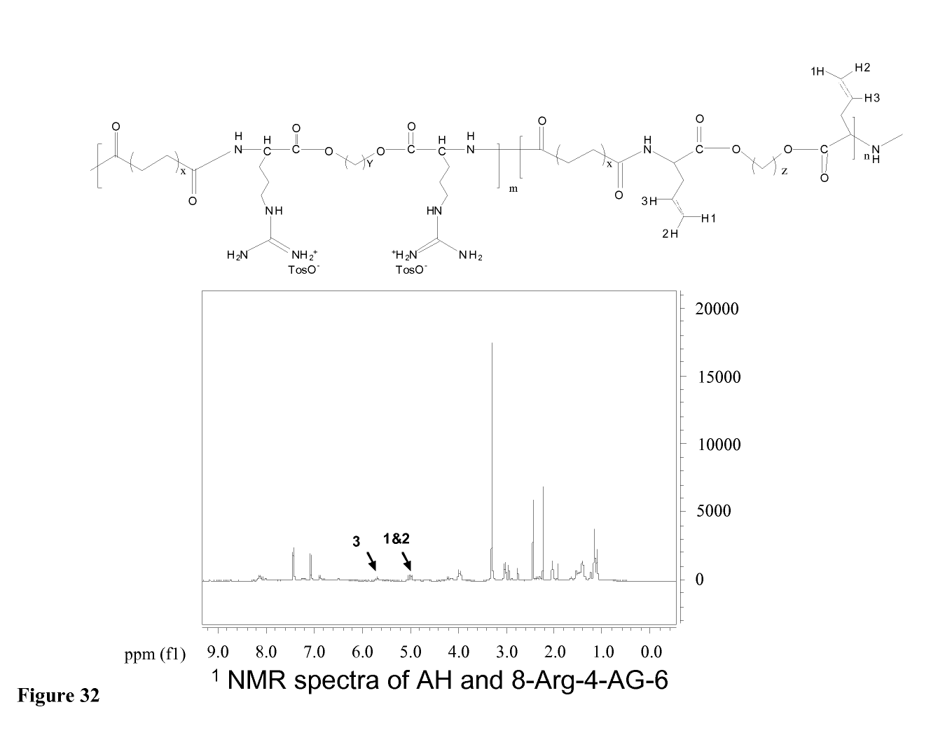

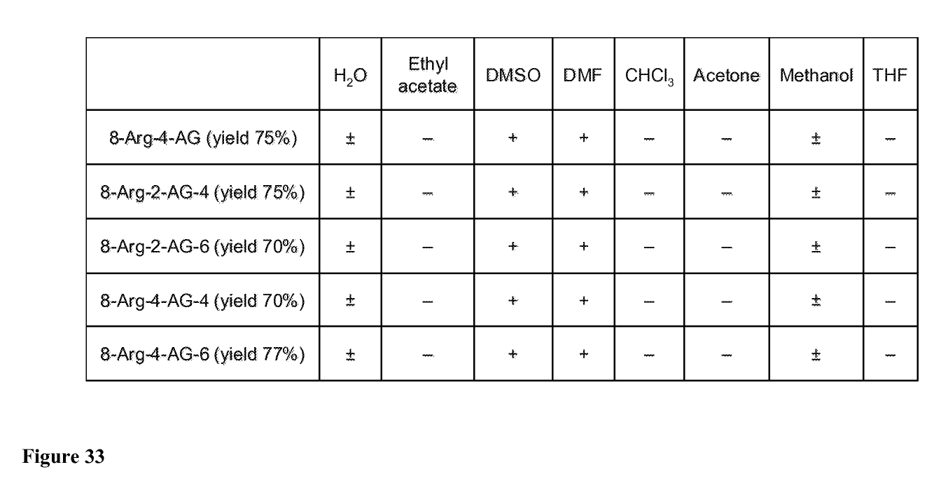

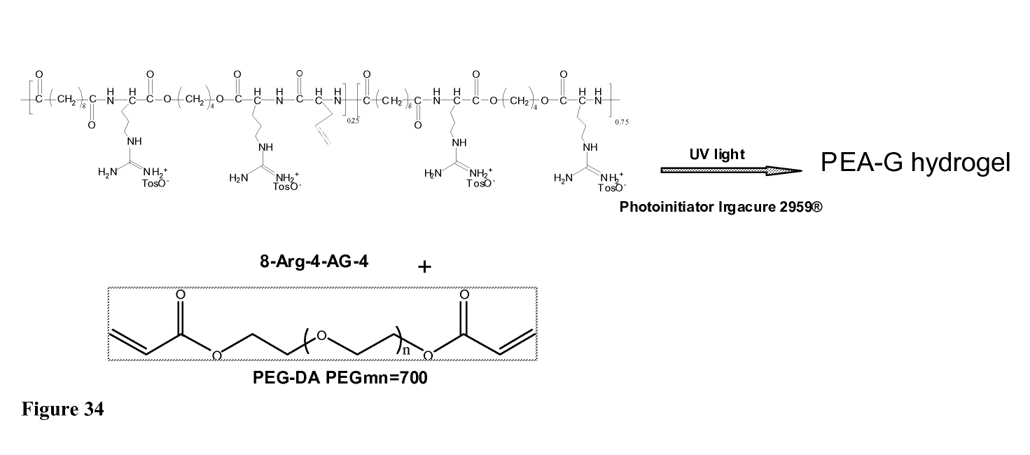

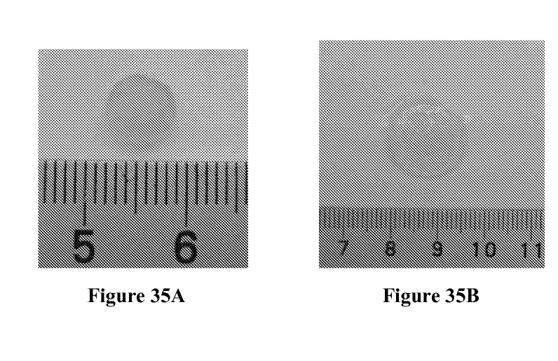

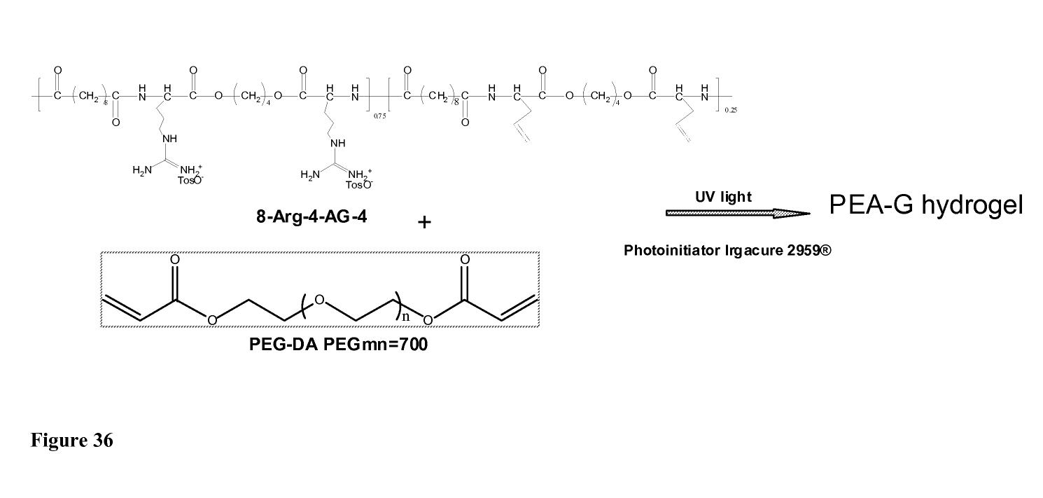

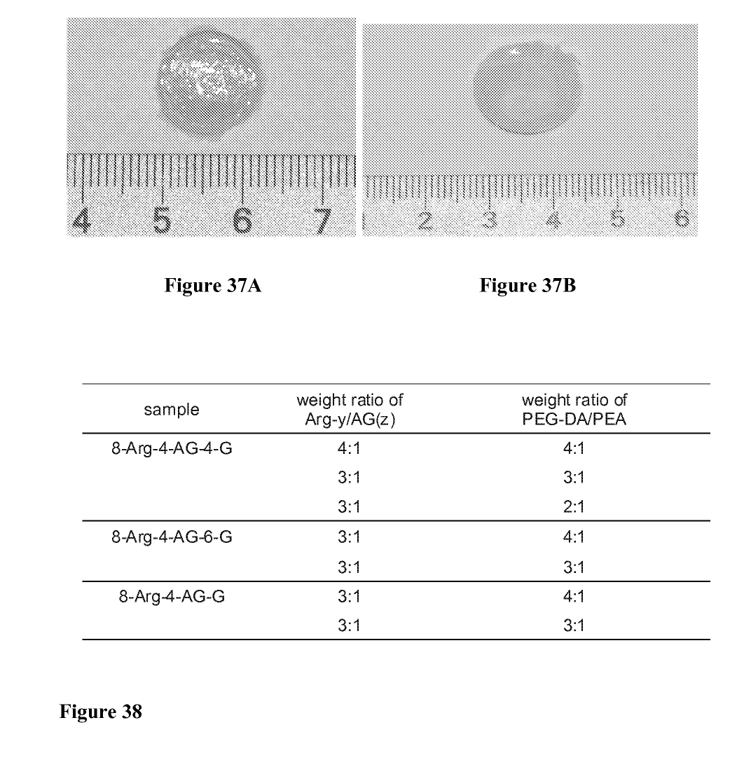

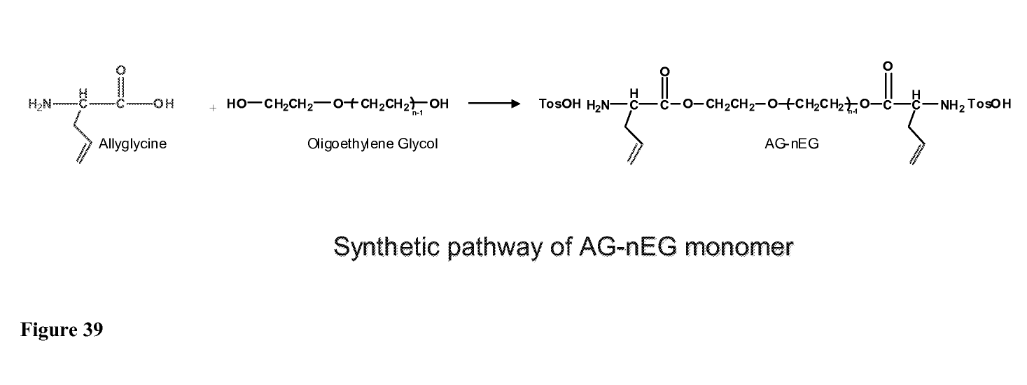

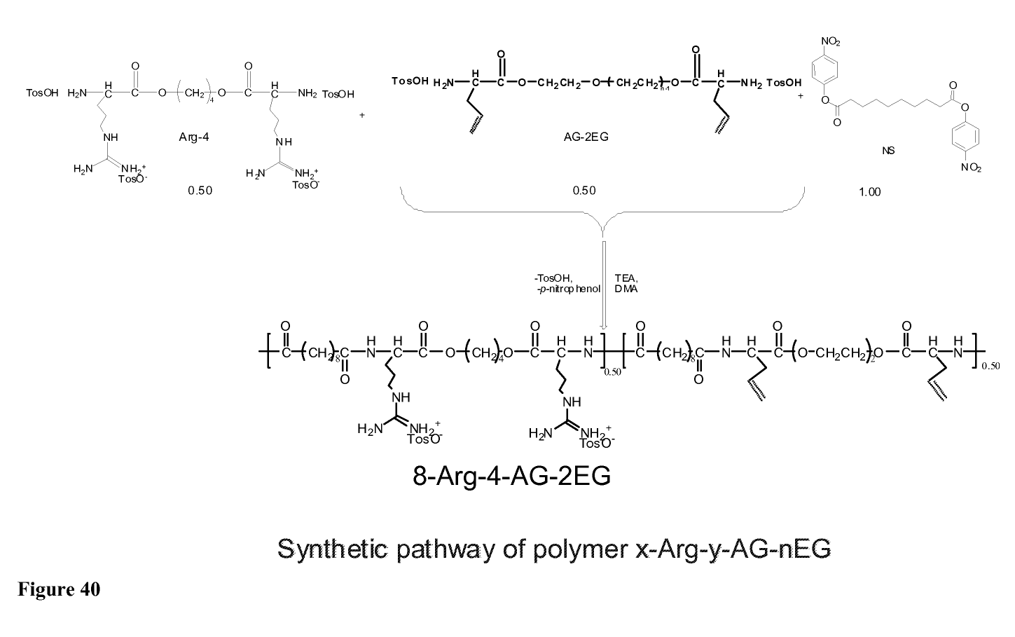

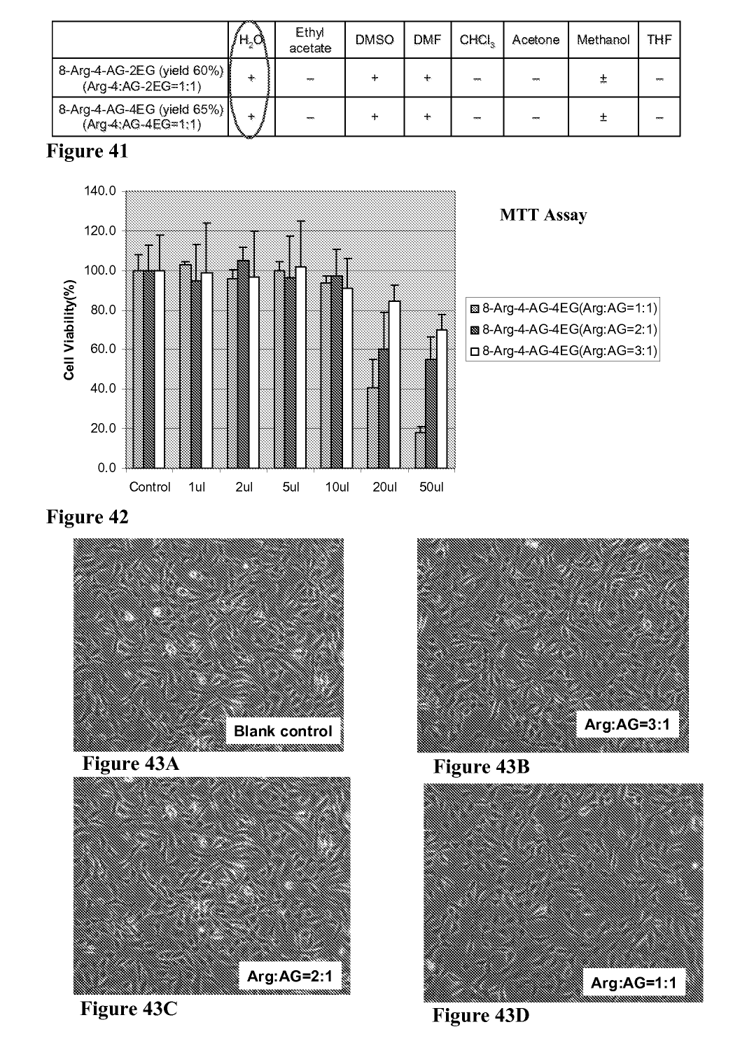

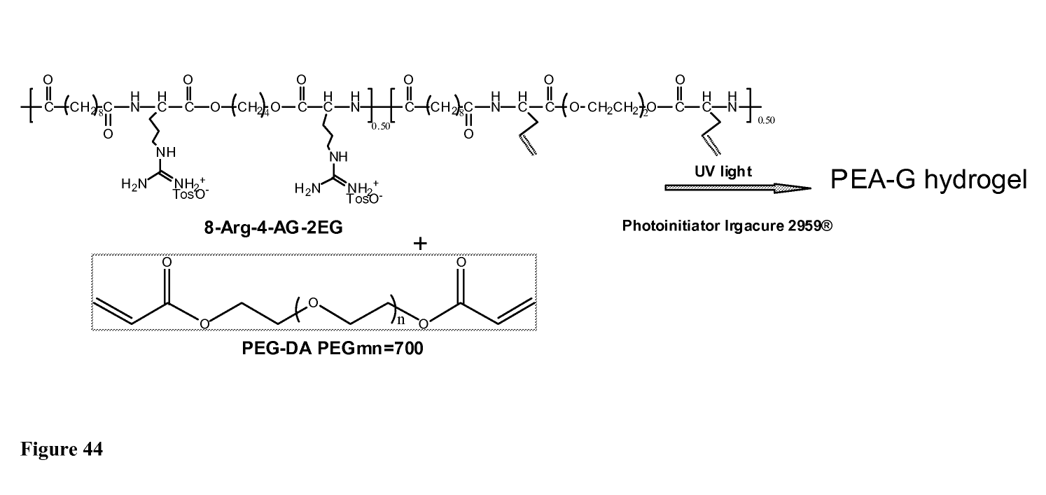

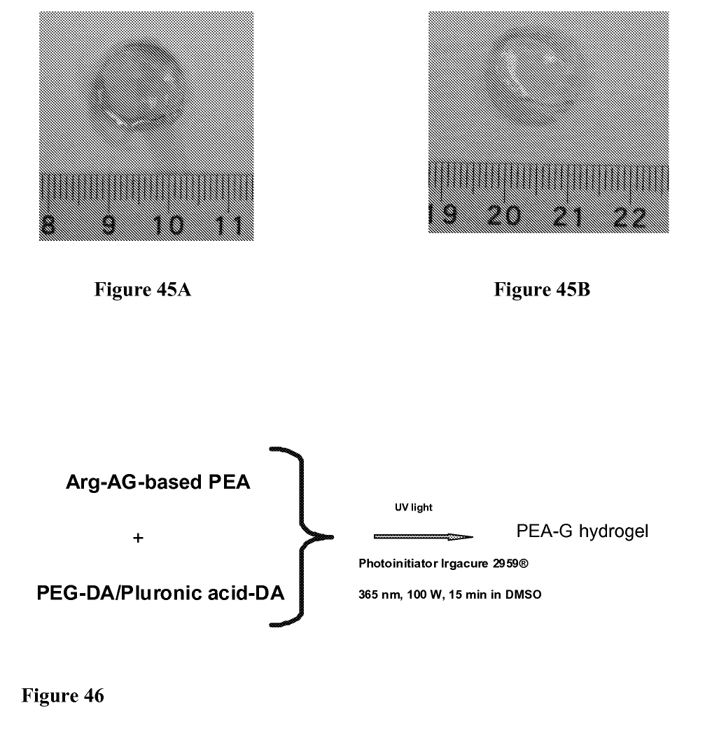

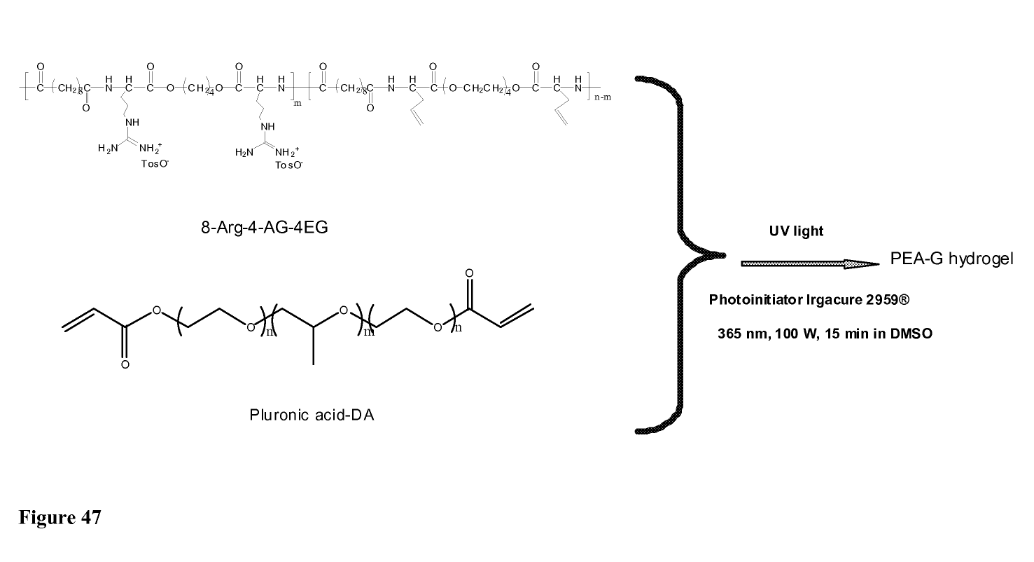

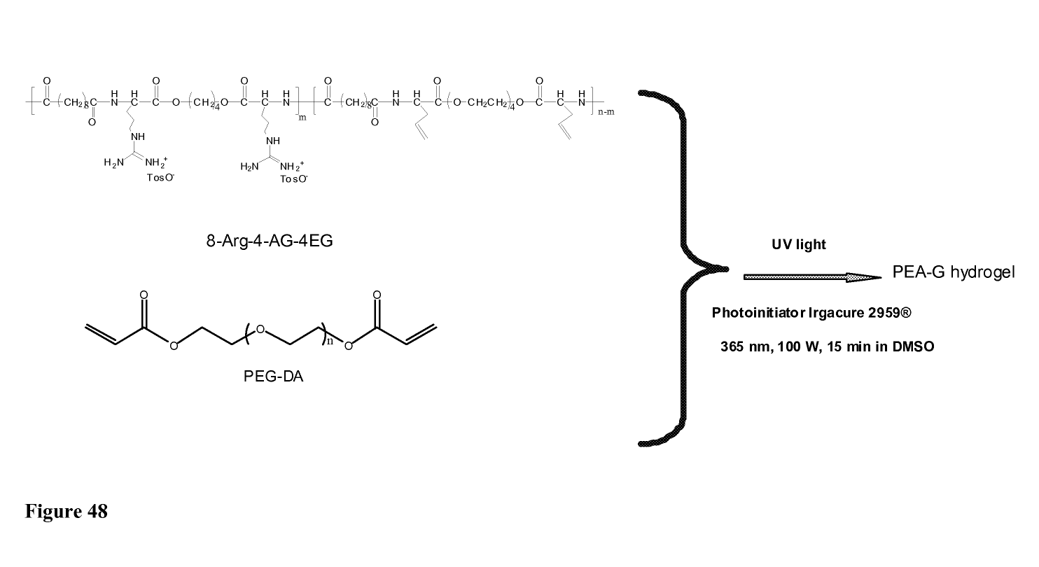

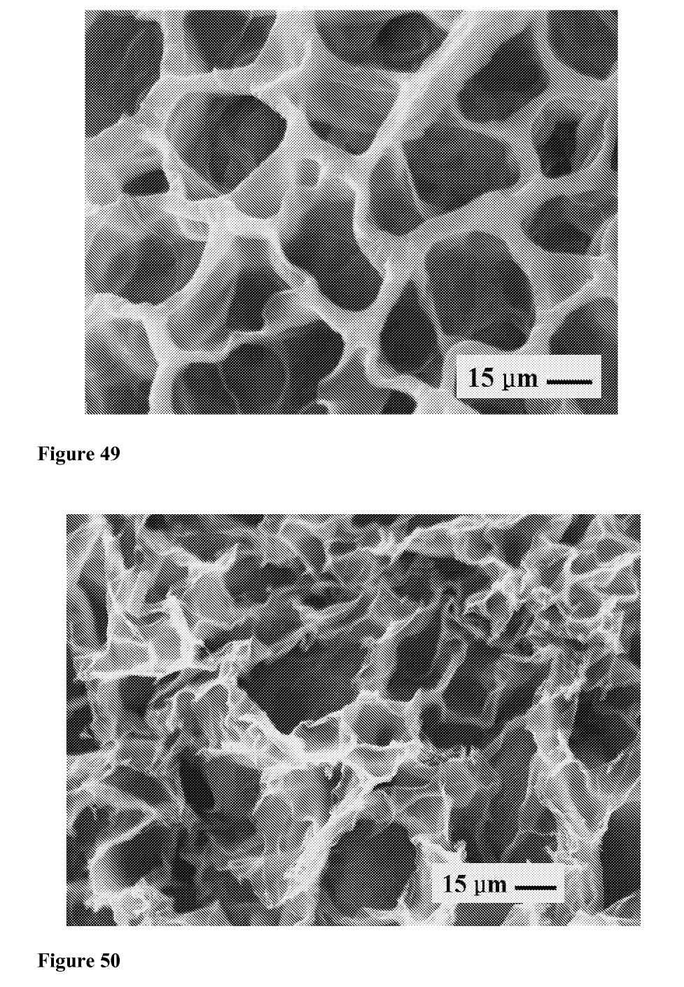

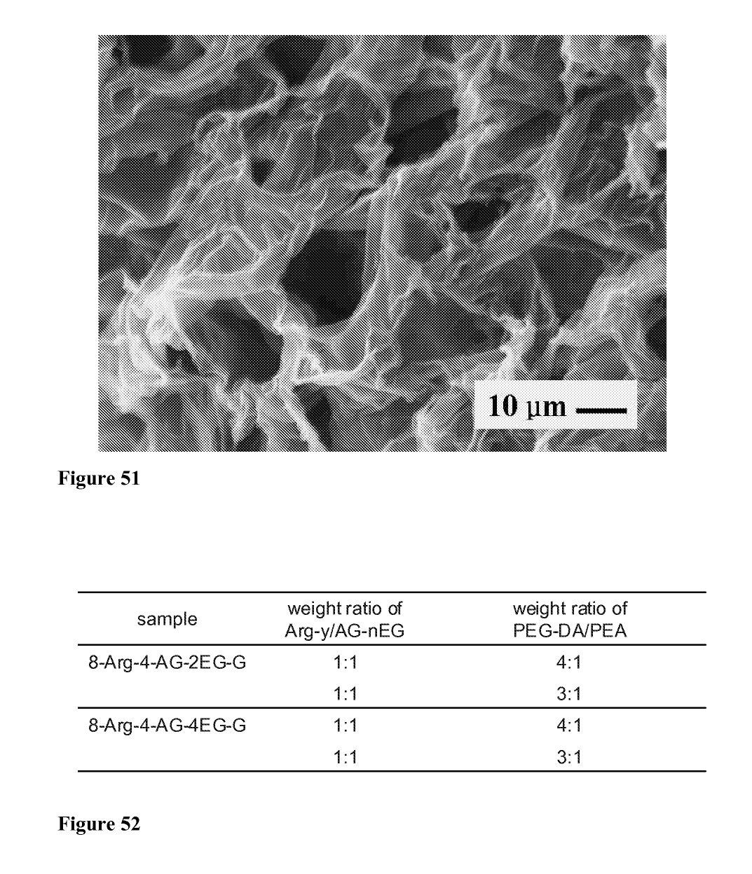

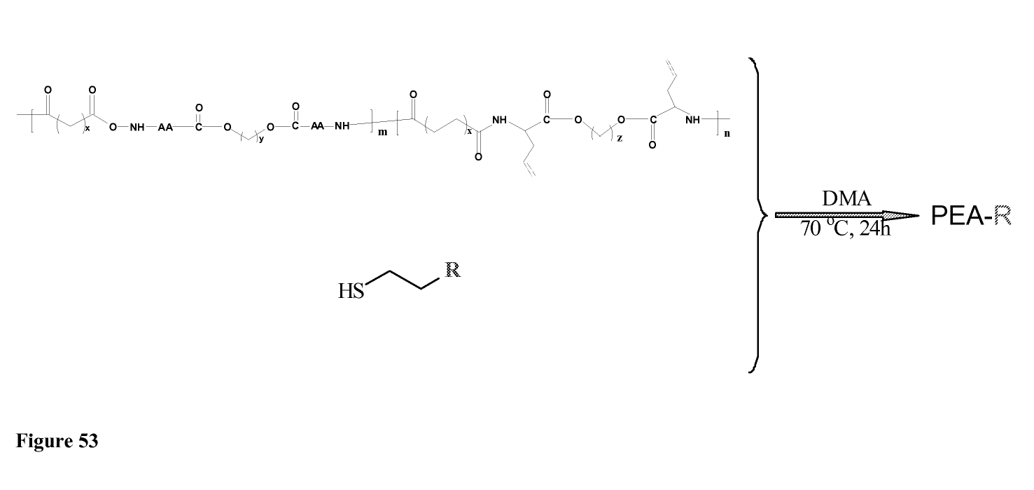

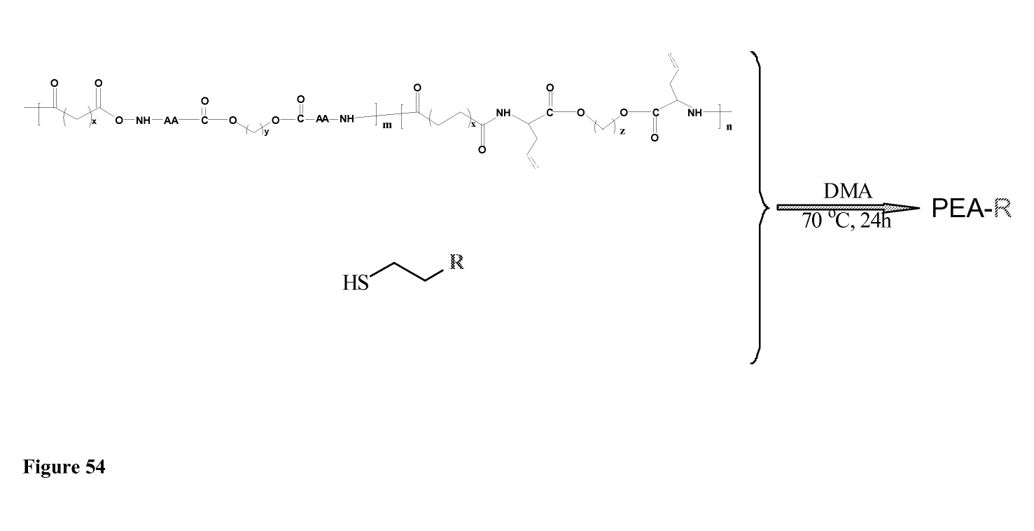

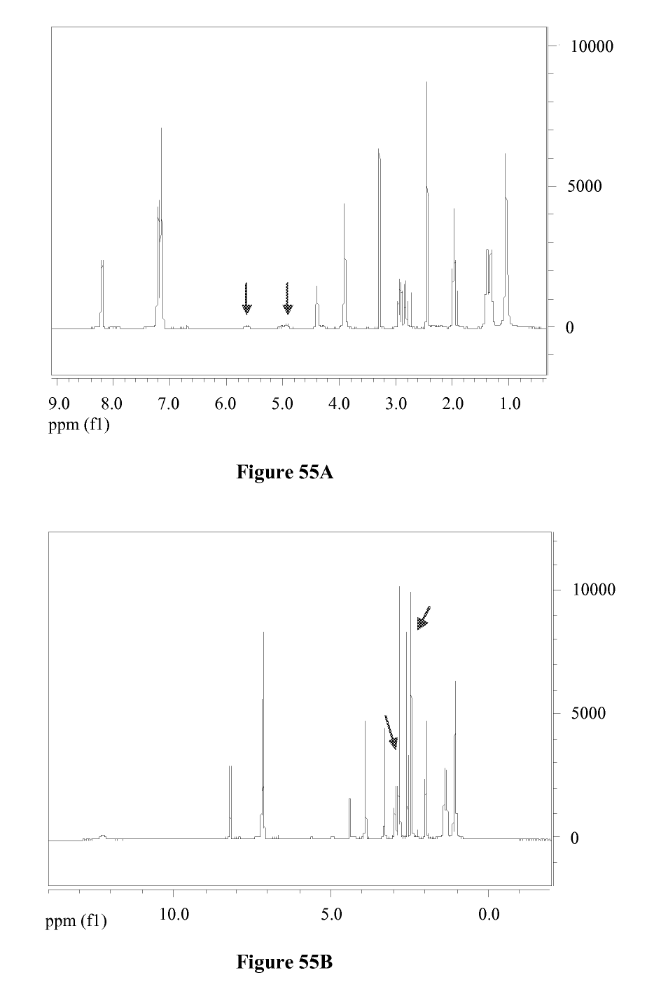

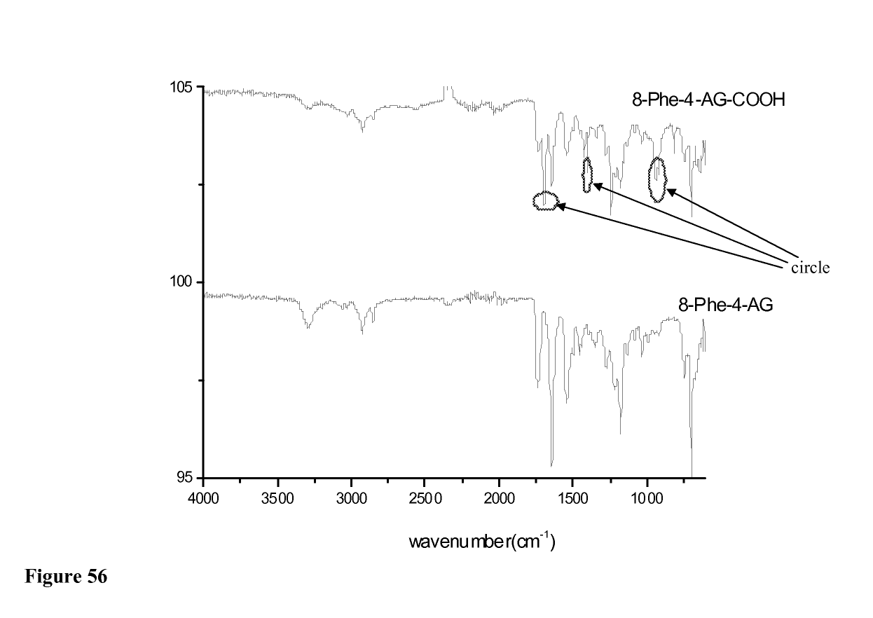

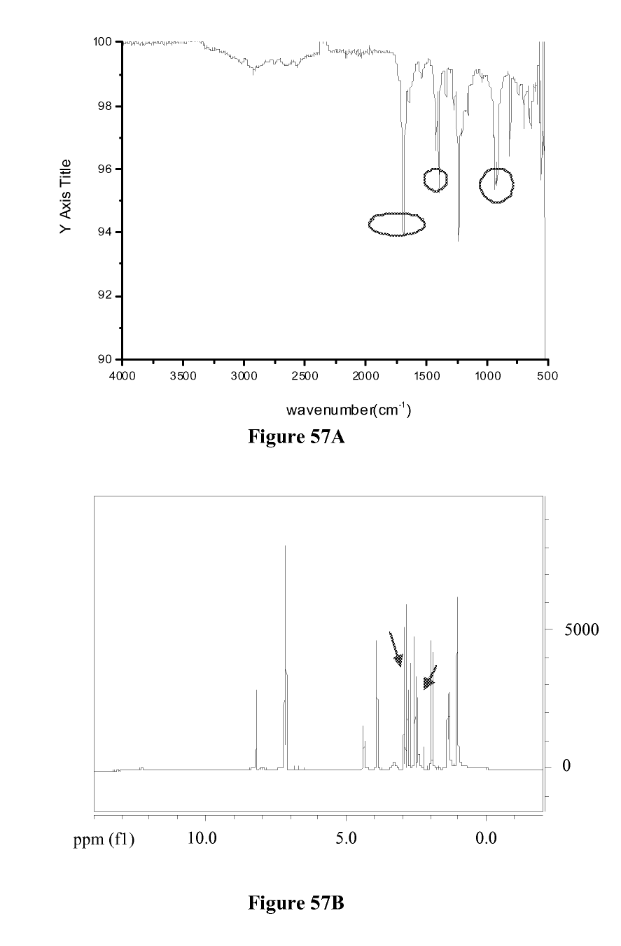

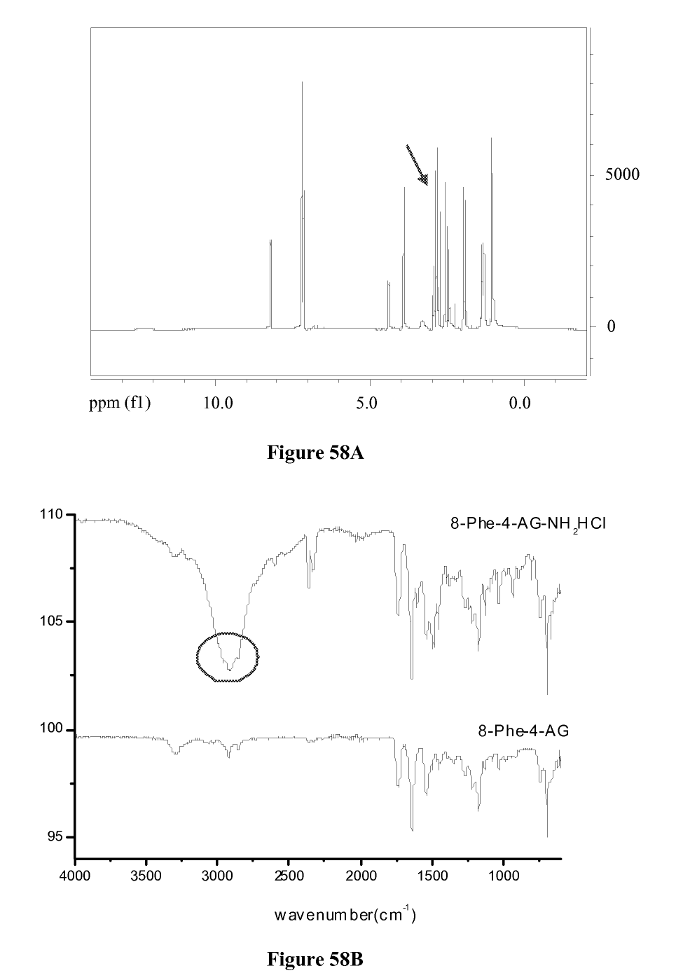

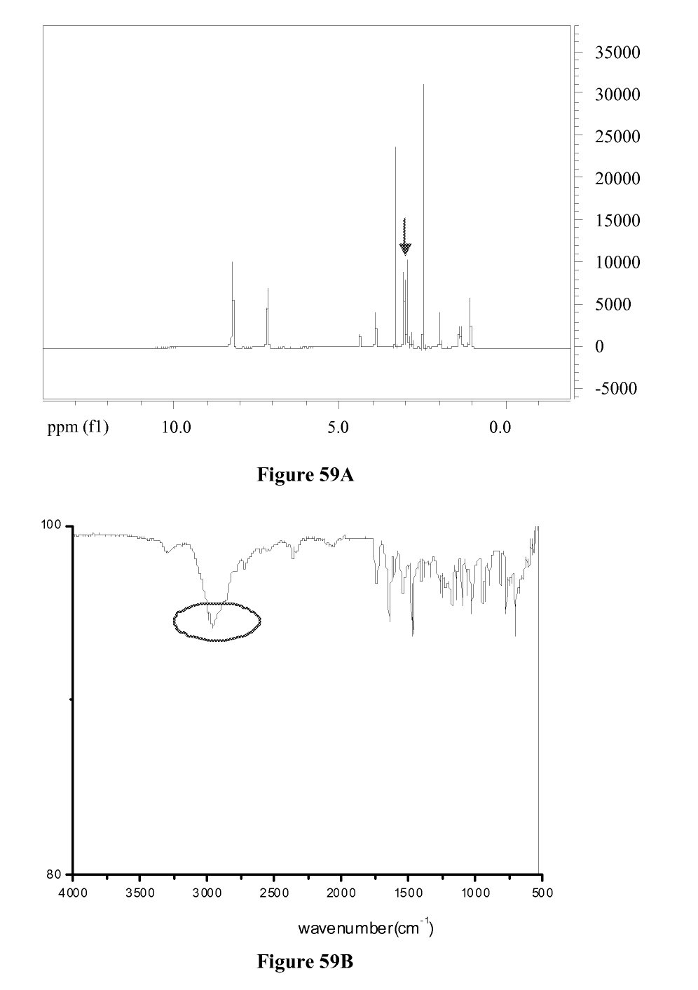

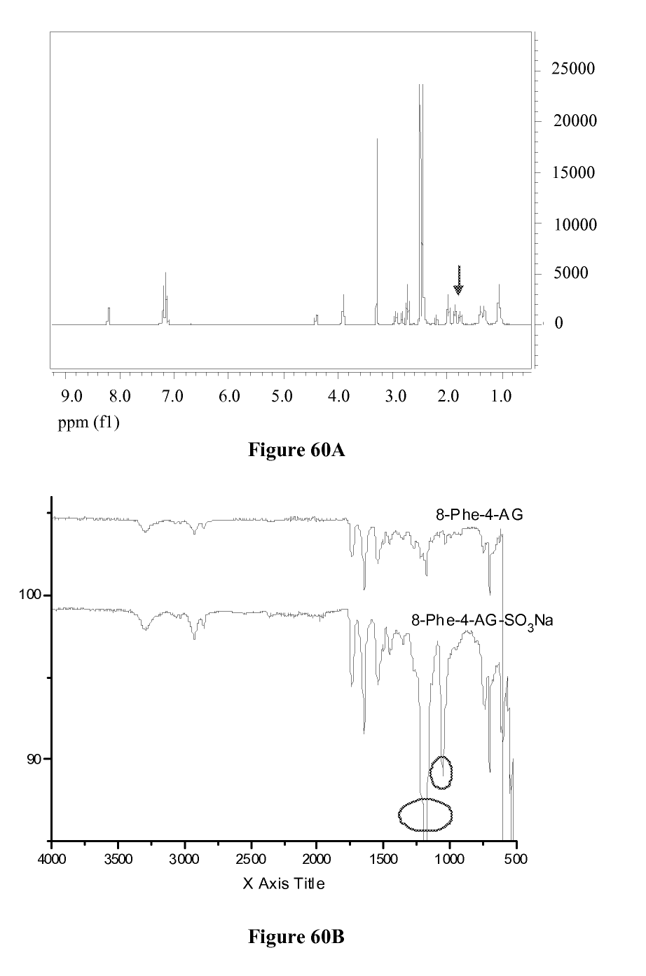

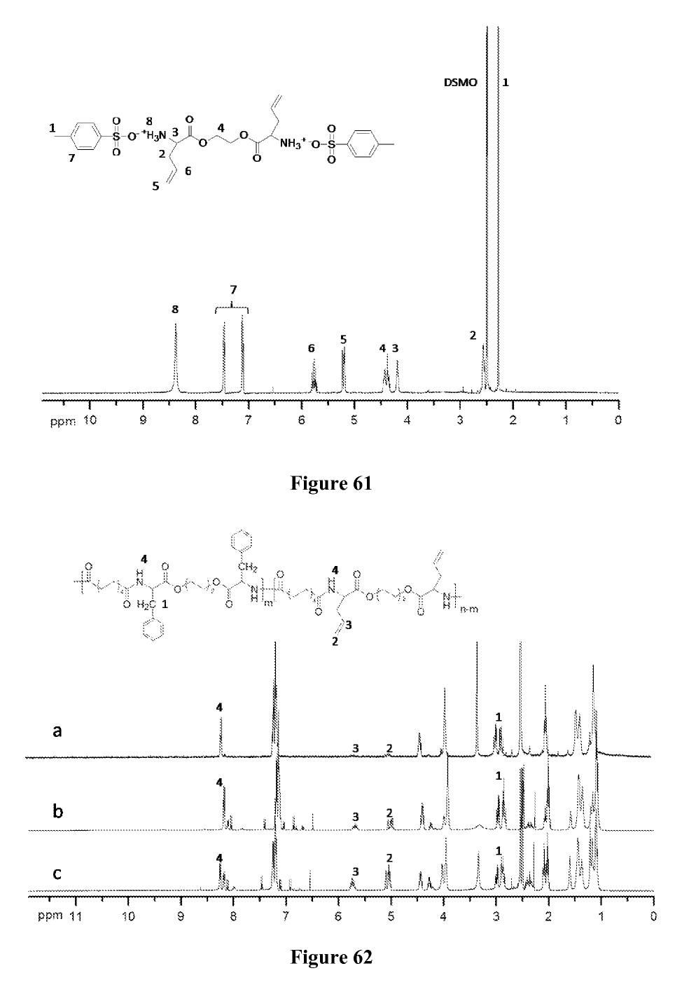

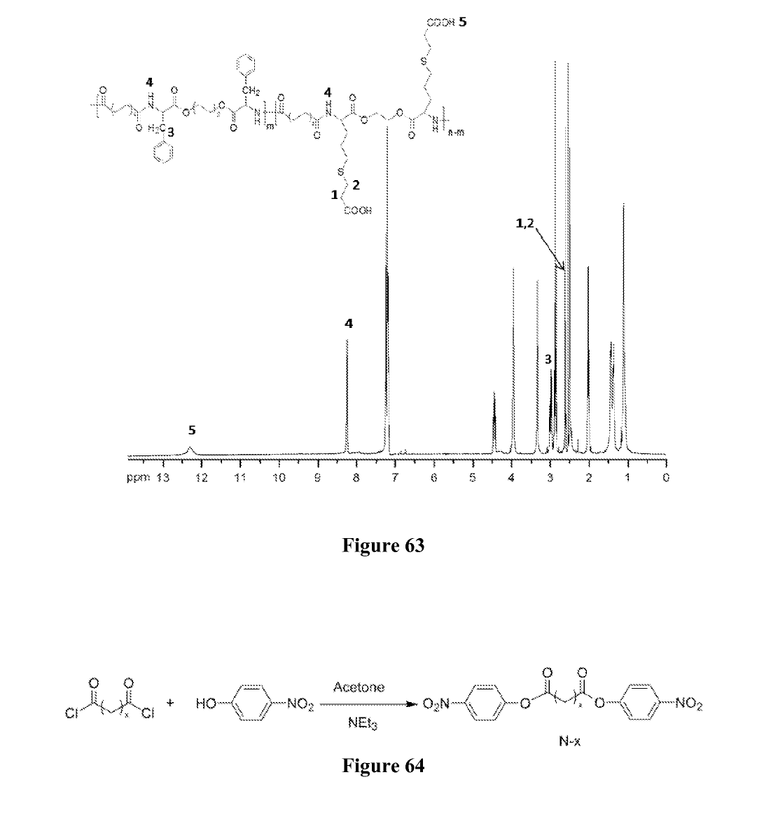

Due to the presence of a AG-PEA segment in functional PEA or PEEA copolymers families, these copolymers have at least one common structural characteristic: pendant carbon-to-carbon double bond that is reactive, for example, in photo-induced hydrogel formation (e.g., see FIGS. 9-12, 15-25, 36-37 and 44-51) or conversion into other reactive functional groups like amine, carboxylic and sulfonic acid (e.g., see FIGS. 53-60). In a x-AA-y-AG copolymer, there is only one pendant carbon-to-carbon double bond per AG-AA block, while a x-AA-y-AG-z copolymer has two pendant carbon-to-carbon double bonds per AG-PEA block (note, not AG-AA block).

Further, in the x-AA-y-AG family, AG is adjacent to another amino acid (e.g., FIG. 3) and these 2 amino acids form one of the two blocks of the copolymers. In the x-AA-y-AG-z family (e.g., FIG. 4), AG forms its own PEA block (not other amino acids join AG in the AG block) and the copolymers have 2 pendant carbon-to-carbon double bonds per AG-PEA block.

The conversion of the pendant and reactive carbon-to-carbon double bonds in the AG unit into other functional groups are exemplified in, for example, FIGS. 53-60.

Besides the linking of these allylglycine-base functional PEA/PEEA copolymers with other PEA/PEEA (without allylglycine unit(s)), additional applications could include the integration of these allylglycine-based functional PEA or PEEA copolymers (via their pendant double bonds in the AG unit) to other non-PEA/PEEA-based polmers like polysaccharides or aliphatic polyesters (e.g., polylactide, polyglycolide, and poly-ε-caprolactone) to form hybrid biomaterials. Such hybrid biomaterials should be very useful.

The following examples are presented to illustrate the present invention. They are not intended to limiting in any manner.

### Example 1

### Synthesis of Monomers and PEA Co-Polymers

Materials. DL-2-Allylglycine (AG), L-Phenylalanine (Phe), p-toluenesulfonic acid monohydrate (TosOH.H₂O), sebacoyl chloride, succinyl chloride, 1,2-ethylenediol, 1,4-butanediol, 1,6-hexanediol, 3-mercaptopropionic acid, 2-aminoethanethiol hydrochloride, sodium-3-mercapto-1-propanesulfonate (Alfa Aesar, Ward Hill, Mass.) and p-nitrophenol (J. T. Baker, Phillipsburg, N.J.) were used without further purification. Triethylamine from Fisher Scientific (Fairlawn, N.J.) was dried via refluxing with calciumhydride and then distilled. Other solvents, such as benzene, ethyl acetate, acetone, N,N-dimethylacetamide (DMA) and dimethyl sulfoxide (DMSO), were purchased from VWR Scientific (West Chester, Pa.) and were purified by standard methods before use.

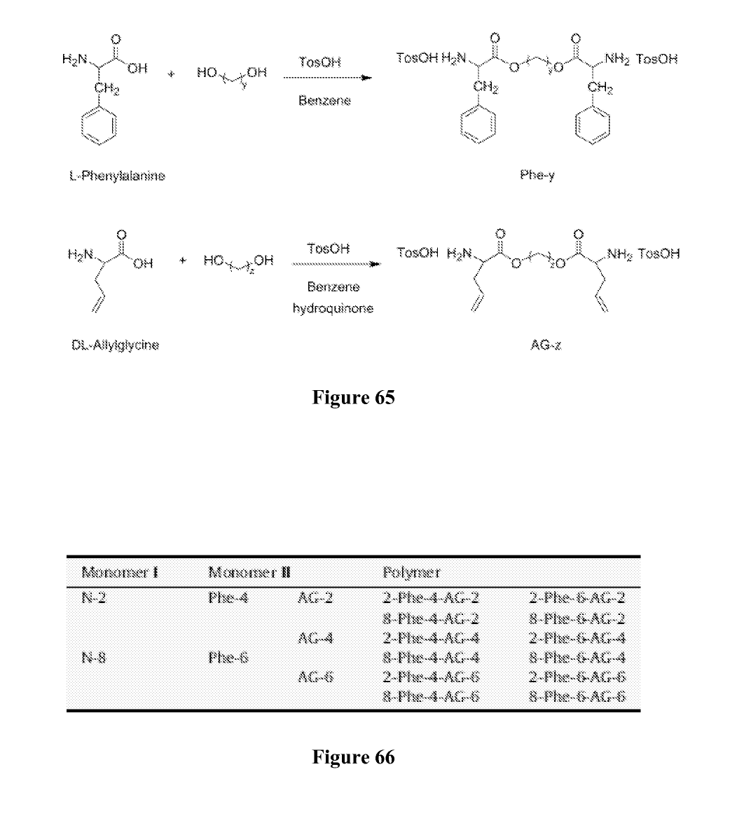

Synthesis of monomers. The monomers synthesized could be divided into two categories: di-p-nitrophenylester of dicarboxylic acids (see FIG. 64); di-p-toluenesulfonic acid salt of bis-Lphenylalanine and bis-DL-2-allylglycine esters (e.g., Structure XI) (see FIG. 65). The synthesis of di-p-nitrophenyl ester of dicarboxylic acid monomer (I) was based on a reported method of reacting dicarboxylic acyl chlorides with p-nitrophenol (FIG. 64). The synthetic procedure of monomer (II) were described as below: di-p-toluenesulfonic acid salts of bis-L-phenylalanine esters were prepared as previously published procedures. The synthetic pathway of di-p-toluenesulfonic acid salts of bis-DL-2-allylglycine esters (AG-z, z indicated the number of methylene group in diol part of AG toluenesulfonic acid salt) is shown in FIG. 65. DL-2-allylglycine (0.044 mol), p-toluenesulfonic acid monohydrate (0.05 mol) and diol (e.g., 1,2-ethylenediol, 1,4-butanediol or 1,6-hexanediol, at 0.022 mol) in 100 mL of benzene were placed in a flask equipped with a Dean-Stark apparatus, CaCl₂ drying tube, and a magnetic stirrer. Hydroquinone was added as an inhibitor. The solid-liquid reaction mixture was heated and reflux for 4 hours until 2.0 mL of H₂O evolved. The reaction mixture was then cooled to room temperature, filtered and dried in vacuo at room temperature. The products, AG-z were purified by dissolving in DMSO and then recrystallization in ethyl acetate three times. The final products were white powder.

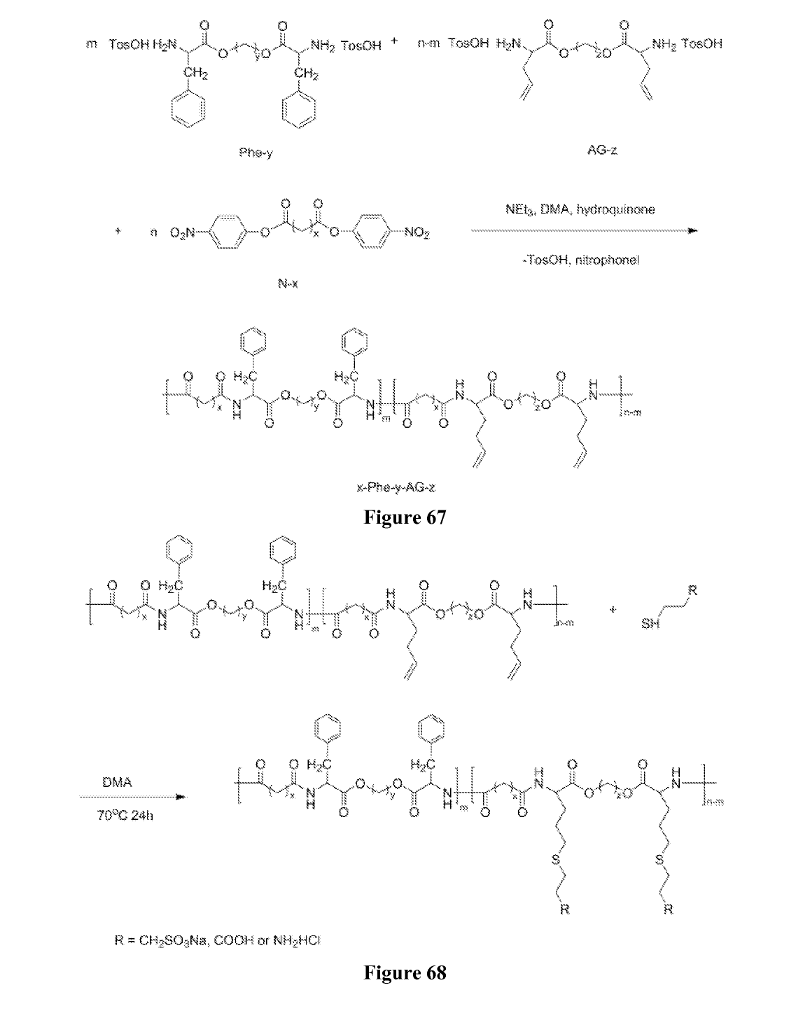

Synthesis of functional PEA-AG co-polymers having pendant double bonds. The functional PEA-AGs having pendant double bonds were synthesized through the solution polycondensation of di-p-nitrophenyl ester with a mixture of di-p-toluenesulfonic acid salts of bis-L-phenylalanine (Phe-y) and bis-DL-2-allylglycine esters (AG-z) in a predetermined feed ratio. The combinations used in this work included x=2 and 8, y=4 and 6, and z=2, 4 and 6, and were listed in FIG. 66 and illustrated in FIG. 67. The functional PEA-AG copolymers were labeled as x-Phe-y-AG-z, where x was the number of methylene group in the diacid unit, y and z were the numbers of methylene group in the diol unit for the corresponding Phe and AG monomers, respectively.

A detailed synthetic pathway of PEA-AG 8-Phe-4-AG-4 was given as an example to illustrate the procedures: a mixture of three monomers (Phe-4, AG-4 and N-8) at a predetermined feed ratio in a suitable organic solvent like DMSO or DMA was placed to a glass reaction vessel equipped with a magnetic stirring bar. The reaction vessel was then heated in an oil bath to 70° C. Trace amounts of triethylamine was added dropwise to the mixture with stirring until the complete dissolution of the three monomers. The reaction vessel was then kept at 70° C. for 48 hours. The resulting functional PEA-AG copolymers were precipitated from the reaction solution by adding cold ethyl acetate, followed by filtration, and extraction by ethyl acetate in a Soxhlet apparatus for 48 hours, and finally dried in vacuo at room temperature.

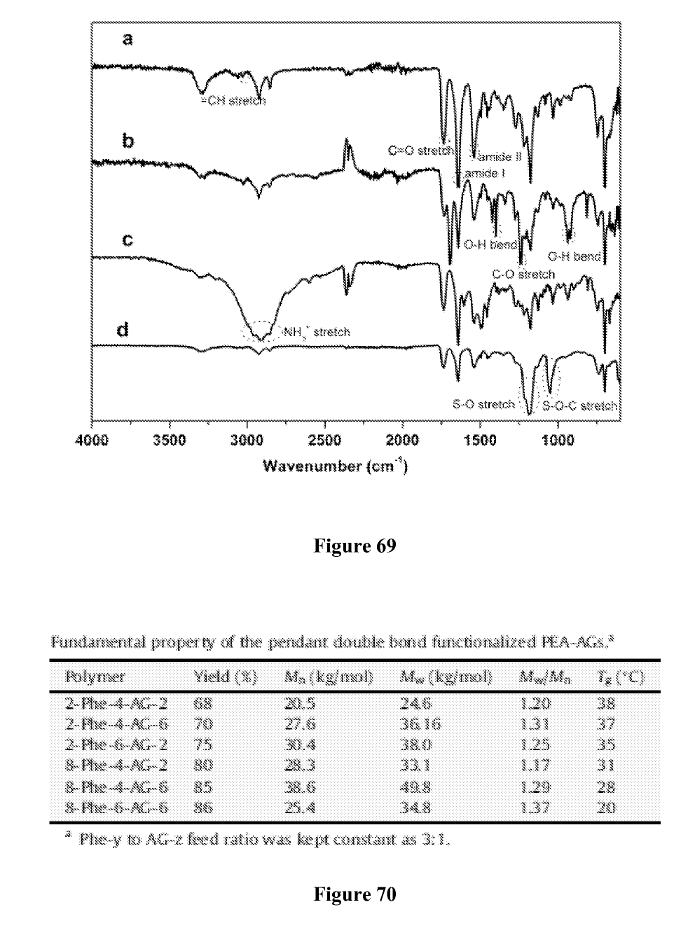

In order to demonstrate the reactivity and utility of the pendant double bonds in the AG segment of the functionalized PEA-AG copolymers, a modified free-radical addition method was used to convert the pendant double bonds into a variety of other functional groups. Three functional thiols (3-mercaptopropionic acid, 2-aminoethanethiol hydrochloride and sodium-3-mercapto-1-propanesulfonate) were used to convert the functional double bonds in PEA-AG into carboxylic acid, amine, and sulfonate functionality, respectively, as shown in FIG. 68. An example of the synthesis for the functionalized PEA-AGs having pendant free carboxylic acid was given below by using 8-Phe-4-AG-2-25 and 3-mercaptopropionic acid. 8-Phe-4-AG-2-25 and 3-mercaptopropionic acid of predetermined concentrations in DMA solvent were added to a glass reaction vessel equipped with a magnetic stirring bar. The reaction vessel was placed in an oil bath of 70° C. overnight. The resulting product (8-Phe-4-AG-2-COOH) in the solution was precipitated out by adding cold ethyl acetate, filtered, extracted by ethyl acetate and finally dried in vacuo at room temperature (FIG. 69).

Chemical structure identification. The chemical structures of polymers were characterized by standard chemical methods. Diffuse Reflectance Infrared Fourier Transform Spectroscopy (DRIFTS) technique was used to collect IR spectra of the copolymers, as DRIFTS provides a faster and simpler sample preparation than traditional FTIR. Samples were ground into powder and filled into the micro-cup of the diffuse reflectance accessory on a Perkin-Elmer Nicolet Magana 560 FTIR spectrometer (Madison, Wis.), and IR information of samples was collected and processed with Omnic software. NMR spectra were recorded by a Varian Unity INOVA-400 400 MHz spectrometer (Palo Alto, Calif.) operating at 400 MHz and 100 MHz for ¹H and ¹³C NMR, respectively. Chemical shifts were given in parts per million from tetramethylsilane standard. Deuterated DMSO-d6 (Cambridge Isotope laboratories) was used as the solvents. The number and weight average molecular weights (Mn and Mw) and MWD of the polymers were determined by gel permeation chromatography (Model 510, Waters Associates Inc. Milford, USA) equipped with a high-pressure liquid chromatographic pump, a Waters 486 UV detector, and a Waters 2410 different refractive index detector. THF was used as the eluent (1.0 mL/min). The columns were calibrated with polystyrene standards having a narrow MWD.

¹H and ¹³C NMR spectra of allylglycine-based monomers (AG-z). AG-2. Yield: 85%. Tm: 162° C. ¹H NMR (400M, DMSO-d6, ppm, δ): 2.29 (6H, H3C-Ph-SO3-), 2.57 (4H, CH2=CHCH2-), 4.19 [2H, +H3NCH(CH2CH═CH2)C(O)O—], 4.33-4.43 [4H, —(O)COCH2-], 5.22 (4H, CH2=CHCH2-), 5.77 (2H, CH2=CHCH2-), 7.12 (4H, ArH), 7.48 (4H, ArH), 8.38 [6H, +H3NCH(CH2CH═CH2)C(O)O—]. ¹³C NMR (100M, DMSO-d6, ppm, δ): 21.20 (H3C-Ph-SO3-), 34.67 (CH2=CHCH2-), 52.34 [2H, +H3N—CH(CH2CH═CH2)-C(O)—O—], 65.21 [—(O)COCH2-], 121.01 (CH2=CHCH2-), 125.90, 128.52, 131.42 (ArC), 138.44 (CH2=CHCH2-), 145.34 (ArC), 169.25 (—C(O)—O—).

AG-4. Yield: 87%. Tm: 150° C. ¹H NMR (400M, DMSO-d6, ppm, δ): 1.68 [4H, —(O)COCH2CH2-], 2.29 (6H, H3C-Ph-SO3-), 2.55 (4H, CH2=CHCH2-), 4.07 [2H, +H3NCH(CH2CH═CH2)C(O)O—], 4.18 [4H, —(O)COCH2CH2-], 5.22 (4H, CH2=CHCH2-), 5.75 (2H, CH2=CHCH2-), 7.06 (4H, ArH), 7.42 (4H, ArH), 8.17-8.28 [6H, +H3NCH(CH2CH═CH2)C(O)O—]. ¹³C NMR (100M, DMSO-d6, ppm, δ): 21.12 (H3C-Ph-SO3-), 25.64 [—(O)COCH2CH2-], 36.88 (CH2=CHCH2-), 52.80 [2H, +H3N—CH(CH2CH═CH2)-C(O)—O—], 65.73 [—(O)COCH2CH2-], 121.45 (CH2=CHCH2-), 125.93, 128.62, 131.55 (ArC), 138.65 (CH2=CHCH2-), 145.22 (ArC), 169.32 (—C(O)—O—).

AG-6. Yield: 86%. Tm: 137° C. ¹H NMR (400M, DMSO-d6, ppm, δ): 1.33 [4H, —(O)CO(CH2)2CH2-], 1.57 [4H, —(O)COCH2CH2-], 2.29 (6H, H3C-Ph-SO3-), 2.57 (4H, CH2=CHCH2-), 4.04 [2H, +H3N—CH(CH2CH═CH2)-C(O)—O—], 4.17 [4H, —(O)COCH2CH2-], 5.16 (4H, CH2=CHCH2-), 5.75 (2H, CH2=CHCH2-), 7.05 (4H, ArH), 7.42 (4H, ArH), 8.17-8.29 [6H, +H3N—CH(CH2CH═CH2)-C(O)—O—]. ¹³C NMR (100M, DMSO-d6, ppm, δ): 21.20 (H3C-Ph-SO3-), 25.10 [—(O)CO(CH2)2CH2-], 28.21 [—(O)COCH2CH2-], 34.75 (CH2=CHCH2-), 52.11 [2H, +H3N—CH(CH2CH═CH2)-C(O)—O—], 65.90 [—(O)COCH2CH2-], 120.35 (CH2=CHCH2-), 125.90, 128.64, 131.54 (ArC), 138.70 (CH2=CHCH2-), 145.19 (ArC), 169.28 (—C(O)—O—).

¹H and ¹³C NMR spectra of PEAs x-Phe-y-AG-z. 2-Phe-4-AG-2. Yield: 68%. ¹H NMR (400M, DMSO-d6, ppm, δ): 1.48 [—(CH2Ph)CH(O)COCH2CH2-], 2.20 [—NHC(O)CH2-], 2.44 (CH2=CHCH2-), 2.80, 2.83 (PhCH2-), 3.94 [—NHCH(CH2Ph)C(O)—], 3.97 [—HNCH(CH2CH═CH2)C(O)O—], 4.10 [—(CH2CH═CH2)CH(O)COCH2-], 4.48 [—(CH2Ph)CH(O)COCH2CH2-], 4.99 (CH2=CHCH2-), 5.66 (CH2=CHCH2-), 7.17-7.27 (ArH), 8.25 [—HNCH(CH2CH═CH2)C(O)O—, —HNCH(CH2Ph)C(O)O—]. ¹³C NMR (100M, DMSO-d6, ppm, δ): 24.81 [—(CH2Ph)CH(O)COCH2CH2-], 29.03 [—NHC(O)CH2-], 35.30 (CH2=CHCH2-), 37.12 (PhCH2-), 52.11 [—NHCH(CH2Ph)C(O)—], 53.90 [—HNCH(CH2CH═CH2)C(O)O—], 64.47 [—(CH2Ph)CH(O)COCH2-], 64.79 [—(CH2CH═CH2)CH(O)COCH2-], 118.10 (CH2=CHCH2-), 126.59, 128.54, 129.41, 137.69 (ArC), 134.17 (CH2=CHCH2-), 172.06 [—(CH2CH═CH2)CH(O)CO—], 172.20 [—(CH2Ph)CH(O)CO—], 172.65 [—NHC(O)CH2-].

2-Phe-4-AG-4. Yield: 65%. ¹H NMR (400M, DMSO-d6, ppm, δ): 1.40 [—(CH2Ph)CH(O)COCH2CH2-], 1.58 [—(CH2CH═CH2)CH(O)COCH2CH2-], 2.24 [—NHC(O)CH2-], 2.50 (CH2=CHCH2-), 2.76, 2.87 (PhCH2-), 3.88 [—NHCH(CH2Ph)C(O)—], 3.99 [—HNCH(CH2CH═CH2)C(O)O—], 4.26 [—(CH2CH═CH2)CH(O)COCH2-], 4.40 [—(CH2Ph)CH(O)COCH2CH2-], 5.00 (CH2=CHCH2-), 5.66 (CH2=CHCH2-), 7.17-7.27 (ArH), 8.20 [—HNCH(CH2CH═CH2)C(O)O—, —HNCH(CH2Ph)C(O)O—]. ¹³C NMR (100M, DMSO-d6, ppm, δ): 24.80 [—(CH2Ph)CH(O)COCH2CH2-], 25.79 [—(CH2CH═CH2)CH(O)COCH2CH2-], 29.01 [—NHC(O)CH2-], 35.28 (CH2=CHCH2-), 37.10 (PhCH2-), 52.13 [—NHCH(CH2Ph)C(O)—], 53.87 [—HNCH(CH2CH═CH2)C(O)O—], 64.40 [—(CH2Ph)CH(O)COCH2-], 65.22 [—(CH2CH═CH2)CH(O)COCH2-], 118.13 (CH2=CHCH2-), 126.50, 128.52, 129.41, 137.71 (ArC), 134.19 (CH2=CHCH2-), 172.08 [—(CH2CH═CH2)CH(O)CO—], 172.22 [—(CH2Ph)CH(O)CO—], 172.66 [—NHC(O)CH2-].

2-Phe-4-AG-6. Yield: 70%. ¹H NMR (400M, DMSO-d6, ppm, δ): 1.27 [—(CH2CH═CH2)CH(O)CO(CH2)2CH2-], 1.39 [—(CH2Ph)CH(O)COCH2CH2-], 1.50 [—(CH2CH═CH2)CH(O)COCH2CH2-], 2.21 [—NHC(O)CH2-], 2.49 (CH2=CHCH2-), 2.89, 2.94 (PhCH2-), 3.94 [—NHCH(CH2Ph)C(O)—], 4.01 [—HNCH(CH2CH═CH2)C(O)O—], 4.27 [—(CH2CH═CH2)CH(O)COCH2-], 4.41 [—(CH2Ph)CH(O)COCH2CH2-], 5.05 (CH2=CHCH2-), 5.67 (CH2=CHCH2-), 6.97-7.06 (ArH), 8.09 [—HNCH(CH2CH═CH2)C(O)O—, —HNCH(CH2Ph)C(O)O—]. ¹³C NMR (100M, DMSO-d6, ppm, δ): 24.83 [—(CH2Ph)CH(O)COCH2CH2-], 25.57 [—(CH2CH═CH2)CH(O)CO(CH2)2CH2-], 28.77 [—(CH2CH═CH2)CH(O)COCH2CH2-], 29.10 [—NHC(O)CH2-], 35.23 (CH2=CHCH2-), 37.11 (PhCH2-), 52.18 [—NHCH(CH2Ph)C(O)—], 53.80 [—HNCH(CH2CH═CH2)C(O)O—], 64.45 [—(CH2Ph)CH(O)COCH2-], 64.66 [—(CH2CH═CH2)CH(O)COCH2-], 118.14 (CH2=CHCH2-), 126.57, 128.54, 129.43, 137.65 (ArC), 134.21 (CH2=CHCH2-), 172.11 [—(CH2CH═CH2)CH(O)CO—], 172.28 [—(CH2Ph)CH(O)CO—], 172.70 [—NHC(O)CH2-].

2-Phe-6-AG-2. Yield: 75%. ¹H NMR (400M, DMSO-d6, ppm, δ): 1.11 [—(CH2Ph)CH(O)CO(CH2)2CH2-], 1.39 [—(CH2Ph)CH(O)COCH2CH2-], 2.28 [—NHC(O)CH2-], 2.50 (CH2=CHCH2-), 2.79, 2.87 (PhCH2-), 3.92 [—NHCH(CH2Ph)C(O)—], 4.01 [—HNCH(CH2CH═CH2)C(O)O—], 4.17 [—(CH2CH═CH2)CH(O)COCH2-], 4.38 [—(CH2Ph)CH(O)COCH2CH2-], 5.00 (CH2=CHCH2-), 5.67 (CH2=CHCH2-), 7.17-7.27 (ArH), 8.19 [—HNCH(CH2CH═CH2)C(O)O—, —HNCH(CH2Ph)C(O)O—]. ¹³C NMR (100M, DMSO-d6, ppm, δ): 25.21 [—(CH2Ph)CH(O)CO(CH2)2CH2-], 28.23 [—(CH2Ph)CH(O)COCH2CH2-], 29.10 [—NHC(O)CH2-], 35.27 (CH2=CHCH2-), 37.16 (PhCH2-), 52.01 [—NHCH(CH2Ph)C(O)—], 53.95 [—HNCH(CH2CH═CH2)C(O)O—], 64.61 [—(CH2Ph)CH(O)COCH2-], 64.74 [—(CH2CH═CH2)CH(O)COCH2-], 118.11 (CH2=CHCH2-), 126.61, 128.55, 129.42, 137.67 (ArC), 134.14 (CH2=CHCH2-), 172.11 [—(CH2CH═CH2)CH(O)CO—], 172.25 [—(CH2Ph)CH(O)CO—], 172.69 [—NHC(O)CH2-].

2-Phe-6-AG-4. Yield: 73%. ¹H NMR (400M, DMSO-d6, ppm, δ): 1.09 [—(CH2Ph)CH(O)CO(CH2)2CH2-], 1.37 [—(CH2Ph)CH(O)COCH2CH2-], 1.56 [—(CH2CH═CH2)CH(O)COCH2CH2-], 2.26 [—NHC(O)CH2-], 2.46 (CH2=CHCH2-), 2.75, 2.87 (PhCH2-), 3.90 [—NHCH(CH2Ph)C(O)—], 3.98 [—HNCH(CH2CH═CH2)C(O)O—], 4.21 [—(CH2CH═CH2)CH(O)COCH2-], 4.37 [—(CH2Ph)CH(O)COCH2CH2-], 5.04 (CH2=CHCH2-), 5.67 (CH2=CHCH2-), 7.17-7.27 (ArH), 8.25 [—HNCH(CH2CH═CH2)C(O)O—, —HNCH(CH2Ph)C(O)O—]. ¹³C NMR (100M, DMSO-d6, ppm, δ): 25.20 [—(CH2Ph)CH(O)CO(CH2)2CH2-], 25.60 [—(CH2CH═CH2)CH(O)COCH2CH2-], 28.26 [—(CH2Ph)CH(O)COCH2CH2-], 29.07 [—NHC(O)CH2-], 35.17 (CH2=CHCH2-), 37.12 (PhCH2-), 52.13 [—NHCH(CH2Ph)C(O)—], 53.85 [—HNCH(CH2CH═CH2)C(O)O—], 64.69 [—(CH2Ph)CH(O)COCH2-], 65.20 [—(CH2CH═CH2)CH(O)COCH2-], 118.09 (CH2=CHCH2-), 126.59, 128.53, 129.41, 137.71 (ArC), 134.13 (CH2=CHCH2-), 172.08 [—(CH2CH═CH2)CH(O)CO—], 172.28 [—(CH2Ph)CH(O)CO—], 172.66 [—NHC(O)CH2-].

2-Phe-6-AG-6. Yield: 75%. ¹H NMR (400M, DMSO-d6, ppm, δ): 1.13 [—(CH2Ph)CH(O)CO(CH2)2CH2-], 1.25 [—(CH2CH═CH2)CH(O)CO(CH2)2CH2-], 1.37 [—(CH2Ph)CH(O)COCH2CH2-], 1.49 [—(CH2CH═CH2)CH(O)COCH2CH2-], 2.26 [—NHC(O)CH2-], 2.47 (CH2=CHCH2-), 3.02, 3.08 (PhCH2-), 3.90 [—NHCH(CH2Ph)C(O)—], 3.99 [—HNCH(CH2CH═CH2)C(O)O—], 4.23 [—(CH2CH═CH2)CH(O)COCH2-], 4.38 [—(CH2Ph)CH(O)COCH2CH2-], 5.01 (CH2=CHCH2-), 5.69 (CH2=CHCH2-), 6.97-7.06 (ArH), 8.14 [—HNCH(CH2CH═CH2)C(O)O—, —HNCH(CH2Ph)C(O)O—]. ¹³C NMR (100M, DMSO-d6, ppm, δ): 25.24 [—(CH2Ph)CH(O)CO(CH2)2CH2-], 25.55 [—(CH2CH═CH2)CH(O)CO(CH2)2CH2-], 28.29 [—(CH2Ph)CH(O)COCH2CH2-], 28.77 [—(CH2CH═CH2)CH(O)COCH2CH2-], 29.10 [—NHC(O)CH2-], 35.27 (CH2=CHCH2-), 37.14 (PhCH2-), 52.08 [—NHCH(CH2Ph)C(O)—], 53.87 [—HNCH(CH2CH═CH2)C(O)O—], 64.55 [—(CH2CH═CH2)CH(O)COCH2-], 64.64 [—(CH2Ph)CH(O)COCH2-], 118.08 (CH2=CHCH2-), 126.60, 128.57, 129.41, 137.72 (ArC), 134.21 (CH2=CHCH2-), 172.05 [—(CH2CH═CH2)CH(O)CO—], 172.18 [—(CH2Ph)CH(O)CO—], 172.64 [—NHC(O)CH2-].

8-Phe-4-AG-2. Yield: 80%. ¹H NMR (400M, DMSO-d6, ppm, δ): 1.14 [—NHC(O)(CH2)2(CH2)4(CH2)2C(O)NH—], 1.39 [—NHC(O)CH2CH2-], 1.44 [—(CH2Ph)CH(O)COCH2CH2-], 2.03 [—NHC(O)CH2CH2-], 2.54 (CH2=CHCH2-), 2.88, 2.99 (PhCH2-), 3.96 [—NHCH(CH2Ph)C(O)—], 4.19 [—HNCH(CH2CH═CH2)C(O)O—], 4.22-4.39 [—(CH2CH═CH2)CH(O)COCH2-], 4.45 [—(CH2Ph)CH(O)COCH2CH2-], 5.11 (CH2=CHCH2-), 5.74 (CH2=CHCH2-), 7.13-7.22 (ArH), 8.24 [—HNCH(CH2CH═CH2)C(O)O—, —HNCH(CH2Ph)C(O)O—]. ¹³C NMR (100M, DMSO-d6, ppm, δ): 24.77 [—(CH2Ph)CH(O)COCH2CH2-], 25.62 [—NHC(O)CH2CH2-], 28.94 [—NHC(O)(CH2)2CH2-], 29.10 [—NHC(O)(CH2)3CH2-], 35.34 (CH2=CHCH2-), 35.72 [—NHC(O)CH2CH2-], 37.11 (PhCH2-), 52.08 [—NHCH(CH2Ph)C(O)—], 53.88 [—HNCH(CH2CH═CH2)C(O)O—], 64.42 [—(CH2Ph)CH(O)COCH2-], 64.74 [—(CH2CH═CH2)CH(O)COCH2-], 118.05 (CH2=CHCH2-), 126.59, 128.55, 129.44, 137.69 (ArC), 134.13 (CH2=CHCH2-), 172.11 [—(CH2CH═CH2)CH(O)CO—], 172.22 [—(CH2Ph)CH(O)CO—], 172.62 [—NHC(O)CH2-].

8-Phe-4-AG-4. Yield: 82%. ¹H NMR (400M, DMSO-d6, ppm, δ): 1.10 [—NHC(O)(CH2)2(CH2)4(CH2)2C(O)NH—], 1.39 [—NHC(O)CH2CH2-], 1.44 [—(CH2Ph)CH(O)COCH2CH2-], 1.60 [—(CH2CH═CH2)CH(O)COCH2CH2-], 2.06 [—NHC(O)CH2CH2-], 2.54 (CH2=CHCH2-), 2.88, 2.99 (PhCH2-), 4.02 [—NHCH(CH2Ph)C(O)—], 4.18 [—HNCH(CH2CH═CH2)C(O)O—], 4.27 [—(CH2CH═CH2)CH(O)COCH2-], 4.44 [—(CH2Ph)CH(O)COCH2CH2-], 5.11 (CH2=CHCH2-), 5.73 (CH2=CHCH2-), 7.13-7.22 (ArH), 8.26 [—HNCH(CH2CH═CH2)C(O)O—, —HNCH(CH2Ph)C(O)O—]. ¹³C NMR (100M, DMSO-d6, ppm, δ): 24.76 [—(CH2Ph)CH(O)COCH2CH2-], 25.68 [—NHC(O)CH2CH2-], 25.77 [—(CH2CH═CH2)CH(O)COCH2CH2-], 28.90 [—NHC(O)(CH2)2CH2-], 29.18 [—NHC(O)(CH2)3CH2-], 35.32 (CH2=CHCH2-), 35.70 [—NHC(O)CH2CH2-], 37.14 (PhCH2-), 52.12 [—NHCH(CH2Ph)C(O)—], 53.83 [—HNCH(CH2CH═CH2)C(O)O—], 64.45 [—(CH2Ph)CH(O)COCH2-], 65.58 [—(CH2CH═CH2)CH(O)COCH2-], 118.06 (CH2=CHCH2-), 126.63, 128.55, 129.43, 137.71 (ArC), 134.16 (CH2=CHCH2-), 172.16 [—(CH2CH═CH2)CH(O)CO—], 172.24 [—(CH2Ph)CH(O)CO—], 172.64 [—NHC(O)CH2-].

8-Phe-4-AG-6. Yield: 85%. ¹H NMR (400M, DMSO-d6, ppm, δ): 1.19 [—NHC(O)(CH2)2(CH2)4(CH2)2C(O)NH—], 1.29 [—(CH2CH═CH2)CH(O)CO(CH2)2CH2-], 1.38 [—NHC(O)CH2CH2-], 1.44 [—(CH2Ph)CH(O)COCH2CH2-], 1.53 [—(CH2CH═CH2)CH(O)COCH2CH2-], 2.01 [—NHC(O)CH2CH2-], 2.54 (CH2=CHCH2-), 2.88, 3.00 (PhCH2-), 3.96 [—NHCH(CH2Ph)C(O)—], 4.07 [—HNCH(CH2CH═CH2)C(O)O—], 4.28 [—(CH2CH═CH2)CH(O)COCH2-], 4.46 [—(CH2Ph)CH(O)COCH2CH2-], 5.10 (CH2=CHCH2-), 5.74 (CH2=CHCH2-), 7.17-7.25 (ArH), 8.25 [—HNCH(CH2CH═CH2)C(O)O—, —HNCH(CH2Ph)C(O)O—]. ¹³C NMR (100M, DMSO-d6, ppm, δ): 24.70 [—(CH2Ph)CH(O)COCH2CH2-], 25.65 [—(CH2CH═CH2)CH(O)CO(CH2)2CH2-], 25.70 [—NHC(O)CH2CH2-], 28.79 [—(CH2CH═CH2)CH(O)COCH2CH2-], 28.91 [—NHC(O)(CH2)2CH2-], 29.14 [—NHC(O)(CH2)3CH2-], 35.35 (CH2=CHCH2-), 35.67 [—NHC(O)CH2CH2-], 37.10 (PhCH2-), 52.14 [—NHCH(CH2Ph)C(O)—], 53.89 [—HNCH(CH2CH═CH2)C(O)O—], 64.40 [—(CH2Ph)CH(O)COCH2-], 64.55 [—(CH2CH═CH2)CH(O)COCH2-], 118.00 (CH2=CHCH2-), 126.59, 128.49, 129.43, 137.69 (ArC), 134.08 (CH2=CHCH2-), 172.09 [—(CH2CH═CH2)CH(O)CO—], 172.20 [—(CH2Ph)CH(O)CO—], 172.69 [—NHC(O)CH2-].

8-Phe-6-AG-2. Yield: 82%. ¹H NMR (400M, DMSO-d6, ppm, δ): 1.15 [—NHC(O)(CH2)2(CH2)4(CH2)2C(O)NH—], 1.14 [—(CH2Ph)CH(O)CO(CH2)2CH2-], 1.37 [—NHC(O)CH2CH2-], 1.39 [—(CH2Ph)CH(O)COCH2CH2-], 2.00 [—NHC(O)CH2CH2-], 2.50 (CH2=CHCH2-), 2.89, 3.01 (PhCH2-), 3.97 [—NHCH(CH2Ph)C(O)—], 4.06 [—HNCH(CH2CH═CH2)C(O)O—], 4.31 [—(CH2CH═CH2)CH(O)COCH2-], 4.40 [—(CH2Ph)CH(O)COCH2CH2-], 5.12 (CH2=CHCH2-), 5.72 (CH2=CHCH2-), 7.17-7.27 (ArH), 8.20 [—HNCH(CH2CH═CH2)C(O)O—, —HNCH(CH2Ph)C(O)O—]. ¹³C NMR (100M, DMSO-d6, ppm, δ): 25.20 [—(CH2Ph)CH(O)CO(CH2)2CH2-], 28.57 [—(CH2Ph)CH(O)COCH2CH2-], 25.60 [—NHC(O)CH2CH2-], 28.99 [—NHC(O)(CH2)2CH2-], 29.16 [—NHC(O)(CH2)3CH2-], 35.39 (CH2=CHCH2-), 35.77 [—NHC(O)CH2CH2-], 37.09 (PhCH2-), 52.11 [—NHCH(CH2Ph)C(O)—], 53.85 [—HNCH(CH2CH═CH2)C(O)O—], 64.64 [—(CH2Ph)CH(O)COCH2-], 64.70 [—(CH2CH═CH2)CH(O)COCH2-], 118.11 (CH2=CHCH2-), 126.65, 128.57, 129.43, 137.69 (ArC), 134.10 (CH2=CHCH2-), 172.09 [—(CH2CH═CH2)CH(O)CO—], 172.20 [—(CH2Ph)CH(O)CO—], 172.61 [—NHC(O)CH2-].

8-Phe-6-AG-4. Yield: 87%. ¹H NMR (400M, DMSO-d6, ppm, δ): 1.11 [—NHC(O)(CH2)2(CH2)4(CH2)2C(O)NH—], 1.17 [—(CH2Ph)CH(O)CO(CH2)2CH2-], 1.34 [—NHC(O)CH2CH2-], 1.47 [—(CH2Ph)CH(O)COCH2CH2-], 1.59 [—(CH2CH═CH2)CH(O)COCH2CH2-], 2.01 [—NHC(O)CH2CH2-], 2.50 (CH2=CHCH2-), 2.84, 2.98 (PhCH2-), 3.90 [—NHCH(CH2Ph)C(O)—], 4.01 [—HNCH(CH2CH═CH2)C(O)O—], 4.22 [—(CH2CH═CH2)CH(O)COCH2-], 4.40 [—(CH2Ph)CH(O)COCH2CH2-], 5.07 (CH2=CHCH2-), 5.68 (CH2=CHCH2-), 7.09-7.20 (ArH), 8.19 [—HNCH(CH2CH═CH2)C(O)O—, —HNCH(CH2Ph)C(O)O—]. ¹³C NMR (100M, DMSO-d6, ppm, δ): 25.21 [—(CH2Ph)CH(O)CO(CH2)2CH2-], 25.63 [—NHC(O)CH2CH2-], 28.25 [—(CH2Ph)CH(O)COCH2CH2-], 28.88 [—(CH2CH═CH2)CH(O)COCH2CH2-], 28.95 [—NHC(O)(CH2)2CH2-], 29.15 [—NHC(O)(CH2)3CH2-], 35.33 (CH2=CHCH2-), 35.75 [—NHC(O)CH2CH2-], 37.17 (PhCH2-), 52.16 [—NHCH(CH2Ph)C(O)—], 53.96 [—HNCH(CH2CH═CH2)C(O)O—], 64.69 [—(CH2Ph)CH(O)COCH2-], 65.22 [—(CH2CH═CH2)CH(O)COCH2-], 118.07 (CH2=CHCH2-), 126.60, 128.52, 129.40, 137.69 (ArC), 134.15 (CH2=CHCH2-), 172.01 [—(CH2CH═CH2)CH(O)CO—], 172.24 [—(CH2Ph)CH(O)CO—], 172.87 [—NHC(O)CH2-].

8-Phe-6-AG-6. Yield: 86%. ¹H NMR (400M, DMSO-d6, ppm, δ): 1.11 [—NHC(O)(CH2)2(CH2)4(CH2)2C(O)NH—], 1.18 [—(CH2Ph)CH(O)CO(CH2)2CH2-], 1.29 [—(CH2CH═CH2)CH(O)CO(CH2)2CH2-], 1.38 [—NHC(O)CH2CH2-], 1.43 [—(CH2Ph)CH(O)COCH2CH2-], 1.54 [—(CH2CH═CH2)CH(O)COCH2CH2-], 2.03 [—NHC(O)CH2CH2-], 2.53 (CH2=CHCH2-), 2.88, 2.99 (PhCH2-), 3.95 [—NHCH(CH2Ph)C(O)—], 4.09 [—HNCH(CH2CH═CH2)C(O)O—], 4.24 [—(CH2CH═CH2)CH(O)COCH2-], 4.44 [—(CH2Ph)CH(O)COCH2CH2-], 5.11 (CH2=CHCH2-), 5.73 (CH2=CHCH2-), 7.17-7.22 (ArH), 8.24 [—HNCH(CH2CH═CH2)C(O)O—, —HNCH(CH2Ph)C(O)O—]. ¹³C NMR (100M, DMSO-d6, ppm, δ): 25.27 [—(CH2Ph)CH(O)CO(CH2)2CH2-], 25.59 [—(CH2CH═CH2)CH(O)CO(CH2)2CH2-], 25.66 [—NHC(O)CH2CH2-], 28.31 [—(CH2Ph)CH(O)COCH2CH2-], 28.82 [—(CH2CH═CH2)CH(O)COCH2CH2-], 28.99 [—NHC(O)(CH2)2CH2-], 29.13 [—NHC(O)(CH2)3CH2-], 35.38 (CH2=CHCH2-), 35.70 [—NHC(O)CH2CH2-], 37.18 (PhCH2-), 52.13 [—NHCH(CH2Ph)C(O)—], 53.92 [—HNCH(CH2CH═CH2)C(O)O—], 64.61 [—(CH2CH═CH2)CH(O)COCH2-], 64.67 [—(CH2Ph)CH(O)COCH2-], 118.12 (CH2=CHCH2-), 126.61, 128.54, 129.43, 137.72 (ArC), 134.19 (CH2=CHCH2-), 172.04 [—(CH2CH═CH2)CH(O)CO—], 172.21 [—(CH2Ph)CH(O)CO—], 172.67 [—NHC(O)CH2-].

¹H and ¹³C NMR spectra of functionalized PEA-AGs. 8-Phe-4-AG-2-COOH. Yield: 85%. ¹H NMR (400M, DMSO-d6, ppm, δ): 1.11 [—NHC(O)(CH2)2(CH2)4(CH2)2C(O)NH—], 1.19 [—SCH2CH2CH2-], 1.37 [—NHC(O)CH2CH2-], 1.43 [—(CH2Ph)CH(O)COCH2CH2-], 1.47 [—SCH2CH2CH2-], 2.03 [—NHC(O)CH2CH2-], 2.46 [—SCH2CH2CH2-], 2.61 [—SCH2CH2COOH], 2.63 [—SCH2CH2COOH], 2.88, 2.99 (PhCH2-), 3.96 [—NHCH(CH2Ph)C(O)—, —HNCH(CH2CH2CH2SCH2CH2COOH)C(O)O—], 4.45 [—(CH2CH2CH2SCH2CH2COOH)CH(O)COCH2-, —(CH2Ph)CH(O)COCH2CH2-], 7.18-7.22 (ArH), 8.24 [—HNCH(CH2CH2CH2SCH2CH2COOH)C(O)O—, —HNCH(CH2Ph)C(O)O—], 12.29 [—SCH2CH2COOH]. ¹³C NMR (100M, DMSO-d6, ppm, δ): 24.96 [—(CH2Ph)CH(O)COCH2CH2-], 25.60 [—NHC(O)CH2CH2-], 25.78 [—SCH2CH2CH2-], 28.90 [—NHC(O)(CH2)2CH2-], 29.13 [—NHC(O)(CH2)3CH2-], 33.40 [—SCH2CH2COOH], 33.98 [—SCH2CH2CH2-], 34.86 [—SCH2CH2CH2-], 35.40 [—NHC(O)CH2CH2-], 37.17 (PhCH2-), 40.80 [—SCH2CH2COOH], 53.92 [—NHCH(CH2Ph)C(O)—, —HNCH(CH2CH2CH2SCH2CH2COOH)C(O)O—], 64.29 [—(CH2Ph)CH(O)COCH2-, —(CH2CH2CH2SCH2CH2COOH)CH(O)COCH2-], 126.40, 128.58, 129.43, 137.70 (ArC), 172.21 [—(CH2CH2CH2SCH2CH2COOH)CH(O)CO—], 172.73 [—(CH2Ph)CH(O)CO—], 172.98 [—NHC(O)CH2-], 173.11 [—SCH2CH2COOH].

8-Phe-4-AG-2-NH2HCl. Yield: 83%. ¹H NMR (400M, DMSO-d6, ppm, δ): 1.10 [—NHC(O)(CH2)2(CH2)4(CH2)2C(O)NH—], 1.18 [—SCH2CH2CH2-], 1.37 [—NHC(O)CH2CH2-], 1.42 [—(CH2Ph)CH(O)COCH2CH2-], 1.47 [—SCH2CH2CH2-], 2.03 [—NHC(O)CH2CH2-], 2.53 [—SCH2CH2CH2-], 2.70 [—SCH2CH2NH2HCl], 2.88, 2.99 (PhCH2-), 3.10 [—SCH2CH2NH2HCl], 3.95 [—NHCH(CH2Ph)C(O)—, —HNCH(CH2CH2CH2SCH2CH2NH2HCl)C(O)O—], 4.45 [—(CH2CH2CH2SCH2CH2NH2HCl)CH(O)COCH2-, —(CH2Ph)CH(O)COCH2CH2-], 7.18-7.22 (ArH), 8.29 [—HNCH(CH2CH2CH2SCH2CH2NH2HCl)C(O)O—, —HNCH(CH2Ph)C(O)O—]. ¹³C NMR (100M, DMSO-d6, ppm, δ): 24.93 [—(CH2Ph)CH(O)COCH2CH2-], 25.60 [—NHC(O)CH2CH2-], 25.77 [—SCH2CH2CH2-], 28.94 [—NHC(O)(CH2)2CH2-], 29.11 [—NHC(O)(CH2)3CH2-], 34.22 [—SCH2CH2CH2-], 34.87 [—SCH2CH2CH2-], 35.37 [—NHC(O)CH2CH2-], 37.11 (PhCH2-), 38.21 [—SCH2CH2NH2HCl], 40.78 [—SCH2CH2NH2HCl], 53.96 [—NHCH(CH2Ph)C(O)—, —HNCH(CH2CH2CH2SCH2CH2NH2HCl)C(O)O—], 64.27 [—(CH2Ph)CH(O)COCH2-, —(CH2CH2CH2SCH2CH2NH2HCl)CH(O)COCH2-], 126.86, 128.56, 129.42, 137.71 (ArC), 172.18 [—(CH2CH2CH2SCH2CH2NH2HCl)CH(O)CO—], 172.23 [—(CH2Ph)CH(O)CO—], 172.78 [—NHC(O)CH2-].

8-Phe-4-AG-2-SO3Na. Yield: 86%. ¹H NMR (400M, DMSO-d6, ppm, δ): 1.08 [—NHC(O)(CH2)2(CH2)4(CH2)2C(O)NH—], 1.18 [—SCH2CH2CH2-], 1.37 [—NHC(O)CH2CH2-], 1.42 [—(CH2Ph)CH(O)COCH2CH2-], 1.47 [—SCH2CH2CH2-], 2.03 [—NHC(O)CH2CH2-], 2.25 [—SCH2CH2CH2SO3Na], 2.55 [—SCH2CH2CH2-, —SCH2CH2CH2SO3Na], 2.88, 2.99 (PhCH2-), 3.37 [—SCH2CH2CH2SO3Na], 3.95 [—HNCH(CH2CH2CH2SCH2CH2CH2SO3Na)C(O)O—, —NHCH(CH2Ph)C(O)—], 4.45 [—(CH2CH2CH2SCH2CH2CH2SO3Na)CH(O)COCH2-, —(CH2Ph)CH(O)COCH2CH2-], 7.18-7.22 (ArH), 8.25 [—HNCH(CH2CH2CH2SCH2CH2CH2SO3Na)C(O)O—, —HNCH(CH2Ph)C(O)O—]. ¹³C NMR (100M, DMSO-d6, ppm, δ): 23.64 [—SCH2CH2CH2SO3Na], 24.94 [—(CH2Ph)CH(O)COCH2CH2-], 25.29 [—SCH2CH2CH2-], 25.60 [—NHC(O)CH2CH2-], 28.88 [—NHC(O)(CH2)2CH2-], 29.12 [—NHC(O)(CH2)3CH2-], 30.11 [—SCH2CH2CH2-], 34.81 [—SCH2CH2CH2-], 35.39 [—NHC(O)CH2CH2-], 37.14 (PhCH2-), 37.32 [—SCH2CH2CH2SO3Na], 40.79 [—SCH2CH2CH2SO3Na], 50.10 [—SCH2CH2CH2SO3Na], 53.93 [—NHCH(CH2Ph)C(O)—, —HNCH(CH2CH2CH2SCH2CH2NH2HCl)C(O)O—], 64.29 [—(CH2Ph)CH(O)COCH2-, —(CH2CH2CH2SCH2CH2NH2HCl)CH(O)COCH2-], 126.87, 128.57, 129.43, 137.70 (ArC), 172.19 [—(CH2CH2CH2SCH2CH2CH2SO3Na)CH(O)CO—], 172.22 [—(CH2Ph)CH(O)CO—], 172.76 [—NHC(O)CH2-].

Thermal property. Thermal properties of the synthesized polymers were characterized by a DSC 2920 (TA Instruments, New Castle, Del.). The measurement was carried out from 0 to 300° C. at a scanning rate of 10° C./min under nitrogen gas at a flow rate of 25 mL/min. TA Universal Analysis software was used for thermal data analysis. The glass transition temperature (Tg) was taken at the inflection point.

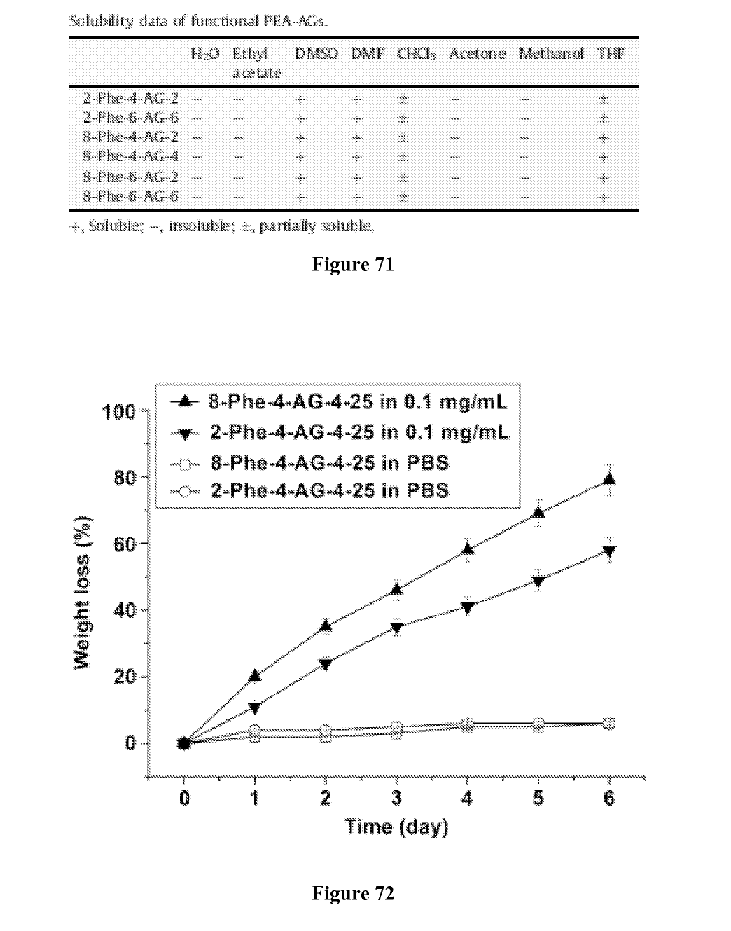

Solubility. The solubility of the PEA-AGs (50 mg) in H₂O and several common organic solvents (1.0 mL) at room temperature (25° C.) was evaluated (FIG. 71).

In vitro enzymatic biodegradation of functional PEA-AG co-polymers having pendant double bonds. The biodegradation of the PEA-AGs was carried out in a vial containing a small piece of dry PEA-AG film (ca. 50 mg) and 10 mL of a phosphate buffered saline solution (PBS, pH 7.4, 0.1 M) with or without a-chymotrypsin of different concentrations (0.1 and 0.2 mg/mL). The corresponding pure PBS buffer was used as the control medium. The vial was then incubated at 37° C. with a constant reciprocal shaking (100 rpm). The incubation media were refreshed daily to maintain the enzymatic activity. At predetermined immersion durations, PEA-AG film samples were removed from the incubation medium and washed gently with distilled water and then dried in vacuo at RT for 24 h. The degree of biodegradation was estimated from the weight loss of a PEA-AG film sample on the basis of the following equation:

W₁(%)=(Wₒ−Wₜ/Wₒ)×100,

where Wₒ was the original weight of the dry PEA-AG film sample before immersion and Wₜ was the dry PEA-AG film sample weight after incubation for t days (with or without the enzyme). The weight loss averaged for three specimens was recorded.

Interior morphology of PEA-AG film. SEM was employed to analyze the surface morphology of the PEA-AG during the biodegradation process. After being taken out of the incubation media, the PEA-AG film samples were dried, fixed on aluminum stubs, and coated with gold for 60 s for SEM observation by a Hitachi S4500 scanning electron microscope (Mountain View, Calif.).

### Results and Discussion.

Monomer synthesis. Synthesis of di-p-nitrophenyl ester of dicarboxylic acid (I). The monomer family (I) (FIG. 64) was synthesized from readily available starting materials, sebacoyl chloride, succinyl chloride with p-nitrophenol as described in previous publications. Monomers N-2 and N-8 had the identical nitrophenol segments but different length of methylene groups: —(O)C(CH2)2C(O)— for N-2 and —(O)C(CH2)8C(O)— for N-8.

Synthesis of di-p-toluenesulfonic acid salts of bis-lphenylalanine and bis-dl-2-allylglycine esters (II). The monomer family (II) (FIG. 65) was also synthesized from readily available starting materials, L-phenylalanine, DL-2-allylglycine and diols. Monomers Phe-4 and Phe-6 had the identical amino acid segments (L-phenylalanine) but different diols: HO—(CH2)4-OH for Phe-4, HO—(CH2)6-OH for Phe-6. Monomers AG-2, AG-4 and AG-6 had the identical amino acid segments (DL-2-allylglycine) but different diols: HO—(CH2)2-OH for AG-2, HO—(CH2)4-OH for AG-4 and HO—(CH2)6-OH for AG-6. All the AG-z monomers had the typical 1H NMR peaks at 5.20 and 5.75 ppm, they were assigned to the methylene and methine protons of the carbon-carbon double bond in the allylglycine.

Polymer synthesis. The functional PEA-AG copolymers having pendant double bonds were synthesized through the solution co-polycondensation of monomers (I) and (II) at different feed ratios. In order to determine the relationship between polymer structures and their chemical and physical properties, 12 PEA-AGs of different methylene chain length (x) in the di-p-nitrophenyl ester of dicarboxylic acid (I), y in the di-p-toluenesulfonic acid salts of bis-L-phenylalanine esters (II) and z in the bis-DL-2-allylglycine esters (II)] and the feed ratios between (I) and (II) were synthesized and listed in FIG. 66.

During the copolymerization, triethylamine was used as the acid receptor for TosOH in order to regenerate free amino groups in the di-p-toluenesulfonic acid salt monomer. The copolymerization occurred smoothly in a DMA solution and the functional PEA-AG products had a medium molecular weight ranging from 14.2 to 39.0 kg/mol and a relatively narrow polydispersity 1.3.

Chemical structure identification. In order to verify the actual chemical compositions of these new functional PEA-AGs, their NMR and IR spectra were obtained. The ¹H NMR spectra of all the PEA-AG samples showed one set of resonance peak at about 5.11 and 5.73 ppm which were assigned to the methylene and methine protons of the carbon-carbon double bond in the AG block. The presence of the carbon-carbon double bond in functional PEA-AG copolymers was further confirmed by their ¹³C NMR spectra as the peaks at 118 and 134 ppm were attributed to the corresponding methylene and methine carbon atoms. These typical peaks indicated that all the functionalized PEA-AGs retained their double bond structures as in their corresponding monomer state. The ¹H NMR peaks at about 3.00 and 8.24 ppm were assigned to benzyl methylene protons of the Phe block and amide proton, respectively. The actual composition ratios of AG to Phe blocks could be calculated from the integrated peak area ratios of the two typical peaks 5.11 ppm (for the methylene protons of the double bond in AG block) and 3.00 ppm (for the benzyl methylene protons in Phe block). In some cases, the actual composition was slightly lower than the intended composition. This deviation was due to the removal of lower molecular weight polymers which had a relatively higher AG contents during the purification process.

Further insight into the nature of the actual PEA-AG structures came from their FTIR spectra. All the FTIR spectra had the characteristic absorption bands of unsaturated ═CH stretch from the AG unit (approx. 3030 cm⁻¹), C═O stretch of ester groups (approx. 1736 cm cm⁻¹), amide I group (approx. 1643 cm⁻¹) and amide II group (approx. 1539 cm⁻¹) (FIG. 69a). Based on these NMR and FTIR data, we concluded that the functional PEA-AGs having pendant double bonds synthesized possessed the chemical structure as we anticipated.

Thermal property. The thermal properties of all the functional PEA-AG polymers containing AG unit were obtained by differential scanning calorimetry (DSC) and was listed in FIG. 70. These functional PEA-AGs were amorphous since no melting temperature was detected. The glass transition temperatures (Tg) of these functional PEA-AGs ranged from 20° C. to 38° C., depending on x, y and z as well as the feed ratio of Phe to AG monomers. An increase in the AG contents from 25% (8-Phe-4-AG-4-25) to 50% (8-Phe-4-AG-4-50) led to a reduction in Tg from 30° C. to 26° C., a 13% reduction. The change in the material parameters like x, y, and z also affect the Tg of the corresponding functional PEA-AGs. For example, as the x (number of CH₂ group in the diacid segment of PEA-AGs) increased from C2 (i.e., 2-Phe-4-AG-4-25) to C8 (i.e., 8-Phe-4-AG-4-25), the Tg was reduced from 37° C. of the 2-Phe-4-AG-4-25 to 30° C. of the 8-Phe-4-AG-4-25, a 19% reduction. Similar reductions in Tg were also observed as y (number of CH₂ groups in the Phe diol segment) and z (number of CH2 groups in the AG diol segment) increased, e.g., 28° C. of the 8-Phe-4-AG-6 vs. 20° C. of the 8-Phe-6-AG-6. This x, y, and z structural effect on Tg was attributed to the higher PEA-AG chain flexibility as the methylene chain length increases. A similar relationship between Tg and the number of methylene groups in PEA backbone was also found in our previous studies of other generations of PEAs.

Comparing with the Phe-based PEA homopolymers (e.g., 8-Phe-4 and 2-Phe-4), the incorporation of AG unit into the PEA-AG backbone lowered their Tg. For example, 2-Phe-4 and 8-Phe-4 had Tg of 55° C. and 40° C., respectively, while the x-Phe-y-AG-z copolymers had Tg values ranging from 20° C. to 38° C., depending on x, y and z values. This suggested that the presence of AG unit in PEA-AG backbone could impart additional chain flexibility due to the increasing free volume from pendant double bonds which could act as internal plasticizers, lowered the intermolecular interaction between PEA-AG chains. Therefore, more allylglycine contents resulted in higher chain flexibility and hence lower Tg values. Similar results were also reported in other polymer systems. For example, the Tg values of the substituted polyglycolide decreased as the length of the grafted linear alkyl group increased (66° C. for polylactide to −37° C. for poly(hexylglycolide)). The flexible pendant group acted as an internal plasticizer, therefore lowered the frictional interaction between polyester chains.

It was important to know that the location of the carbon-carbon double bonds incorporated into PEA could have a profound different effect on Tg. In this study, the double bonds were introduced as the pendant groups, i.e., reducing Tg. If the double bonds were introduced into the PEA backbone as in the unsaturated PEAs, their Tg increased instead because the rigidity of the carbon-carbon double bond in the PEA backbone made the PEA chain more difficult to rotate and hence reduced flexibility and increased Tg. For example, the Tg value of a saturated PEA (8-Phe-4) was 40° C., while the unsaturated PEA (u-8-Phe-4) was 46° C. The only difference between 8-Phe-4 and u-8-Phe-4 was the diol part in the PEA backbone in which 8-Phe-4 had the saturated 1,4-butanediol, u-8-Phe-4 had the unsaturated 1,4-butenediol (see FIG. 70).

Solubility. The solubility of these functional PEA-AGs in several common organic solvents was evaluated at room temperature and the data were given in FIG. 71. All these PEA-AGs were completely or partially soluble in DMSO, DMF, DMA and THF, but could not dissolve in H₂O, ethyl acetate, or acetone. These solubility data were similar with our previous Phe-based saturated PEAs, suggesting the incorporation of AG unit into PEA-AG did not significantly alter the PEA solubility.

Short-term in vitro biodegradation of functional PEA-AGs. The short-term in vitro biodegradation of the functional PEA-AGs in terms of weight loss over a period of 6 days was investigated in both a-chymotrypsin solutions and pure phosphate buffered saline (PBS) as control of pH 7.4 at 37° C. Functional PEA-AGs of different chemical structures (i.e., x, y, and z) and AG contents were selected as representatives for the biodegradation study. During the test period, all these functional PEA-AGs showed a slight hydrolysis (weight loss <8%) in a pure PBS buffer; but they were sensitive to the enzymatic biodegradation. Similar results were reported recently by using unsaturated and saturated PEAs.

Effect of the methylene chain length of PEA-AGs. The effect of x of the functional PEA-AGs (2-Phe-4-AG-4-25 vs. 8-Phe-4-AG-4-25) on their weight loss was showed in FIG. 72. In the first day and 0.1 mg/mL a-chymotrypsin solution, 2-Phe-4-AG-4-25 had 11% weight loss, while the weight loss of 8-Phe-4-AG-4-25 increased to 20%. After 6-day incubation, the weight loss of 8-Phe-4-AG-4-25 was 79%, while 2-Phe-4-AG-4-25 was only 58%. The only structural difference between these two functional PEA-AGs was the number of CH2 groups in the diacid segment. Lengthening the diacid backbone from C2 to C8 increased the biodegradation rate significantly.

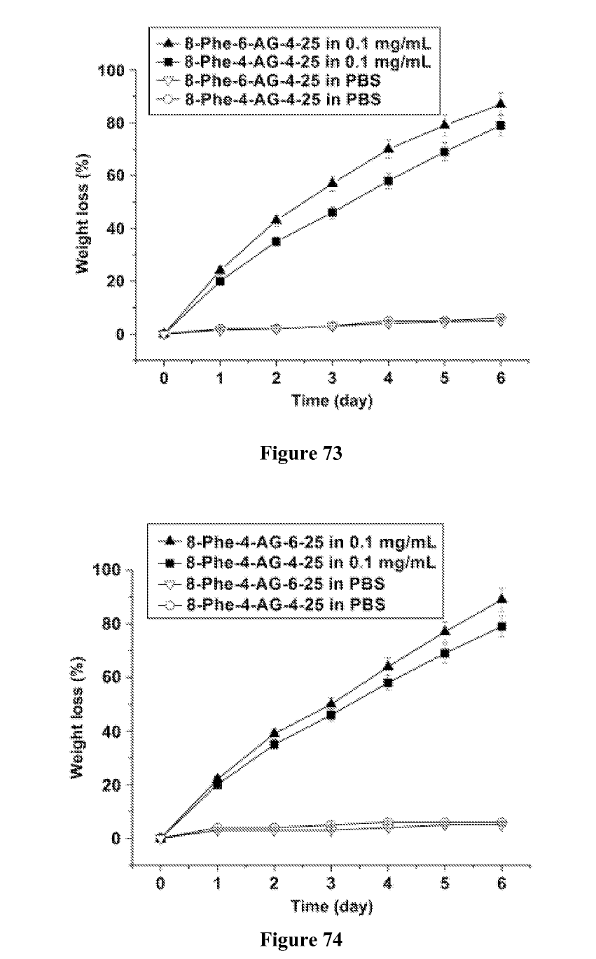

The effect of y of the functional PEA-AGs (8-Phe-6-AG-4-25 vs. 8-Phe-4-AG-4-25) on their weight loss was shown in FIG. 73. The biodegradation behaviors of 8-Phe-6-AG-4-25 and 8-Phe-4-AG-4-25 manifested that 8-Phe-6-AG-4-25 had slightly higher degradation rate than 8-Phe-4-AG-4-25. In 0.1 mg/mL a-chymotrypsin solution 8-Phe-6-AG-4-25 lost 24% weight while 8-Phe-4-AG-4-25 had 20% loss in the first day. After 6-day incubation, the weight loss of 8-Phe-4-AG-4-25 was 79% and 8-Phe-6-AG-4-25 had 87% weightloss. The only structural difference between these two PEA-AGs was the number of CH2 groups in the phenylalanine-based diester segment. Lengthening the phenylalanine-based diester backbone from C4 to C6 also increased biodegradation rate.

The effect of z of the functional PEA-AGs (8-Phe-4-AG-4-25 vs. 8-Phe-4-AG-6-25) on their weight loss was shown in FIG. 74. A similar trend as the x and y was found for z as lengthening the allylglycine-based diester backbone from C4 to C6 would also result in a higher biodegradation rate. The first day weight loss ranged from 20% (8-Phe-4-AG-4-25) to 22% (8-Phe-4-AG-6-25), and the sixth day from 79% (8-Phe-4-AG-2-25) to 89% (8-Phe-4-AG-6-25) in 0.1 mg/mL a-chymotrypsin solution. All these methylene chain length effects on the enzyme-catalyzed biodegradation rate and extent of the newly synthesized functional PEA-AGs could be attributed to the higher hydrophobicity derived from the longer methylene chains which may lead to a better affinity of the PEA-AG polymers toward a-chymotrypsin. The role of hydrophobicity on PEA enzymatic biodegradation rate was initially suggested by Katsarava et al. in their reported study of a series of saturated non-functional PEAs. This relationship between hydrophobicity of PEA biomaterials and their enzymatic biodegradation rate was confirmed by the subsequent studies of other types of PEAs, such as unsaturated PEAs having double bonds on the PEA backbone and saturated functional PEA copolymers. This relationship was now further confirmed in the current newly developed PEA-AG family.

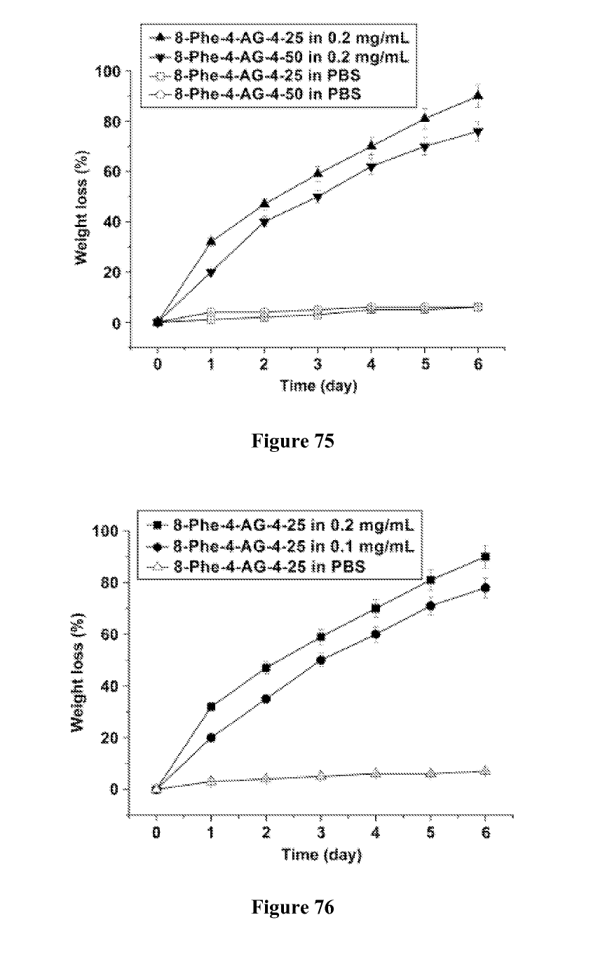

Effect of the allylglycine (AG) contents. With an increase in the AG contents from 25% (8-Phe-4-AG-4-25) to 50% (8-Phe-4-AG-4-50), the biodegradation rate decreased as shown in FIG. 75. The weight loss of 8-Phe-4-AG-4-50 was 73% in 0.2 mg/mL a-chymotrypsin solution after 6-day incubation, while 8-Phe-4-AG-4-25 had 90% weight loss under the same conditions. It was found that the benzyl side group from phenylalanine was more hydrophobic than allyl side group from allylglycine. Therefore, the more allylglycine introduced into PEA-AG would relatively reduce the Phe content, and caused the PEA-AGs to be less hydrophobic, and correspondingly, less affinitive to a-chymotrypsin.

Effect of the enzyme concentration. The biodegradation rate of PEA-AGs increased with an increase in a-chymotrypsin concentration as shown in FIG. 75. In the first day, 8-Phe-4-AG-4-25 had 20% weight loss in a achymotrypsin solution (0.1 mg/mL), but its weight loss at the same incubation period increased to 32% in a 0.2 mg/mL achymotrypsin solution. After 6-day incubation, the weight loss of 8-Phe-4-AG-4-25 ranged from 79% (in 0.1 mg/mL a-chymotrypsin solution) to 90% (in 0.2 mg/mL a-chymotrypsin solution) as shown in FIG. 76. When comparing with the Phe-based saturated PEAs, the presence of AG unit in the functional PEA-AG copolymers increased their biodegradation rates. For example, saturated PEA 8-Phe-6 had 67% weight loss in a 6-day incubation while 8-Phe-4-AG-4-25 had 79% weight loss in the same conditions (in 0.1 mg/mL a-chymotrypsin solution at 37° C.). It is not clear why the incorporation of the pendant double bond could increase the enzyme biodegradation rate. Pivsa-Art et al. reported that the biodegradability of non-amino acid based block copoly(esteramide)s in lipase decreased when the molecular rigidity of the copolymers increased. The role of molecular flexibility (or rigidity) of a polymer in its enzymatic biodegradation had also been demonstrated in this study as an increase in the methylene chain length (i.e., x, y and z material parameters) led to an increase in enzymatic biodegradation rates. The presence of AG unit in PEAAG backbone could also impart additional chain flexibility due to the increasing free volume from the pendant double bonds which could act as internal plasticizers, lowered the frictional interaction between PEA-AG chains. As a result, the incorporated AG unit could lower the polymer rigidity and Tg values. Therefore, the more flexible PEA-AG showed higher biodegradation rates as Pivsa-Art et al. reported in their study of the effect of chain flexibility of non-amino acid-based PEAs on their enzymatic biodegradation rates. It was believed that a more flexible polymer chain could adapt to an enzyme conformation better than a more rigid polymer chain for an enzyme-catalyzed biodegradation.

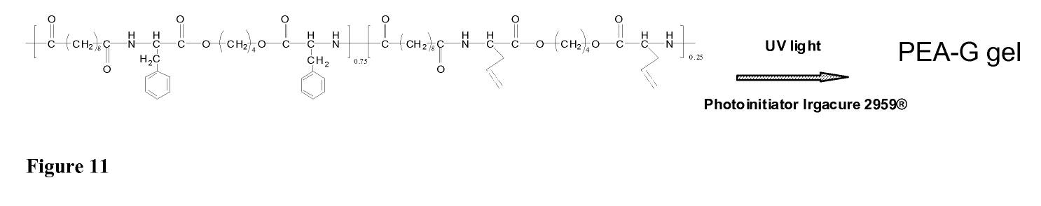

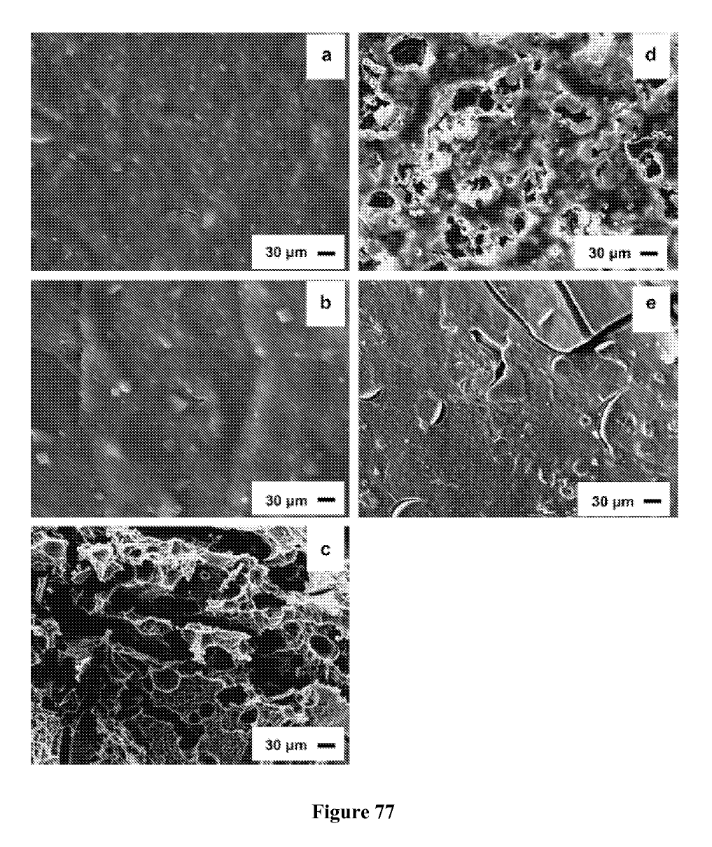

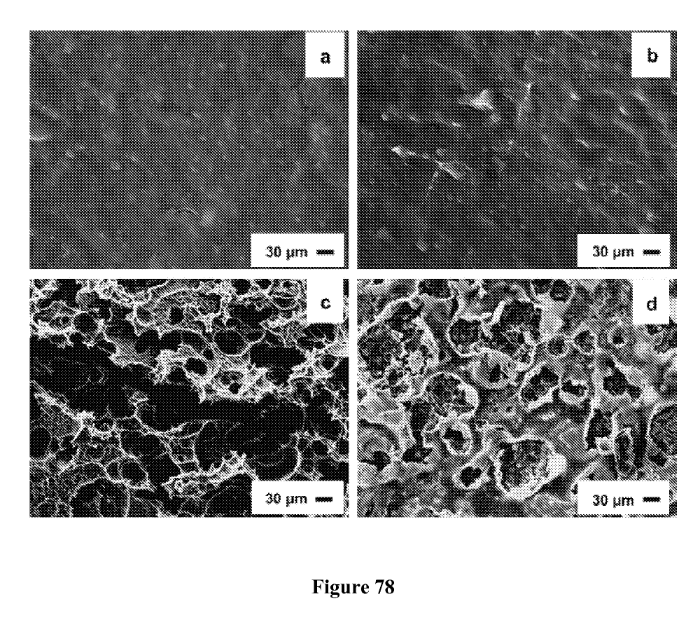

Surface morphology. The surface morphology changes of the PEA-AG films upon biodegradation were shown in FIGS. 77 and 78. After 6-days incubation, all the PEA-AGs showed a significant a-chymotrypsin catalyzed biodegradation as evident by the appearance of a more severe eroded surface (FIGS. 77c and d) compared with their counterparts in PBS (FIG. 11e). All these PEA-AG film samples showed slight surface erosion in a PBS solution. In addition, as the AG content decreased, the erosion level of the polymer film surface became more severe (FIGS. 78c and d). These SEM data were consistent with the biodegradation weight loss data.

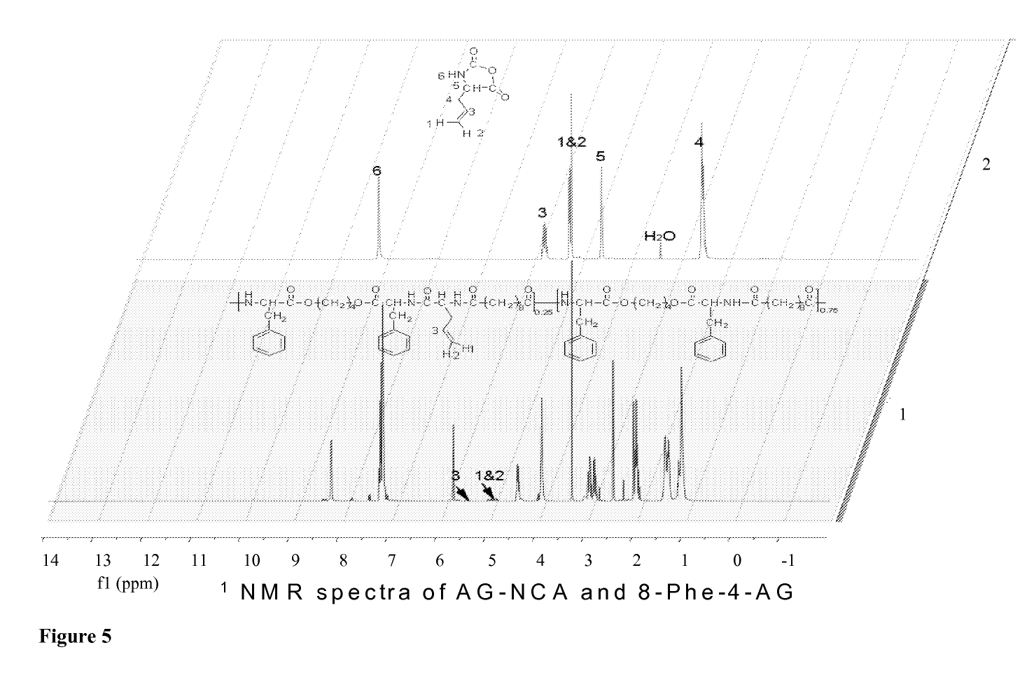

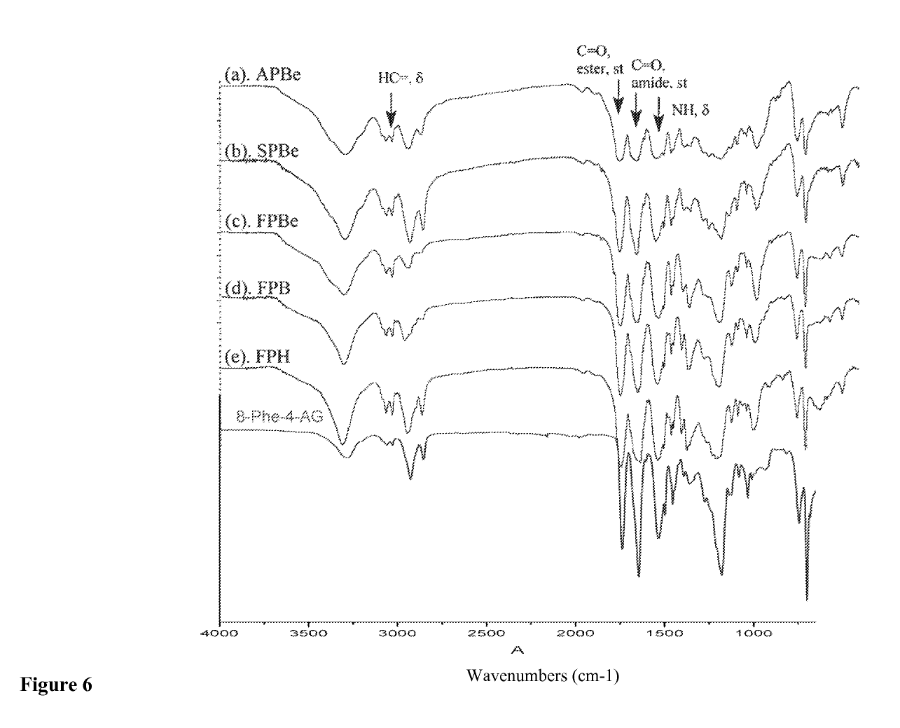

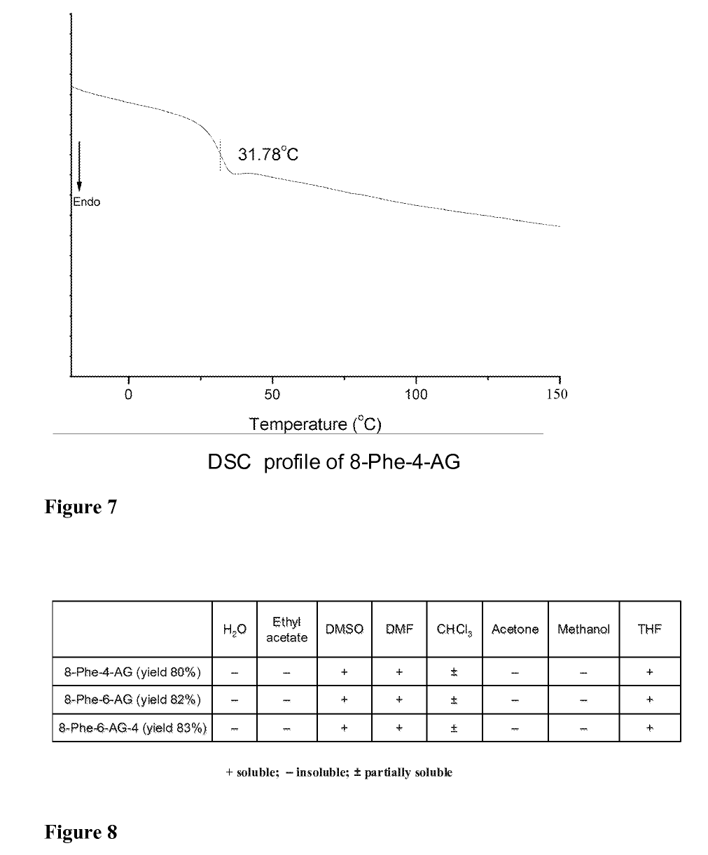

Utility of the functional PEA-AGs having pendant double bonds. To demonstrate the utility of these newly synthesized functional PEA-AGs having pendant double bonds, the feasibility to convert these pendant double bonds in the AG unit to thiol based functional groups was investigated. As depicted in FIG. 68, three types of thiol-based functional groups were introduced into the pendant double bond sites by using the corresponding thiols: —COOH by using 3-mercaptopropionic acid, —NH3Cl by using 2-aminoethanethiol hydrochloride, and —SO3Na by using sodium-3-mercapto-1-propanesulfonate. The 1H NMR spectra of all the PEA-AG samples after thiol-functionalization manifested almost complete consumption of the double bonds by the absence of the double bond proton resonance peak at 5.11 and 5.73 ppm. The observation of the methylene protons peaks from functional thiols confirmed the attachment of these three functional thiols. Further evidence of the successful conversion of the pendant double bonds in the PEA-AGs to thiol-based functional groups came from the FTIR spectra as shown in FIG. 5b-d. As for the 8-Phe-4-AG-2-COOH (FIG. 69b), the bands at 1400 and 928 cm⁻¹ were assigned to O—H bending; the band at 1237 cm cm⁻¹ was assigned to C—O stretch. A broad absorption was observed at 2903 cm⁻¹ in FIG. 69c (8-Phe-4-AG-2-NH2HCl) due to the asymmetric —NH3 ⁺ group stretching vibration. The bands at 1203 and 1055 cm⁻¹ in FIG. 69d (8-Phe-4-AG-2-SO3Na) were due to the S—O and S—O—C stretching band. Based on both the NMR and FTIR spectral data, we could conclude that the pendant carbon-carbon double bonds in the newly synthesized functional PEA-AGs were reactive and could be used to make many different types of functional PEA-AG derivatives for additional biomedical applications.

### CONCLUSIONS

A new family of biodegradable and functional amino acid-based poly(ester amide)s having pendant carbon-carbon double bonds were synthesized by the solution co-polycondensation of amino acid based monomers (II) and dicarboxylic acid based monomers (I). The contents of the pendant double bond could be adjusted by tuning the monomer feed ratio of L-Phe to DL-2-allylglycine (AG). The FTIR and NMR data confirmed the chemical structures of these new functional PEA-AG copolymers. The effects of the PEA-AG chemical structures on their biodegradation properties (in terms of weight loss) were investigated in a-chymotrypsin media at different concentrations. The short-term in vitro biodegradation data suggested that the methylene chain length as well as the allglycine contents in these functional PEA-AGs had a profound impact on their rate and extent of biodegradation. The utility of the incorporated pendant carbon-carbon double bond along the PEAAG chains was demonstrated by converting these double bonds into functional thiols, and new functional PEA-AG derivatives having carboxylic acid, amine and sulfonate groups were synthesized to broaden their biomedical applications.

While the invention has been particularly shown and described with reference to specific embodiments (some of which are preferred embodiments), it should be understood by those having skill in the art that various changes in form and detail may be made therein without departing from the spirit and scope of the present invention as disclosed herein.

What is claimed is:

1) A polymer having the following structure comprising and [AA]ₘ block and [PXL1]ₙ or [PXL2]ₙ block: 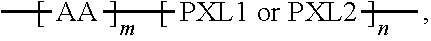
wherein 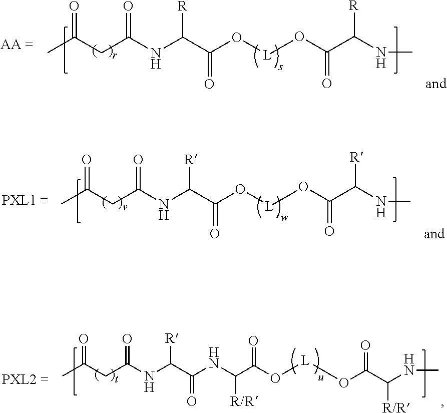
wherein the [AA]ₘ block and [PXL1]ₙ or [PXL2]ₙ blocks are connected by an amide bond,
wherein R is a side chain of a naturally-occurring amino acid,
wherein R′ is an alkyl group comprising an alkene group,
wherein L=CH₂, CH₂—CH₂ or CH₂—(CH₂—O—CH₂)ₖ—CH₂ and k is from 1 to 6;
wherein r or v or t is from 2 to 8,
wherein s or w or u is from 2 to 6, and
wherein the ratio of m to n is from 1 to 4.

2) The polymer of claim 1, wherein the number averaged molecular weight, Mn, is from 10 kg/mol to 100 kg/mol or the weight averaged molecular weight, Mw, is from 10 kg/mol to 100 kg/mol.

3) The polymer of claim 1, wherein R is a benzyl group or a alkylguanidinium group, and wherein R′ is an allyl group.

4) The polymer of claim 1, wherein the polymer has the following structure:

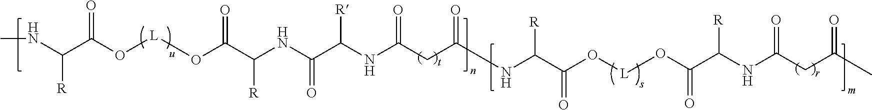

5) The polymer of claim 4, wherein the polymer is selected from the following structures:

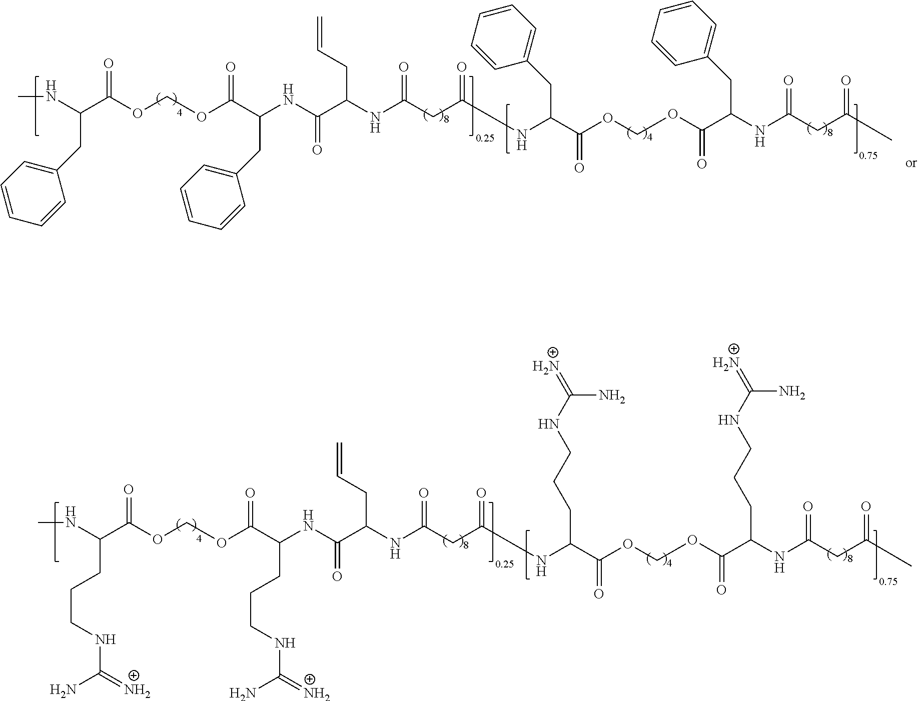

6) The polymer of claim 1, wherein the polymer has the following structure:

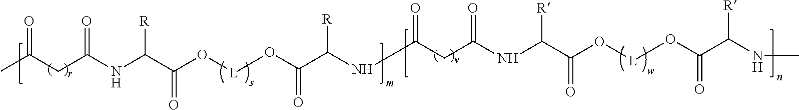

7) The polymer of claim 6, wherein the polymer is selected from the following structures:

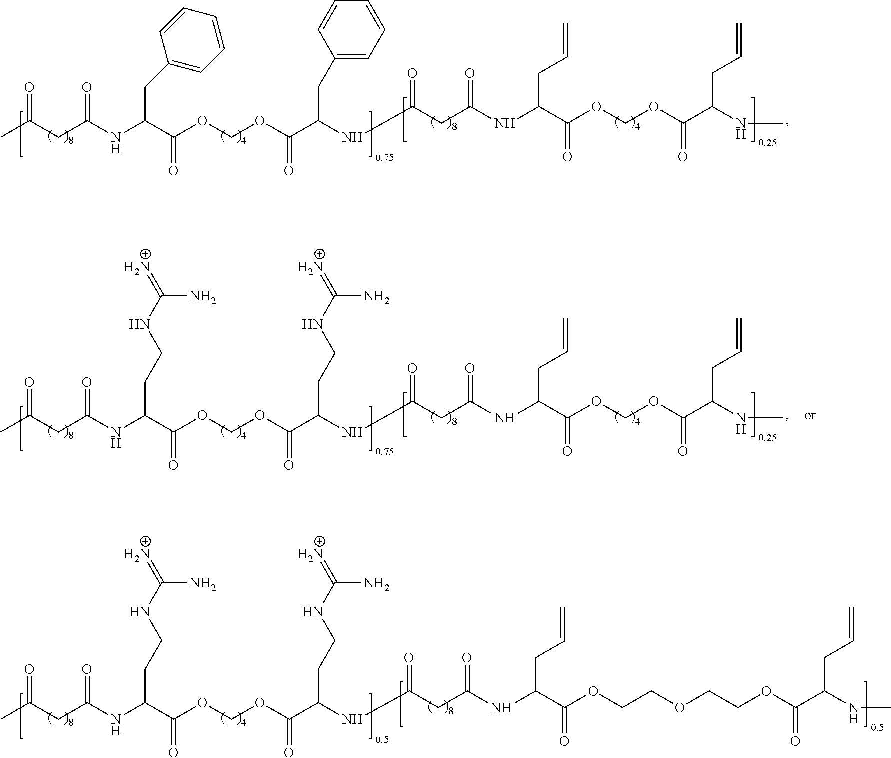

8) The polymer of claim 1, wherein in the block terminated by an amine the amine is present as an p-nitro phenol adduct, and wherein the block terminated by a carbonyl group is present as a p-nitro phenolate ester.

9) A method for making a polymer of claim 1 comprising the steps of:
a) mixing a first monomer having the following structure: 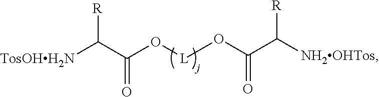
wherein R is a side chain of a naturally-occurring or synthetic amino acid, and
wherein L=CH₂ or CH₂—CH₂ or CH₂—(CH₂—O—CH₂)ₖ—CH₂, where k is from 1 to 6, and
wherein j is from 2 to 6,
with a second monomer having the following structure: 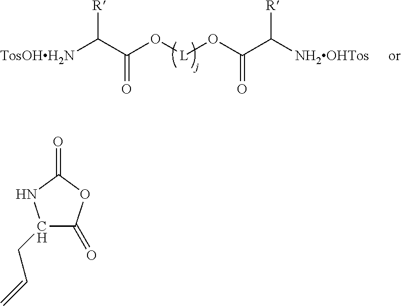
wherein R′ is an alkyl group comprising an alkene group, and
wherein L=CH₂ or CH₂—CH₂ or CH₂—(CH₂—O—CH₂)ₖ—CH₂, where k is from 1 to 6, and
wherein j is from 2 to 6,
in a ratio such that a m/n ratio of from 1 to 4 is achieved, and
optionally, a solvent,
b) heating the mixture from a) at a temperature of from 70° C. to 100° C. for until the polymerization has proceeded to the desired extent.

10) The method of claim 9 wherein step b is carried for 48 hours to 72 hours.

11) The method of claim 9, wherein R is a benzyl group or a alkylguanidinium group, and wherein R′ is an allyl group.

12) A hydrogel formed from a plurality of polymer molecules, the polymer molecules having the structure of claim 1, wherein the hydrogel has at least one covalent bond between different blocks of the same molecule or between blocks from different polymer molecules.

13) The hydrogel of claim 12, wherein the at least one covalent bond is formed by subjecting the plurality of polymer molecules to reaction conditions such that a reaction takes place between two alkene groups from blocks of the same polymer molecule or between blocks from different polymer molecules forming a covalent bond.

14) The hydrogel of claim 13, wherein the reactions conditions are photochemical conditions, wherein the plurality of polymer molecules and a photoinitiator are combined in the presence of ultraviolet radiation.

15) The hydrogel of claim 14, wherein the photoinitator is Irgacure 2959® and the ultraviolet radiation has a wavelength of from 300 nm to 400 nm.
